(19) United States
(12) Patent Application Publication
(10) Pub. No.: US 2024/0078903 A1
(43) Pub. Date: Mar. 7, 2024

(54) AUTONOMOUS DRIVING SYSTEM AND METHOD THEREOF

(71) Applicant: JIOH PARK, Seoul (KR)

(72) Inventor: JIOH PARK, Seoul (KR)

(21) Appl. No.: 18/052,177

(22) Filed: Nov. 2, 2022

(30) Foreign Application Priority Data
Nov. 2, 2021 (KR) 10-2021-0148369
Oct. 31, 2022 (KR) 10-2022-0142659

(51) Int. Cl. G08G 1/0967; G08G 1/01; G08G 1/056; H04L 9/40

(52) U.S. Cl. CPC G08G 1/096725; G08G 1/0112; G08G 1/0116; G08G 1/056; G08G 1/096783; H04L 63/0442

(57) ABSTRACT

An electronic device for the vehicle according to various exemplary embodiments includes at least one transceiver, a memory configured to store instructions, and at least one processor operatively coupled to at least one transceiver and the memory. When the instructions are executed, the at least one processor may be configured to receive an event message related to an event of the source vehicle. The event message includes identification information about a serving road side unit (RSU) of the source vehicle and direction information indicating a driving direction of the source vehicle. The at least one processor is configured to identify whether the serving RSU of the source vehicle is included in a driving list of the vehicle when the instructions are executed.

### CROSS-REFERENCE TO RELATED APPLICATIONS

This application claims priority under 35 U.S.C § 119 to Korean Patent Application No. 10-2021-0148369 filed on Nov. 2, 2021, and to Korean Patent Application No. 10-2022-0142659 filed on Oct. 31, 2022, in the Korean Intellectual Property Office, 2021, the entire contents of which are hereby incorporated by reference.

### BACKGROUND

### Field

Various exemplary embodiments disclosed in the present disclosure relate to an electronic device and method for processing data acquired and received by an automotive electronic device.

### Description of the Related Art

Recently, due to the development of a computing power mounted in the vehicle and a machine learning algorithm, an autonomous driving related technique for vehicles are more actively being developed. In the vehicle driving state, the automotive electronic device detects a designated state of the vehicle (for example, sudden breaking and/or collision) and acquires data based on the state.

Further, an advanced driver assistant system (ADAS) are being developed for vehicles which are being launched in recent years, to prevent traffic accidents of driving vehicles and promote an efficient traffic flow. At this time, a vehicle-to-everything (V2X) is used as a vehicle communication system. As representative examples of the V2X, a vehicle to vehicle (V2V) communication and a vehicle to infrastructure (V2I) communication may be used. Vehicles which support the V2V and V2I communication may transmit whether there is an accident ahead or a collision warning to other vehicles (neighbor vehicles) which support the V2X communication. A management device such as a road side unit (RSU) may control the traffic flow by informing a real-time traffic situation to the vehicles or controlling a signal waiting time.

### SUMMARY

An electronic device which is mountable in the vehicle may identify a plurality of subjects disposed in a space adjacent to the vehicle using a plurality of cameras. In order to represent interaction between the vehicle and the plurality of subjects, a method for acquiring a positional relationship between the plurality of subjects with respect to the vehicle may be demanded.

Further, in accordance with the development of the communication technique, a method for promptly recognizing data which is being captured by a vehicle data acquiring device and/or a designated state and/or an event recognized by the vehicle data acquiring device and performing a related function based on a recognized result may be demanded.

A technical object to be achieved in the present disclosure is not limited to the aforementioned technical objects, and another not-mentioned technical objects will be obviously understood by those skilled in the art from the description below.

According to the exemplary embodiments, a device of the vehicle includes at least one transceiver, a memory configured to store instructions, and at least one processor operatively coupled to at least one transceiver and the memory. When the instructions are executed, the at least one processor may be configured to receive an event message related to an event of the source vehicle. The event message includes identification information about a serving road side unit (RSU) of the source vehicle and direction information indicating a driving direction of the source vehicle. The at least one processor is configured to identify whether the serving RSU of the source vehicle is included in a driving list of the vehicle when the instructions are executed. The at least one processor is configured to identify whether the driving direction of the source vehicle matches a driving direction of the vehicle when the instructions are executed. When the instructions are executed, if it is identified that the driving direction of the source vehicle matches the driving direction of the vehicle and a serving RSU of the source vehicle is included in the driving list of the vehicle (upon identifying), the at least one processor is configured to perform the driving according to the event message. When the instructions are executed, if it is identified that the driving direction of the source vehicle does not match the driving direction of the vehicle and a serving RSU of the source vehicle is not included in the driving list of the vehicle (upon identifying), the at least one processor is configured to perform the driving without the event message.

According to the exemplary embodiments, a device performed by the road side unit (RSU) includes at least one transceiver, a memory configured to store instructions, and at least one processor operatively coupled to at least one transceiver and the memory. When the instructions are executed, the at least one processor may be configured to receive an event message related to an event in the source vehicle, from a vehicle which is serviced by the RSU. The event message includes identification information of the vehicle and direction information indicating a driving direction of the vehicle. The at least one processor is configured to identify the driving route of the vehicle based on the identification information of the vehicle when the instructions are executed. When the instructions are executed, the at least one processor is configured to identify at least one RSU located in a direction opposite to the driving direction of the vehicle, from the RSU, among one or more RSUs included in the driving route of the vehicle. The at least one processor is configured to transmit the event message to each of the at least one identified RSU when the instructions are executed.

According to the exemplary embodiments, a method performed by the vehicle includes an operation of receiving an event message related to an event of the source vehicle. The event message includes identification information about a serving road side unit (RSU) of the source vehicle and direction information indicating a driving direction of the source vehicle. The method includes an operation of identifying whether the serving RSU of the source vehicle is included in a driving list of the vehicle. The method includes an operation of identifying whether the driving direction of the source vehicle matches a driving direction of the vehicle. When it is identified that the driving direction of the source vehicle matches the driving direction of the vehicle and a serving RSU of the source vehicle is included in the driving list of the vehicle (upon identifying), the method includes an operation of performing the driving according to the event message. When it is identified that the driving direction of the source vehicle does not match the driving direction of the vehicle and a serving RSU of the source vehicle is not included in the driving list of the vehicle (upon identifying), the method includes an operation of performing the driving without the event message.

In the exemplary embodiments, the method performed by a road side unit (RSU) includes an operation of receiving an event related event message in the vehicle from the vehicle which is serviced by the RSU. The event message includes identification information of the vehicle and direction information indicating a driving direction of the vehicle. The method includes an operation of identifying a driving route of the vehicle based on the identification information of the vehicle. The method includes an operation of identifying at least one RSU located in a direction opposite to the driving direction of the vehicle from the RSU, among one or more RSUs included in the driving route of the vehicle. The method includes an operation of transmitting the event message to at least one identified RSU.

According to the exemplary embodiments, an electronic device which is mountable in the vehicle includes a plurality of cameras which is disposed to different directions of the vehicle, a memory, and a processor. The processor acquires a plurality of frames acquired by the plurality of cameras which is synchronized with each other. The processor may identify one or more lanes included in a road on which the vehicle is disposed, from the plurality of frames. The processor may identify one or more subjects disposed in a space adjacent to the vehicle, from the plurality of frames. The processor acquires information for identifying a position of the at least one subject in the space, based on one or more lanes. The processor stores the acquired information in the memory.

The method of the electronic device which is mountable in the vehicle includes an operation of acquiring a plurality of frames acquired by the plurality of cameras which is synchronized with each other. The method may identify one or more lanes included in a road on which the vehicle is disposed, from the plurality of frames. The method may include an operation of identifying one or more subjects disposed in a space adjacent to the vehicle, from the plurality of frames. The method includes an operation of acquiring information for identifying a position of the at least one subject in the space, based on one or more lanes. The method includes an operation of storing the acquired information in a memory.

According to the exemplary embodiments, the one or more programs of a computer readable storage medium which stores one or more programs acquire a plurality of frames acquired by a plurality of cameras which is synchronized with each other when the programs are executed by a processor of an electronic device mountable in a vehicle. For example, the one or more programs may identify one or more lanes included in a road on which the vehicle is disposed, from the plurality of frames. The one or more programs may identify one or more subjects disposed in a space adjacent to the vehicle, from the plurality of frames. The one or more programs may acquire information for identifying a position of the at least one subject in the space, based on one or more lanes. The one or more programs may store the acquired information in the memory.

According to various exemplary embodiments, an electronic device which is mountable in the vehicle may identify a plurality of subjects disposed in a space adjacent to the vehicle using a plurality of cameras. The electronic device may acquire the positional relationship between the plurality of subjects with respect to the vehicle using a plurality of frames acquired using the plurality of cameras to represent the interaction between the vehicle and the plurality of subjects.

According to various exemplary embodiments, the electronic device may promptly recognize data which is being captured by a vehicle data acquiring device and/or an event which occurs in a vehicle including the vehicle data acquiring device and perform a related function based on a recognized result.

A technical object to be achieved by the present disclosure is not limited to the aforementioned effects, and another not-mentioned effects will be obviously understood by those skilled in the art from the description below.

### BRIEF DESCRIPTION OF THE DRAWINGS

FIG. 1 illustrates a wireless communication system according to exemplary embodiments;

FIG. 2 illustrates an example of a traffic environment according to exemplary embodiments;

FIG. 3 illustrates an example of a groupcast type vehicle communication according to an exemplary embodiment;

FIG. 4 illustrates an example of unicast type vehicle communication according to an exemplary embodiment;

FIG. 5 illustrates an example of an autonomous driving service establishment procedure by a road side unit (RSU) according to an exemplary embodiment;

FIG. 6 illustrates an example of an autonomous driving service based on an event according to an exemplary embodiment;

FIG. 7 illustrates an example of signaling between entities for setting a driving route based on an event according to an exemplary embodiment;

FIG. 8 illustrates an example of efficiently processing an event message when a driving route is set based on an event according to an exemplary embodiment;

FIG. 9 illustrates an example of efficiently processing an efficient event message when a driving route is set based on an event according to an exemplary embodiment;

FIG. 10 illustrates an example of efficient event message processing when a driving route is set based on an event according to an exemplary embodiment;

FIG. 11 illustrates an operation flow of an RSU for processing an event message according to an exemplary embodiment;

FIG. 12 illustrates an operation flow of a vehicle for processing an event message according to an exemplary embodiment;

FIG. 13 illustrates an operation flow of an event related vehicle according to an exemplary embodiment;

FIG. 14 illustrates an operation flow of a service provider for resetting a driving route in response to an event according to an exemplary embodiment;

FIG. 15 illustrates an example of a component of a vehicle according to an exemplary embodiment;

FIG. 16 illustrates an example of a component of a RSU according to an exemplary embodiment;

FIG. 17 illustrates a block diagram illustrating an autonomous driving system of a vehicle;

FIGS. 18 and 19 are block diagrams illustrating an autonomous moving object according to an exemplary embodiment;

FIG. 20 illustrates an example of a block diagram of an electronic device according to an embodiment.

FIGS. 21 to 23 illustrate exemplary states indicating obtaining of a plurality of frames using an electronic device disposed in a vehicle according to an embodiment.

FIGS. 24 to 25 illustrate an example of frames including information on a subject that an electronic device obtained by using a first camera disposed in front of a vehicle, according to an embodiment.

FIGS. 26 to 27 illustrate an example of frames including information on a subject that an electronic device obtained by using a second camera disposed on the left side surface of a vehicle, according to an embodiment.

FIGS. 28 to 29 illustrate an example of frames including information on a subject that an electronic device obtained by using a third camera disposed on the right side surface of a vehicle, according to an embodiment.

FIG. 30 illustrates an example of frames including information on a subject that an electronic device obtained by using a fourth camera disposed at the rear of a vehicle, according to an embodiment.

FIG. 31 is an exemplary flowchart illustrating an operation in which an electronic device obtains information on one or more subjects included in a plurality of frames obtained by using a plurality of cameras, according to an embodiment.

FIG. 32 illustrates an exemplary screen including one or more subjects, which is generated by an electronic device based on a plurality of frames obtained by using a plurality of cameras, according to an embodiment.

FIG. 33 is an exemplary flowchart illustrating an operation in which an electronic device identifies information on one or more subjects included in the plurality of frames based on a plurality of frames obtained by a plurality of cameras, according to an embodiment.

FIG. 34 is an exemplary flowchart illustrating an operation of controlling a vehicle by an electronic device according to an embodiment.

FIG. 35 is an exemplary flowchart illustrating an operation in which an electronic device controls a vehicle based on an autonomous driving mode according to an embodiment.

FIG. 36 is an exemplary flowchart illustrating an operation of controlling a vehicle by using information of at least one subject obtained by an electronic device by using a camera according to an embodiment.

### DETAILED DESCRIPTION OF THE EMBODIMENT

Specific structural or functional descriptions of exemplary embodiments in accordance with a concept of the present invention which are disclosed in this specification are illustrated only to describe the exemplary embodiments in accordance with the concept of the present invention and the exemplary embodiments in accordance with the concept of the present invention may be carried out by various forms but are not limited to the exemplary embodiments described in this specification.

Various modifications and changes may be applied to the exemplary embodiments in accordance with the concept of the present invention so that the exemplary embodiments will be illustrated in the drawings and described in detail in the specification. However, it does not limit the specific embodiments according to the concept of the present disclosure, but includes changes, equivalents, or alternatives which are included in the spirit and technical scope of the present disclosure.

Terms such as first or second may be used to describe various components but the components are not limited by the above terminologies. The above terms are used to distinguish one component from the other component, for example, a first component may be referred to as a second component without departing from a scope in accordance with the concept of the present invention and similarly, a second component may be referred to as a first component.

It should be understood that when one constituent element referred to as being “coupled to” or “connected to” another constituent element, one constituent element can be directly coupled to or connected to the other constituent element, but intervening elements may also be present. In contrast, when one constituent element is “directly coupled to” or “directly connected to” another constituent element, it should be understood that there are no intervening element present. Other expressions which describe the relationship between components, that is, “between” and “directly between”, or “adjacent to” and “directly adjacent to” need to be interpreted by the same manner.

Terms used in the present specification are used only to describe specific exemplary embodiments, and are not intended to limit the present disclosure. A singular form may include a plural form if there is no clearly opposite meaning in the context. In the present specification, it should be understood that terms “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

In various exemplary embodiments of the present specification which will be described below, hardware approaches will be described as an example. However, various exemplary embodiments of the present disclosure include a technology which uses both the hardware and the software so that it does not mean that various exemplary embodiments of the present disclosure exclude software based approaches.

Terms (for example, signal, information, message, signaling) which refer to a signal used in the following description, terms (for example, lists, set, subset) which refer to a data type, terms (for example, step, operation, procedure) which refer to a computation state, terms (for example, packet, user stream, information, bit, symbol, codeword) which refer to data, terms (for example, symbol, slot, subframe, radio frame, subcarrier, resource element, resource block, bandwidth part (BWP), occasion which refer to a resource, terms which refer to a channel, terms which refer to a network entity, and terms which refer to a component of a device are illustrated for the convenience of description. Accordingly, the present disclosure is not limited by the terms to be described below and other terms having the equal technical meaning may be used.

Further, in the present specification, in order to determine whether to satisfy or fulfil a specific condition, expressions of more than or less then are used, but this is only a description for expressing one example, does not exclude the description of equal to or higher than or equal to or lower than. A condition described as “equal to or more than” may be replaced with “more than” and a condition described as “equal to or less than” may be replaced with “less than”, and a condition described as “equal to or more than and less than” may be replaced with “more than and equal to or less than”. Further, “A” to “B” means at least one of elements from A (including A) to B (including B).

In the present disclosure, various exemplary embodiments will be descried using terms used for some communication standards such as 3rd generation partnership project (3GPP), European telecommunications standards institute (ETSI), extensible radio access network (xRAN), open-radio access network (O-RAN), but these are just examples for description. Various exemplary embodiments of the present disclosure may be easily modified to be applied to other communication systems. Further, in description of the communication between vehicles, terms in the 3GPP based cellular-V2X are described as an example, but communication methods defined in WiFi based dedicated short range communication (DSRC) and other groups (for example, 5G automotive association (5GAA)) or separate institutes may be used for the exemplary embodiments of the present disclosure.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in this specification.

Hereinafter, example embodiments will be described in detail with reference to the accompanying drawings. However, the scope of the patent application will be not limited or restricted to embodiments below. In each of the drawings, like reference numerals denote like elements.

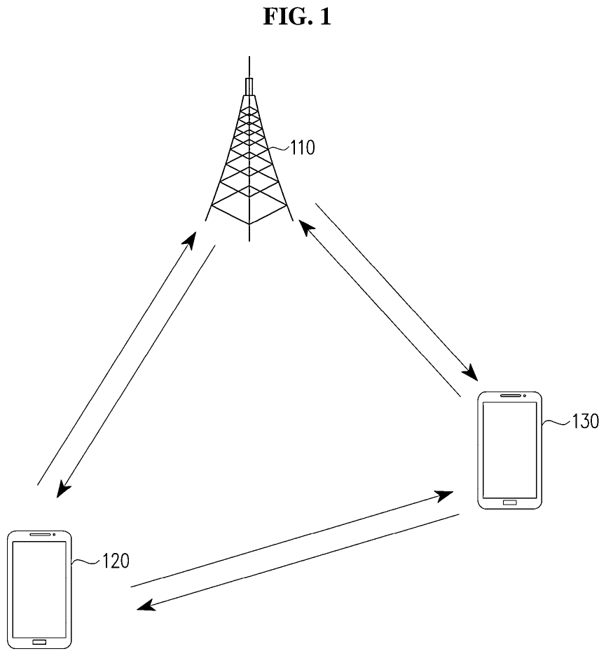

FIG. 1 illustrates a wireless communication system according to exemplary embodiments of the present disclosure. FIG. 1 illustrates a base station 110, a terminal 120, and a terminal 130 as some of nodes which use wireless channels in a wireless communication system. Even though in FIG. 1, only one base station is illustrated, the same or similar other base station as the base station 110 may be further comprised.

The base station 110 is a network infrastructure which provides wireless connection to the terminals 120 and 130. The base station 110 has a coverage defined as a certain geographical area based on a distance over which a signal is transmitted. The base station 110 may also be referred as access point (AP), eNodeB (eNB), a 5th generation node (5G), a next generation node B (gNB), a wireless point, a transmission/reception point (TRP), or other terms having an equivalent technical meaning.

Each of the terminals 120 and 130 are devices used by the user and communicates with the base station 110 through a wireless channel. A link which is directed to the terminal 120 or the terminal 130 from the base station is referred to as a downlink (DL) and a link which is directed to the base station 110 from the terminal 120 or the terminal 130 is referred to as an uplink (UL). Further, the terminal 120 and the terminal 130 perform the communication through a wireless channel therebetween. At this time, the link between the terminal 120 and the terminal 130 is referred to as a sidelink and the sidelink may be interchangeably used with the PC5 interface. In some cases, at least one of the terminal 120 and the terminal 130 may be operated without having involvement of the user. That is, at least one of the terminal 120 and the terminal 130 is a device which performs machine-type communication (MTC) and may not be carried by the user. Each of the terminal 120 and the terminal 130 may be referred to as user equipment (UE), a mobile station, a subscriber station, a remote terminal, a wireless terminal, or a user device, or other term having the equivalent technical meaning.

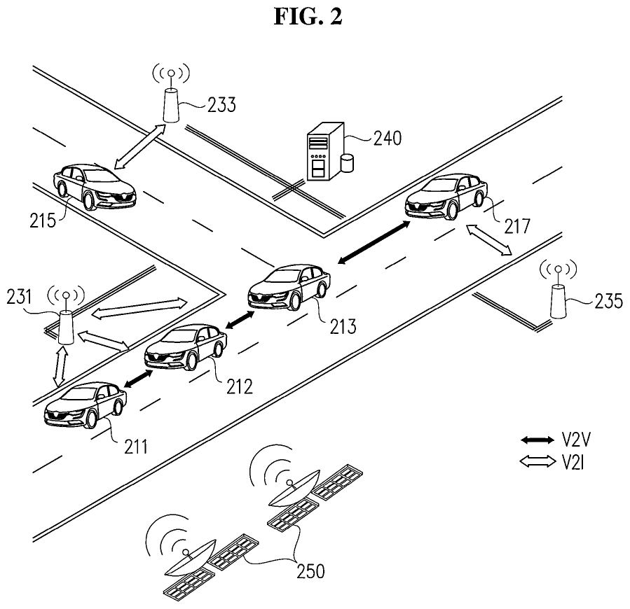

FIG. 2 illustrates an example of a traffic environment according to exemplary embodiments. Vehicles on the road may perform communication. The vehicles which perform the communication are considered as terminals 120 and 130 of FIG. 1 and communication between the terminal 120 and the terminal 130 may be considered as vehicular-to-vehicular (V2V) communication. That is, the terminals 120 and 130 may refer to a vehicle which supports vehicular-to-vehicular communication, a vehicle or a handset (for example, a smart phone) of a pedestrian which supports vehicle-to-pedestrian communication (V2P), a vehicle which supports vehicular-to-network communication (V2N), or a vehicle which supports a vehicular-to-infrastructure (V2I). Further, in the present disclosure, the terminal may refer to a road side unit (RSU) mounted with a terminal function, an RSU mounted with a function of the base station 110, or an RSU mounted with a part of the function of the base station 110 and a part of the function of the terminal 120.

Referring to FIG. 2, vehicles 211, 212, 213, 215, and 217 may be driving on the road. In order to support the communication with a vehicle which is driving, a plurality of RSUs 231, 233, and 235 may be located on the road. Each RSU may perform the function of the base station or a part of the function of the base station. For example, each RSU performs the communication with the vehicle to allocate resources to the individual vehicles and provide a service (for example, autonomous driving service) to each vehicle. For example, the RSU 231 may perform the communication with the vehicles 211, 212, and 213. The RSU 233 performs the communication with the vehicle 215. The RSU 235 performs the communication with the vehicle 217. In the meantime, the vehicle may perform the communication with a network entity of a non-terrestrial network such as a GNSS satellite, as well as the RSU of the terrestrial network.

The RSU controller 240 may control the plurality of RSUs. The RSU controller 240 may assign each RSU ID to each of the RSUs. The RSU controller 240 may generate a neighbor RSU list including RSU IDs of the neighbor RSUs of each RSU. The RSU controller 240 may be connected to each RSU. For example, the RSU controller 240 may be connected to a first RSU 231. The RSU controller 240 may be connected to a second RSU 233. The RSU controller 240 may be connected to a third RSU 235.

The vehicle may be connected to a network through the RSU. However, the vehicle may directly communicate with not only the network entity, such as a base station, but also the other vehicle. That is, the vehicles communicate with each other. That is, not only V2I, but also V2V is possible, and a transmitting vehicle may transmit a message to at least one other vehicle. For example, the transmitting vehicle may transmit a message to at least one other vehicle through a resource allocated by the RSU. As another example, the transmitting vehicle may transmit a message to at least one other vehicle through a resource within a preconfigured resource pool.

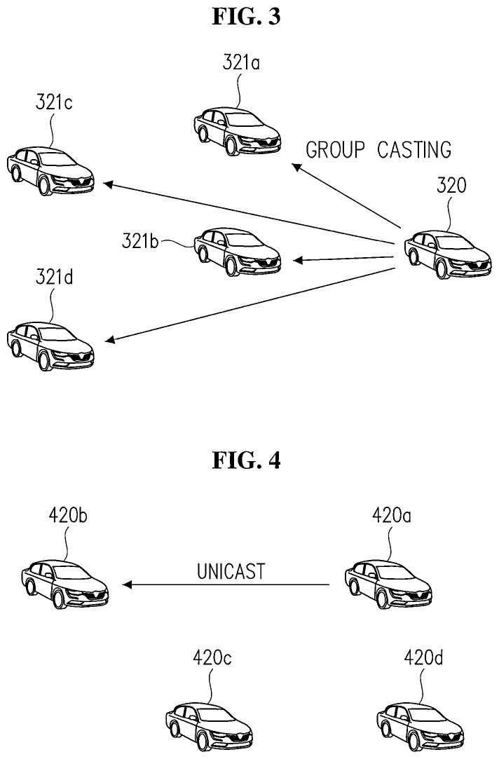

FIG. 3 illustrates an example of a groupcast type vehicle communication according to an exemplary embodiment. Hereinafter, each vehicle illustrates vehicles 211, 212, and 213 of FIG. 2.

Referring to FIG. 3, the one-to-many transmission (point-to-multipoint transmission) scheme may be referred to as a groupcast or multicast. The transmitting vehicle 320, the first vehicle 321a, the second vehicle 321b, the third vehicle 321c, and the fourth vehicle 321d form one group and vehicles in the group perform the groupcast communication. Vehicles perform the groupcast communication in their group and perform the unicast, groupcast, or broadcast communication with at least one other vehicle belonging to the other group. In the meantime, unlike FIG. 3, side-link vehicles perform the broadcast communication. The broadcast communication refers to a scheme in which all neighbor sidelink vehicles receive data and control information transmitted from a sidelink transmitting vehicle through a sidelink. For example, in FIG. 3, when the other vehicle drives in the vicinity of the transmitting vehicle 320, if the other vehicle is not assigned in a group, the other vehicle can't receive the data and control information in accordance with the groupcast communication of the transmitting vehicle 320. However, even though the other vehicle is not assigned in the group, the other vehicle may receive the data and the control information in accordance with the broadcast communication of the transmitting vehicle 320.

FIG. 4 illustrates an example of unicast type of vehicle communication according to an exemplary embodiment.

Referring to FIG. 4, the one-to-one transmission method is referred to as “unicast”. The one-to-many transmission method is referred to as groupcast or multicast. The transmitting vehicle 420a assigns the first vehicle 420b among the first vehicle 420b, the second vehicle 420c, and the third vehicle 420d as a target to receive a message and can transmit a message for the first vehicle 420b. The transmitting vehicle 420a can transmit the message to the first vehicle 420b in the unicast method using a radio access technology (for example, LTE or NR).

Unlike the LTE sidelink, in the case of the NR sidelink, it is considered to support a transmission type that the vehicle transmits data only to one specific vehicle through the unicast and a transmission type that the vehicle transmits data to a plurality of specific vehicles through the groupcast. For example, when a service scenario such as a platooning technique which connects two or more vehicles by one network to be clustered to move is considered, the unicast and groupcast techniques are usefully used. Specifically, in order to allow a leader vehicle of the group connected by the platooning to control one specific vehicle, the unicast communication may be used and in order to allow the leader vehicle to simultaneously control a group formed by a plurality of specific vehicles, the groupcast communication is used.

For example, in the sidelink system such as V2X, V2V, and V2I, the resource allocation may be divided into two modes as follows.

### (1) Mode 1 Resource Allocation

Mode 1 is a method based on scheduled resource allocation which is scheduled by the RSU (or a base station). To be more specific, in Mode 1 resource allocation, the RSU may allocate a resource which is used for sidelink transmission according to a dedicated scheduling method to the RRC connection (radio resource control connection) connected vehicles. Since the RSU manages the resource of the sidelink, the scheduled resource allocation is advantageous for interference management and the management of a resource pool (for example, dynamic allocation and/or semi-persistent transmission). When the RRC connected mode vehicle has data to be transmitted to the other vehicle(s), the vehicle may transmit information notifying the RSU that there is data to be transmitted to the other vehicle(s), using an RRC message or an MAC control element. For example, the RRC message notifying of the presence of data may be sidelink terminal information (SidelinkUEinformation) and terminal assistance information (UEAssistanceinformation). For example, the MAC control element notifying of the presence of the data may be a buffer status report (BSR) MAC control element or a scheduling request (SR) each for sidelink communication. The buffer status report comprises at least one of an indicator notifying that it is BSR and information about a size of data buffered for the sidelink communication. When Mode 1 is applied, the RSU schedules the resource to the transmitting vehicle so that Mode 1 may be applied only when the transmitting vehicle is in a coverage of the RSU.

### (2) Mode 2 Resource Allocation

Mode 2 is a method based on UE autonomous resource selection in which the sidelink transmitting vehicle selects a resource. Specifically, according to Mode 2, the RSU provides a sidelink transmission/reception resource pool for the sidelink to the vehicle as system information or an RRC message (for example, an RRC reconfiguration message or a PC-5 RRC message) and the transmitting vehicle selects the resource pool and the resource according to a determined rule. Because the RSU provides configuration information for the sidelink resource pool, when the vehicle is in the coverage of the RSU, Mode 2 can be used. When the vehicle is out of the coverage of the RSU, the vehicle may perform an operation according to Mode 2 in the preconfigured resource pool. For example, as the autonomous resource selection method of the vehicle, zone mapping or sensing based resource selection or random selection may be used.

### (3) The Other

Additionally, even though the vehicle is located in the coverage of the RSU, the resource allocation or the resource selection may not be performed in the scheduled resource allocation or vehicle autonomous resource selection mode. In this case, the vehicle may perform the sidelink communication through a preconfigured resource pool.

Currently, in order to implement the autonomous vehicle, many companies and developers make an effort to allow the vehicle to autonomously perform all the tasks which are performed by a human while driving the vehicle, in the same way. The tasks are divided into a perception step which recognizes surrounding environments of the vehicle through various sensors, a decision-making step which determines how to control the vehicle using various information perceived by the sensors, and a control step which controls the operation of the vehicle according to the determined decision.

In the perception step, data of the surrounding environment is collected by a radar, a LIDAR, a camera, and an ultrasonic sensor and a vehicle, a pedestrian, a road, a lane, and an obstacle are perceived using the data. In the decision-making step, a driving circumstance is recognized based on the result perceived in the previous step, a driving route is searched, and vehicle/pedestrian collision prevention, and obstacle avoidance are determined to determine an optimal driving condition (a route and a speed). In the control step, instructions to control a drive system and a steering system are generated to control the vehicle driving and the motion based on the perception and determination results. In order to implement more complete autonomous driving, it is desirable to utilize information received from the other vehicle or road infrastructures through a wireless communication device mounted in the vehicle in the perception step, rather than recognizing of the external environment of the vehicle only using sensors mounted in the vehicle.

As such a wireless communication related technology for a vehicle, various technologies have been studied for a long time and a representative technology, among the technologies, is an intelligent transport system (ITS). Recently, as one of the technologies for realizing the ITS, a vehicular Ad hoc network (VANET) is attracting attention. VANET is a network technique which provides V2V and V2I communication using a wireless communication technique. Various services are provided using VANET to transmit various information such as a speed or a location of a neighbor vehicle or traffic information of a road on which the vehicle is driving to the vehicle to allow the driver to safely and efficiently drive the vehicle. Specifically, it is important to transmit an emergency message required for the driver for the purpose of secondary accident prevention and efficient traffic flow management, like traffic accident information.

In order to transmit various information to all the drivers using the VANET, a broadcast routing technique is used. The broadcast routing technique is the simplest method used to transmit the information so that when a specific message is sent, regardless of the ID of the receiver or whether to receive the message, the message is transmitted to all nearby vehicles and the vehicle which receives the message retransmits the message to all nearby vehicles to transmit the message to all the vehicles on the network. As described above, the broadcast routing method is the simplest method to transmit information to all the vehicles but enormous network traffics are causes so that a network congestion problem called a broadcast storm is caused in urban areas with a high vehicle density. Further, according to the broadcast routing method, in order to limit a message transmission range, a time to live (TTL) needs to be set but the message is transmitted using a wireless network, so that there is a problem in that the TTL cannot be accurately set.

In order to solve the broadcast storm problem, studies according to various methods, such as probability based, location based, and clustering based algorithms are being conducted. However, in the case of the probability based algorithm, a vehicle to retransmit the message is probabilistically selected so that in the worst case, the retransmission may or may not occur in the plurality of vehicles. Further, in the case of the clustering based algorithm, if the size of the cluster is not sufficiently large, the frequent retransmission may occur.

The following application technology is being studied to satisfy the above-mentioned VANET security requirements. Each vehicle which is present in the vehicle network embeds an immutable tamper-proof device (TPD) therein. In the TPD, a unique electronic number of the vehicle is present and secrete information for a vehicle user is stored. Each vehicle performs the user authentication through the TPD. The digital signature is a message authentication technique used to independently authenticate the message and provide a non-repudiation function for a user who transmits a message. Each message comprises a signature which is signed with a private key of the user and the receiver of the message verifies a signed value using a public key of the user to confirm that the message is transmitted from a legitimate user.

Institute of electrical and electronics engineers (IEEE) 1609.2 is a wireless access in vehicular environments (WAVE) related standard which is a wireless communication standard in a vehicle environment and studies a security specification which should be followed by the vehicle during the wireless communication with the other vehicle or an external system. When a wireless communication traffic in the vehicle is suddenly increased in the future, the number of attacks, such as eavesdropping, spoofing, a packet reuse which occurs in a normal network environment will also increase, which obviously have a very negative affect on the safety of the vehicle. Accordingly, in the IEEE 1609.2, a public key infrastructure (PKI) based VANET security structure is standardized. The vehicular PKI (VPK) is a technique of applying the internet based PKI to the vehicle and TPD includes a certificate provided from an authorized agency. Vehicles use the certificates granted by the authorized agencies to authenticate themselves and the other party in the vehicle to vehicle (V2V) or vehicle to infrastructure (V2I) communication. However, in the PKI structure, vehicles move at a high speed so that in the service which requests a quick response such as a vehicle urgent message or a traffic situation message, it is difficult for vehicles to quickly response due to a procedure for verifying the validity of the certificate of the message transmitting vehicle. Anonymous keys are used to protect privacies of the vehicles which use the network in the VANET environment and in the VANET, the personal information leakage is prevented by the anonymous keys.

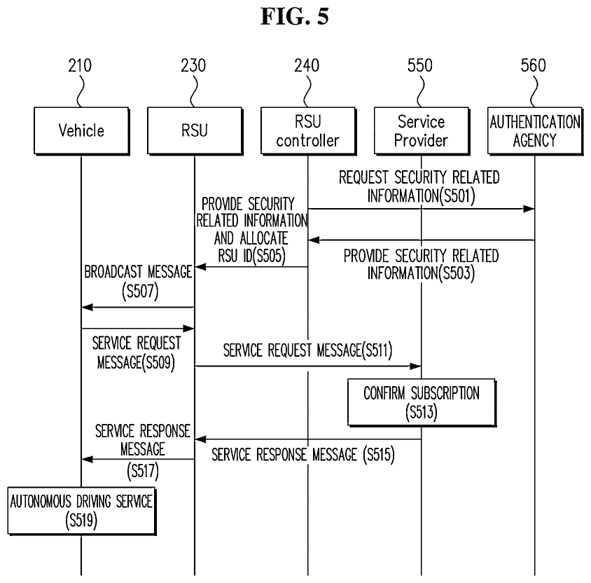

As described above, various methods are being studied to quickly transmit event messages which are generated in various situations in the VANET environment to the other vehicle or infrastructure while maintaining a high security. However, generally, in order to maintain a high security, various authentication procedures need to be additionally performed to verify the complex encryption algorithm and/or integrity, which acts as an obstacle to quickly transmit/receive data for safe driving of a device which moves at a high speed, such as a vehicle. Accordingly, exemplary embodiments for transmitting data generated in a vehicle in which an event occurs to the other vehicle while maintaining a high security will be described below. First, referring to FIG. 5, messages and related procedures required for the vehicle which performs the autonomous driving service will be described.

### (1) Encryption in Unit of RSU

FIG. 5 illustrates an example of an autonomous driving service establishment procedure by a road side unit (RSU) according to an exemplary embodiment. The vehicle 210 which receives the autonomous driving service illustrates a vehicle 211, 212, 213, 215, or 217 of FIG. 2. The same reference numeral may be used for corresponding description.

Referring to FIG. 5, in an operation S501, the RSU controller 240 may transmit a request message for requesting security related information to the authentication agency server 560. The authentication agency server 560 is an agency which manages or supervises the plurality of RSUs and generates and manages a key and a certificate for each RSU. Further, the authentication agency server 560 issues a certificate for a vehicle or manages the issued certificate. The RSU controller 240 requests an encryption key/decryption key to be used in the coverage of each RSU to the authentication agency server 560.

In an operation S503, the authentication agency server 560 transmits a response message including security related information. The authentication agency server 560 generates the security related information for the RSU controller 240 in response to the request message. According to the exemplary embodiment, the security related information may comprise encryption related information to be applied to a message between the RSU and the vehicle. For example, the security related information may comprise at least one of an encryption method, an encryption version (may be a version of an encryption algorithm), and a key to be used (for example, a symmetric key or a public key).

In an operation S505, the RSU controller 240 provides a setting message including an RSU ID and security related information to each RSU (for example, an RSU 230). The RSU controller 240 is connected to one or more RSUs. According to the exemplary embodiment, the RSU controller 240 configures security related information required for the individual RSU of one or more RSUs based on the security related information acquired from the authentication agency server 560. The RSU controller 240 may allocate the encryption/decryption key to be used to each RSU. For example, the RSU controller 240 may configure security related information to be used for the RSU 230. According to the exemplary embodiment, the RSU controller 240 may allocate an RSU ID for one or more RSUs. The setting message may comprise information related to the RSU ID allocated to the RSU.

In an operation S507, the RSU 230 may transmit a broadcast message to the vehicle 210. The RSU 230 generates the broadcast message based on the security related information and the RSU ID. The RSU 230 may transmit the broadcast message to vehicles (for example, a vehicle 210) in the coverage of the RSU 230. The vehicle 210 may receive the broadcast message. For example, the broadcast message may have a message format as represented in the following Table 1.

TABLE 1

| Field | Description | Note |
|---|---|---|
| Message Type | Broadcast | Broadcast message is transmitted |
| | | through R2V communication |
| RSU ID | ID of RSU which transmits | Serving RSU ID |
| | Broadcast message | |
| Location information | Location information of RSU | |
| of RSU | | |
| Neighbor RSU's | List information of neighbor | |
| information | RSU | |
| Encryption Policy | Encryption policy | |
| | information | |
| Encryption scheme | symmetric-key scheme | Information indicating whether |
| | asymmetric-key scheme | applied encryption scheme is |
| | | symmetric key scheme or |
| | | asymmetric key scheme |
| Encryption algorithm | Encryption algorithm version | Information indicating encryption |
| version | Information | version |
| Encryption | Encryption Key | Key information used according to |
| Key/Decryption Key | information/Decryption Key | applied encryption scheme |
| | information | (for example, when asymmetric key |
| | | scheme is used, public key is used |
| | | for encryption/decryption and when |
| | | symmetric key scheme is used, |
| | | symmetric key is used for |
| | | encryption/decryption |
| Key information | Key issued date, key valid | |
| | date, authentication agency | |
| | information, key version | |
| | information | |

The symmetric key scheme means an algorithm in which same key is used for both encryption and decryption. One symmetric key may be used for both the encryption and the decryption. For example, as an algorithm for the symmetric key scheme, data encryption standard (DES), advanced encryption standard (AES), and SEED may be used. The asymmetric key scheme refers to an algorithm which performs the encryption and/or decryption by a public key and a private key. For example, the public key is used for the encryption and the private key may be used for the decryption. As another example, the private key is used for the encryption and the public key may be used for the decryption. As an example, an algorithm for the symmetric key scheme may use Rivest, shamir and adleman (RSA) and elliptic curve cryptosystem (ECC).

According to the exemplary embodiment, the vehicle 210 receives the broadcast message to identify a serving RSU corresponding to a coverage in which the vehicle 210 enters, that is, RSU 230. The vehicle 210 may identify the encryption method in the RSU 230 based on the broadcast message. For example, the vehicle 210 may identify the encryption scheme in the RSU 230. For example, the vehicle 210 may decrypt the encrypted message by the public key or the symmetric key of the RSU 230. In the meantime, the broadcast message illustrated in Table 1 is illustrative and exemplary embodiments of the present disclosure are not limited thereto. When an encryption scheme used for the communication between the vehicle 210 and the RSU 230 is determined in advance in the specification of the communication, at least one of elements (for example, an encryption scheme) of the broadcast message may be omitted.

In an operation S509, the vehicle 210 may transmit a service request message to the RSU 230. After receiving the broadcast message, the vehicle 210 which enters the RSU 230 may start the autonomous driving service. In order to engage the autonomous driving service, the vehicle 210 may generate a service request message. For example, the service request message may have a message format as represented in the following Table 2.

TABLE 2

| Field | Description | Note |
|---|---|---|
| Service Request ID | Service Request ID | Information for identifying |
| | | autonomous driving service requested |
| | | by vehicle (for distinguishing from |
| | | autonomous driving service request |
| | | received from the other vehicles) |
| Vehicle ID | Vehicle Identifier | Unique information allocated to |
| | | identify vehicles (VIN, SIM(subscriber |
| | | identification module), vehicle IMSI |
| | | (international mobile subscriber |
| | | identity), and the like)//may be |
| | | allocated from vehicle manufacturing |
| | | company or wireless communication |
| | | service provider |
| User ID | User Identifier | User ID who requests autonomous |
| | | driving service (User ID subscribing to |
| | | autonomous driving service) |
| Start location | Location where | Autonomous driving start location |
| | autonomous driving | (location information of vehicle, |
| | service starts | electronic device) |
| Destination location | Location where | Autonomous driving service ending |
| | autonomous driving | location (destination information input |
| | service ends | by user) |
| | (destination) | |
| Serving RSU ID | Serving RSU ID | RSU ID of coverage in which current |
| | | vehicle is located |
| Map data version | Map Data Version | Map data version information stored in |
| | | current vehicle |
| Autonomous driving | Autonomous driving | Autonomous driving software version |
| software version | software version | stored in current vehicle |

In the meantime, the service request message illustrated in Table 2 is illustrative and exemplary embodiments of the present disclosure are not limited thereto. According to the exemplary embodiment, the service request message may further comprise additional information (for example, an autonomous driving service level or a capability of the vehicle). According to another exemplary embodiment, at least one (for example, the autonomous driving service start location) of elements of the service request message may be omitted.

In an operation S511, the RSU 230 may transmit a service request message to the service provider server 550.

In an operation S513, the service provider server 550 confirms subscription information. The service provider server 550 confirms the user ID and a vehicle ID of the service request message to identify whether the vehicle 210 subscribes to the autonomous driving service. When the vehicle 210 subscribes the autonomous driving service, the service provider server 550 may store information of a service user.

In an operation S515, the service provider server 550 may transmit a service response message to the RSU 230. The service provider server 550 may generate driving plan information for the vehicle 210 based on the service request message of the vehicle 210 received from the RSU 230.

According to an exemplary embodiment, the service provider server 550 may acquire a list of one or more RSUs which are adjacent to each other or located in a predicted route, based on the driving plan information. For example, the list may comprise at least one of the RSU IDs allocated by the RSU controller 240. Whenever the vehicle 210 enters a new RSU along the route, the vehicle 210 identifies to reach the RSU on the driving plan information through the RSU ID of the broadcast message of the new RSU.

According to the exemplary embodiment, the service provider server 550 may generate encryption information of each RSU of the list. In order to collect and process information generated from a region to be passed by the vehicle 210, that is, the RSU, it is necessary to know previous encryption information about each RSU. Accordingly, the service provider server 550 generates encryption information for every RSU for the predicted route and includes the generated encryption information in the service response message. For example, the service response message may have a message format as represented in the following Table 3.

TABLE 3

| Field | Description | Note |
|---|---|---|
| Service | Service Request ID | Service request message ID corresponding to |
| request | | Response |
| response | | |
| Route plan | Start Point, Destination Point, | Route plan information calculated from start |
| information | Global Path Planning | point to destination point (hereinafter, driving |
| | information (Route Number, | plan information), cost value for each of |
| | Cost vales for each calculated | plurality of routes from start point to |
| | route) | destination point |
| Neighbor | RSU 32, RSU 33, RSU 34, | RSU list information present on calculated |
| RSU List | RSU 35 etc. | route (for example, list of RSU ID allocated |
| | | by RSU controller 240) |
| Pre- | RSU 32: 04 CE D7 61 49 49 | N pre-encryption keys allocated to each RSU |
| Encryption | FD; | existing on route (here, N is integer of 1 or |
| Key | RSU 33: 11 70 4E 49 16 61 FC; | larger) |
| | RSU 34: FA 7F BA 6F 0C 05 | |
| | 53; | |
| | RSU 35: 1B 86 BC A3 C5 BC | |
| | D8. Etc. | |

In an operation S517, the RSU 230 may transmit a service response message to the vehicle 210. The RSU 230 may transmit a service response message received from the service provider server 550 to the vehicle 210.

In an operation S519, the vehicle 210 may perform the autonomous driving service. The vehicle 210 may perform the autonomous driving service based on the service response message. The vehicle 210 may perform the autonomous driving service based on a predicted route of the driving plan information. The vehicle 210 may move along each RSU present on the path.

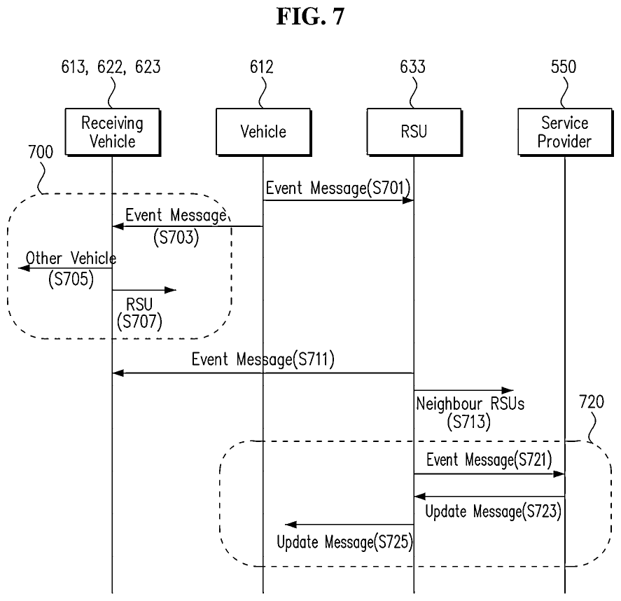

According to the exemplary embodiment, a sender who transmits a message in the coverage of the RSU may transmit a message based on the public key or the symmetric key of the RSU. For example, the RSU 230 may encrypt the message (the service response message of the operation S517 or an event message of an operation S711 of FIG. 7), based on the public key or the symmetric key of the RSU. When there is no private key corresponding to the public key of the RSU or symmetric key, the receiver cannot decrypt the message. For example, a vehicle which does not have a private key corresponding to the public key of the RSU or a vehicle which does not have a symmetric key cannot decrypt the message.

According to the exemplary embodiment, a message transmitted from the vehicle may be encrypted based on the private key or the symmetric key of the vehicle. When the symmetric key algorithm is used, the sender may transmit a message (for example, an event message of the operation S701 of FIG. 7) using the symmetric key of the RSU. The receiver may acquire the symmetric key through the broadcast message of the operation S501 or the service response message of the operation S515. The receiver decrypts the message. In the meantime, when the asymmetric key algorithm is used, a private key of the vehicle and a public key of the RSU which services the vehicle may be grouped for the asymmetric key algorithm. A private key may be allocated to each vehicle in the RSU and a public key may be allocated to the RSU. Each private key and public key may be used for encryption/decryption or decryption/encryption. The sender may transmit a message (for example, an event message of the operation S701 of FIG. 7) using a private key corresponding to the public key of the RSU. The receiver should know the public key of the RSU to decrypt the message. When the receiver is a vehicle which knows the public key of the RSU, even though the receiver is in a coverage of an RSU different from a serving RSU of a vehicle which transmits the event message, the receiver can decrypts the event message. To this end, the service response message for autonomous driving may provide encryption information (for example, a pre-encryption key) for the RSU on the driving route to the vehicle.

Even though in FIG. 5, a situation in which a broadcast message is received and a service request message is transmitted has been described, the exemplary embodiments of the present disclosure is not limited thereto. Whenever the vehicle 210 newly enters a coverage of the RSU, it does not always transmit the service request message. The vehicle 210 may transmit the service request message through the serving RSU periodically or in accordance with generation of a specific event. That is, when the vehicle 210 enters the other RSU, if the vehicle 210 already has the driving plan information, the vehicle may not transmit the service request message after receiving the broadcast message.

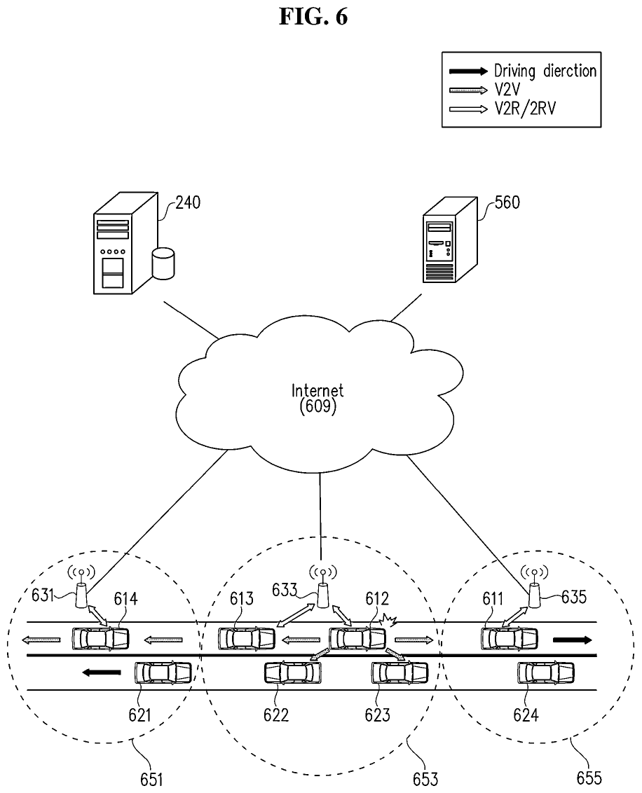

In FIG. 5, for the autonomous driving service, an example that the vehicle 210 enters a new RSU and finds out RSUs on a predicted route through the service provider server has been described. As the autonomous driving server (for example, a service provider server 550) senses an event in advance, instead of manually setting the route, the autonomous driving service is used to provide adaptive driving information. That is, even though an unexpected event occurs, the autonomous driving server collects and analyzes information about the event to provide the changed driving route to the vehicle. Hereinafter, a situation in which the event occurs during the driving is described with reference to FIG. 6.

### (2) Event Message

FIG. 6 illustrates an example of an autonomous driving service based on an event according to an exemplary embodiment.

Referring to FIG. 6, vehicles 611, 612, 613, 614, 621, 622, 623, 624 and RSUs 631, 633, and 635 in a traffic environment (for example, highways or motorways) in which a driving direction is specified are illustrated. Vehicles 611, 612, 613, 614, 621, 622, 623, 624 illustrate vehicles 211, 212, 213 of FIG. 2 or a vehicle 210 of FIG. 5. Description for the vehicles described with reference to FIGS. 2 to 5 may be applied to the vehicles 611, 612, 613, 614, 621, 622, 623, 624. The RSUs 631, 633, and 635 illustrate the RSUs 231, 233, and 235 of FIG. 2 or the RSU 230 of FIG. 5. Description for the RSU described with reference to FIGS. 2 to 5 may be applied to the RSUs 631, 633, 635.

The vehicle may move along the driving direction. The driving direction may be determined according to a lane on which the vehicle drives. For example, the vehicles 611, 612, 613, and 614 may drive on an upper lane of two lanes. A driving direction of the upper lane may be from the left to the right. The vehicles 621, 622, 623, and 624 may drive on a lower lane between two lanes. A driving direction of the lower lane may be from the right to the left.

The RSU may provide a wireless coverage to support the vehicle communication (for example, a V2I). The RSU may communicate with a vehicle which enters the wireless coverage. For example, the RSU 631 may communicate with the vehicles 614 and 621 in the coverage 651 of the RSU 631. The RSU 633 may communicate with the vehicle 612, the vehicle 613, the vehicle 622, and the vehicle 623 in the coverage 653 of the RSU 633. The RSU 635 may communicate with the vehicles 611 and 624 in the coverage 655 of the RSU 635.

Each RSU may be connected to the RSU controller 240 through the Internet 609. Each RSU may be connected to the RSU controller 240 via a wired network or be connected to the RSU controller 240 via a backhaul interface (or a fronthaul interface). Each RSU may be connected to the authentication agency server 560 through the Internet 609. The RSU may be connected to the authentication agency server 560 via the RSU controller 240 or be directly connected to the authentication agency server 560. The authentication agency server 560 may authenticate and manage the RSU and the vehicles.

A situation in which an event occurs in the vehicle 612 in the coverage of the RSU 633 is assumed. A situation in which the vehicle 612 is bumped into an unexpected obstacle or the vehicle 612 cannot be normally driven due to a functional defect of the vehicle may be detected. The vehicle 612 may notify the other vehicles (for example, the vehicle 613, the vehicle 622, and the vehicle 623) or the RSU (for example, the RSU 633) of the event of the vehicle 612. The vehicle 612 broadcasts an event message including event related information.

The event message according to the exemplary embodiments of the present disclosure comprises various information to accurately and efficiently operate the autonomous driving service. Hereinafter, elements comprised in the event message are illustrated. Not all elements to be described below are necessarily comprised in the event message, so that in some exemplary embodiments, at least some of the elements to be described below may be comprised in the event message.

According to an exemplary embodiment, the event message may comprise vehicle information. The vehicle information may comprise information representing/indicating a vehicle which generates an event message. For example, the vehicle information may comprise a vehicle ID. Also, for example, the vehicle information is information about the vehicle itself and may comprise information about a vehicle type (for example, a vehicle model or a brand), a vehicle model year, or a mileage.

According to an exemplary embodiment, the event message may comprise RSU information. For example, the RSU information may comprise identification information (for example, a serving RSU ID) of a serving RSU of a vehicle in which event occurs (hereinafter, a source vehicle). Further, for example, the RSU information may comprise driving information of a vehicle in which an event occurs or identification information (for example, a RSU ID list) of RSUs according to the driving route.

According to an exemplary embodiment, the event message may comprise location information. For example, the location information may comprise information about a location where the event occurs. For example, the location information may comprise information about a current location of the source vehicle. Further, for example, the location information may comprise information about a location where the event message is generated. The location information may indicate an accurate location coordinate. Further, as an additional exemplary embodiment, the location information may further comprise information about whether an event occurrence location is in the middle of the road, or an entrance ramp or an exit ramp of a motorway or which lane number is.

According to an exemplary embodiment, the event message may comprise event related information. The event related data may refer to data collected from the vehicle when the event occurs. The event related data may refer to data collected by a sensor or a vehicle for a predetermined period. The predetermined period may be determined based on a time when the event occurs. For example, the predetermined period may be set to be from earlier than the event occurring time by a specific time (for example, five minutes) to after a specific time (for example, one minute) from the event occurring time. For example, the event related data may comprise at least one of image data, impact data, steering data, speed data, accelerator data, braking data, location data, and sensor data (for example, light detection and ranging (LiDAR) sensor or radio detection and ranging (RADAR) sensor data).

According to an exemplary embodiment, the event message may comprise priority information. The priority information may be information representing the importance of the generated event. For example, “1” of the priority information may indicate that collision or fire occurs in the vehicle. “2” of the priority information may indicate the malfunction of the vehicle. “3” of the priority information may indicate that there is an object on the road. “4” of the priority information may indicate that previously stored map data and the current road information are different. The higher the value of the priority information, the lower the priority.

According to an exemplary embodiment, the event message may comprise event type information. Like the priority information, the service provider for the autonomous driving service may provide an adaptive route setting or an adaptive notification according to a type of the event occurring in the vehicle. For example, when there is a temporal defect of the vehicle (for example, a foreign material is detected, a display defect, end of a media application, a buffering phenomenon for a control instruction, or erroneous side mirror operation) or there is no influence on the other vehicle, the service provider may not change driving information about the vehicle which is out of a predetermined distance. Further, for example, when the vehicle is discharged or a fuel is insufficient, the service provider calculates a normalization time and resets driving information based on the normalization time. To this end, a plurality of types of events of the vehicle may be defined in advance for every step and the event type information may indicate at least one of the plurality of types.

According to an exemplary embodiment, the event message may comprise driving direction information. The driving direction information may indicate a driving direction of the vehicle. The road may be divided into a first lane and a second lane with respect to a direction in which the vehicle drives. The first lane has a driving direction directed to a driver with respect to the driver of a specific vehicle and the second lane has a driving direction to which the driver is directed. For example, when the vehicle moves along the first lane, driving direction information may indicate “1” and when the vehicle moves along the second lane, the driving direction information may indicate “0”. For example, because the vehicle 612 is driving on the first lane, the vehicle 612 may transmit an event message including the driving direction information which indicates “1”. As another example, because the vehicle 621 is driving on the second lane, the vehicle 621 may transmit an event message including the driving direction information which indicates “0”. When the driving direction of the source vehicle and the driving direction of the receiving vehicle are different, the driving information of the receiving vehicle does not need to be changed based on the event. Accordingly, for the purpose of the efficiency of the autonomous driving service through the event message, the driving direction information may be comprised in the event message.

According to an exemplary embodiment, the event message further comprises lane information. Like the driving direction information, the event of the vehicle located on the first lane may less affect a vehicle which is located on a fourth lane. The service provider may provide an adaptive route setting for every lane. To this end, the source vehicle may comprise the lane information in the event message.

According to an exemplary embodiment, the event message may comprise information about a time when the event message is generated (hereinafter, generating time information). The event message may be provided through a link between vehicles and/or a vehicle and the RSU. That is, as the event message is transmitted through a multi-hop method, after elapsing a sufficient time since the event occurs, a situation in which the event message is received may occur. In order to identify an event occurrence time of the vehicle which receives the event message, the generation time information may be comprise in the event message.

According to an exemplary embodiment, the event message may comprise transmission method information. The event message may be provided from the RSU to the other vehicle again through a link between the vehicle and the vehicle and/or between the vehicle and RSU. Accordingly, in order for a vehicle or an RSU which receives the event message to recognize a transmission method of the currently received event message, the transmission method information may be comprised in the event message. The transmission method information may indicate whether the event message is transmitted by V2V scheme or transmitted by a V2R (or R2V) scheme.

According to an exemplary embodiment, the event message comprises vehicle maneuver information. The vehicle maneuver information may refer to information about vehicle itself when event occurs. For example, the vehicle maneuver information may comprise information about a state of the vehicle in case of the event occurrence, a wheel of the vehicle, and whether to open/close the door.

According to an exemplary embodiment, the event message may comprise driver behavior information. The driver behavior information may refer to information about vehicle manipulation by the driver when an event occurs. The driver behavior information may refer to information which is manually manipulated by the driver by releasing an autonomous driving mode. For example, the driver behavior information may comprise information about braking, steering manipulation, and ignition when the event occurs.

For example, the message transmitted by the vehicle 612 may have a message format as represented in the following Table 4.

TABLE 4

| Field | Description | Note |
|---|---|---|
| Source Vehicle | Information indicating vehicle which | Source Vehicle: True |
| | generates event message | Other vehicle: False |
| Vehicle ID | Vehicle Identifier | ID allocated to vehicle |
| Message Type | Event message | Message Type is indicated |
| Location | Location information in which event | |
| Information | message is generated | |
| Event related data | Image data, Impact data, steering data, | Information acquired with |
| | speed data, acceleration data, braking | regard to event |
| | data, location data | |
| Generated Time | Message generation time | To figure out whether |
| | | message available period |
| | | has elapsed |
| Serving RSU | Serving RSU ID | Serving RSU ID of coverage |
| Information | | in which vehicle is located |
| Driving direction | Information indicating driving | “1” or “2” |
| | direction of source vehicle in which | |
| | event occurs | |
| Transmission | Transmission method information by | Information indicating |
| Information | which event message is transmitted | whether event message is |
| | | transmitted by V2V |
| | | communication scheme or |
| | | transmitted by V2R (R2V) |
| | | communication scheme |
| Priority | “1”: when collision of source vehicle | It is determined in advance |
| Information | occurs or fire occurs | depending on event type |
| | “2”: when malfunction of source | which may occur on road |
| | vehicle occurs | |
| | “3”: when dangerous object is | |
| | detected on road | |
| | “4”: when road information different | |
| | from previously stored electronic map | |
| | data is acquired | |
| Vehicle maneuver | GPS, odometry information, a gyro | Vehicle maneuver |
| information | information and kinematic information | information when event |
| | | occurs |
| Driver behavior | When the event occurred, information | Driver behavior information |
| information | which human driver operates to | (vehicle manipulation |
| | maneuver a vehicle. | information) when event |
| | | occurs |
| | | (Information which is |
| | | manually manipulated by |
| | | user after releasing |
| | | autonomous driving mode) |

In the meantime, the event message illustrated in Table 4 is illustrative and exemplary embodiments of the present disclosure are not limited thereto. In order to reduce the weight of the event message, at least one of elements of the event message (for example, transmission information of event message) may be omitted.

FIG. 7 illustrates an example of signaling between entities for setting a driving route based on an event according to an exemplary embodiment. In FIG. 7, an example of resetting a driving route based on an event of the vehicle 612 of FIG. 6 will be described.

Referring to FIG. 7, in an operation S701, the vehicle 612 may transmit an event message to the RSU 633. The vehicle 612 may detect the occurrence of the event of the vehicle 612. The vehicle 612 may generate the event message based on the event of the vehicle 612. The vehicle 612 may transmit the event message to the RSU 633 which is a serving RSU of the vehicle 612. The event message may be the event message which has been described with reference to FIG. 6. According to the exemplary embodiment, the event message may comprise at least one of vehicle information, RSU information, location information, event related information, priority information, event type information, driving direction information, lane information, generation time information, transmission scheme information, vehicle maneuver information and driver behavior information.

The vehicle 612 may transmit the event message not only to the serving RSU, but also the other vehicle or the other RSU (700). In an operation S703, the vehicle 612 may transmit the event message to the other vehicle (hereinafter, receiving vehicle). In an operation S705, the receiving vehicles (for example, the vehicle 613, the vehicle 622, and the vehicle 623) may transmit the event message to the other vehicle. In an operation S707, the receiving vehicle may transmit the event message to the other RSU.

When the RSU 633 receives the event message from the vehicle 612, the RSU may verify the integrity for the event message. When the RSU 633 receives the event message from the vehicle 612, the RSU may decrypt the event message. When the integrity and the decryption are completed, the RSU 633 may transmit the event message to the other receiving vehicle (for example, the vehicle 613) or the neighbor RSU (for example, RSU 635). In an operation S711, the RSU 633 may transmit the event message to the receiving vehicle. In an operation S713, the RSU 633 may transmit the event message to the other RSU.

The RSU 633 may update the autonomous driving data based on the event of the vehicle 612 (720). In an operation S721, the RSU 633 may transmit the event message to the service provider server 550. The event of the vehicle 612 may affect not only the vehicle 612, but also the other vehicle. Accordingly, the RSU 633 may transmit the event message to the service provider server 550 to reset the driving route of the vehicle which is using the autonomous driving service.

In an operation S723, the service provider server 550 may transmit an update message to the RSU 633. The service provider server 550 may reset the driving route for every vehicle based on the event. If the driving route should be changed, the service provider server 550 may generate an update message including the reset driving route information. For example, the update message may have a message format as represented in the following Table 5.

According to an exemplary embodiment, the update message comprises driving plan information. The driving plan information may refer to a driving route which is newly calculated from the current location of the vehicle (for example, the vehicle 612 and the vehicle 613) to the destination. Further, according to the exemplary embodiment, the update message may comprise a list of one or more RSUs present on the calculated route. When the driving route is changed, the RSU which is adjacent to the driving route or located in the driving route is changed so that the list of the updated RSUs is comprised in the update message. Further, according to an exemplary embodiment, the update message may comprise encryption information. Since the driving route is changed, the RSU ID for the RSU which is adjacent to the driving route or located on the driving route is changed. In the meantime, the encryption information for the RSU which is repeated due to the update may be omitted from the update message to reduce the weight of the update message.

TABLE 5

| Field | Description | Note |
|---|---|---|
| Route plan | Link ID, Node ID, route ID and | Route plan information calculated from |
| information | cost value for each route ID | start location to destination (hereinafter, |
| | related to planned route | driving route information) |
| Neighbor RSU | Please refer to the Table 3 | List information of RSU present on |
| List | | calculated route (for example, List of RSU |
| | | IDs allocated by RSU controller 240) |
| Pre- | Please refer to the Table 3 | N pre-encryption keys allocated to each |
| Encryption | | RSU present on route (here, N is integer of |
| Key | | 1 or larger) |

In an operation S725, the RSU 633 may transmit the update message to the vehicle 613, the vehicle 622, and the vehicle 623. The update message received from the service provider server 550 may comprise driving information for every vehicle in a coverage of the RSU 633 and the RSU 633 may identify the driving information for the vehicle 612. The RSU 633 may transmit the update message including the driving information for the vehicle 612 to the vehicle 612.

According to the exemplary embodiment, the event message transmitted from the vehicle (for example, the vehicle 612 and the vehicle 613) may be encrypted based on the private key of the vehicle. The private key of the vehicle and the public key of the RSU (for example, the RSU 633) which services the vehicle may be used for the asymmetric key algorithm. The sender may transmit a message (for example, an event message of the operation S701) using a symmetric key or a private key corresponding to the public key of the RSU. For example, the sender may be a vehicle. The receiver should know the symmetric key or the public key of the RSU to decrypt the message. When the receiver is a vehicle which knows the public key of the RSU (hereinafter, receiving vehicle), even though the receiver is in a coverage of an RSU different from a serving RSU of a vehicle which transmits the event message, the receiving vehicle may decrypt the event message. To this end, the receiving vehicle may acquire and store the encryption information (for example, the pre-encryption key) for the RSU on the driving route through the service response message (for example, the service response message of FIG. 5).

Even though in FIG. 7, only the maneuver of the vehicle (for example, the vehicle 612) in which the accident occurs in the serving RSU (for example, the RSU 633) has been described, the exemplary embodiments of the present disclosure are not limited thereto. The driving information which is reset according to the event message needs to be shared with the other RSUs (for example, the RSU 631 and the RSU 635) and the other vehicles (for example, the vehicle 614 and the vehicle 621). The service provider server 550 may transmit the update message to the other vehicles through the other RSU.

Even though it is not illustrated in FIG. 7, the vehicle 612 in which the accident occurs may end the autonomous driving. The vehicle 612 may transmit a service end message to the service provider server 550 through the RSU 633. Thereafter, the service provider server 550 may discard information about the vehicle 612 and information about a user of the vehicle 612.

### (3) Driving Route and RSU

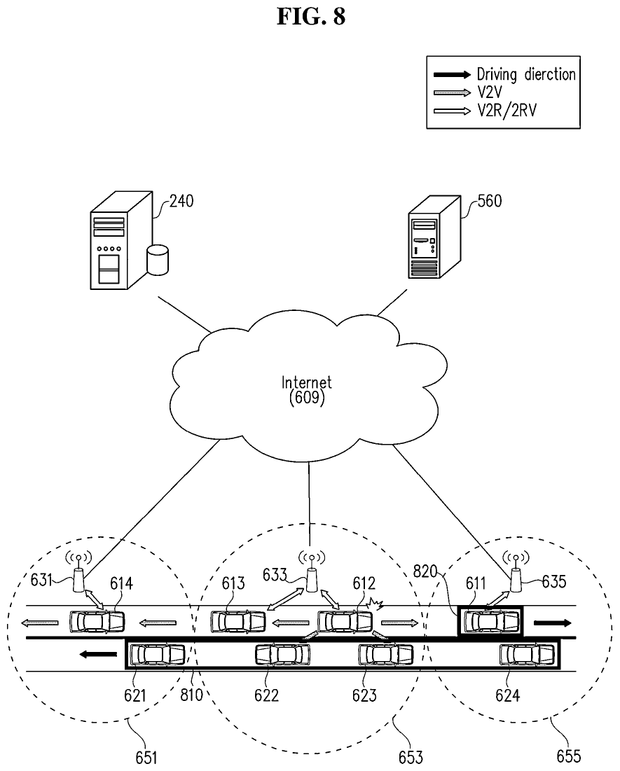

FIGS. 8 to 10 illustrate an example of efficiently processing an event message when a driving route is set based on an event according to an exemplary embodiment. In order to describe the driving environment related to the event, the driving environment of FIG. 6 is illustrated. The same reference numeral may be used for the same description.

Referring to FIG. 8, the vehicle 611, the vehicle 612, the vehicle 613, and the vehicle 614 may be driving on the first lane. A driving direction of the first lane may be from the left to the right. The first lane may be a left side with respect to the driving direction of the driver. The vehicles 621, 622, 623, and 624 may be driving on a second lane. A driving direction of the second lane may be from the right to the left. The driving direction of the second lane may be opposite to the driving direction of the first lane.

A vehicle which is not affected by an event of a specific vehicle does not need to recognize the event of the specific vehicle. When the vehicle is not affected by the event, it means that a driving plan of the vehicle is not changed due to the event. Hereinafter, for the convenience of description, the vehicle which is not affected by the event of the specific vehicle is referred to as an independent vehicle of the event. In contrast, the vehicle which is affected by the event of the specific vehicle is referred to as a dependent vehicle of the event.

Vehicles 810 having a driving direction which is different from the driving direction of the source vehicle may correspond to the independent vehicles. The driving information of the independent vehicle does not need to be changed based on the event. For example, when the driving direction of the vehicle is a first lane direction (for example, from the left to the right), vehicles 621, 622, 623, and 624 having a second lane direction (for example, from the right to the left) as the driving direction are not affected by the event. Further, vehicles 820 (for example, a vehicle 611) which drive ahead of the source vehicle (for example, the vehicle 612) may correspond to the independent vehicles. The independent vehicle may not be affected by the information about the event. Since it is not common (hardly occurs) for a vehicle to suddenly go backward on the motorway, the vehicle 611 ahead of the vehicle 612 in the driving direction may be not affected by the event due to the accident, defects, and malfunction of the vehicle 612.

The effect by the event may be identified depending on whether driving plan information for the autonomous driving service is changed. When the expected driving route of the specific vehicle (for example, a vehicle 613) is changed before and after the event occurrence, it is interpreted that the specific vehicle is affected by the occurrence of the event. The specific vehicle may be a dependent vehicle of the event. According to the exemplary embodiments of the present disclosure, when the event occurs in a vehicle, a method for providing a vehicle which is not relevant to the event, that is, the independent vehicle does not receive the event message, and even though the vehicle receives the event message, reducing the update of an unnecessary driving route is proposed.

In order to determine the relevance of the vehicle and the event, an encryption method, RSU ID, and a driving direction may be used.

According to the exemplary embodiment, the encryption method refers to encryption information (for example, a public key or a symmetric key of the used RSU) applied to an event message informing the event. Further, according to the exemplary embodiment, the RSU ID may be used to identify whether a specific RSU is comprised in the RSU list comprised in the driving route of the vehicle. Further, according to the exemplary embodiment, the driving direction may be used to distinguish a dependent vehicle which is affected by the event from an independent vehicle which is not affected by the event.

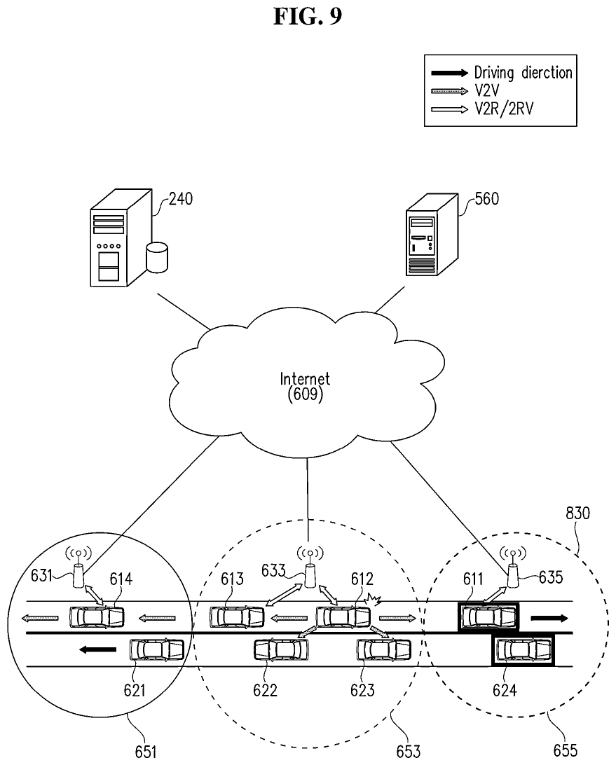

Referring to FIG. 9, the driving route of the vehicle may be related to the RSUs. For example, the driving route of the vehicle may be represented by RSU IDs. The service response message (for example, a service response message of FIG. 5) may comprise an RSU list on a route of the driving plan information. The RSU list may comprise one or more RSU IDs. For example, the RSU list for a driving route for the vehicle 612 may comprise an RSU ID for the RSU 633 and an RSU ID for the RSU 635. The vehicle 612 is located in the coverage of the current RSU 633, but is expected to be located in the coverage of the RSU 635 on the driving direction. On the basis of the driving direction of the vehicle in which event occurred (that is, a source vehicle), vehicles in the coverage 830 of the RSU ahead of the vehicle may not be affected by the event. In other words, all the vehicles in the coverage 830 of the RSU may be independent vehicles of the event.

According to the exemplary embodiment, the RSU may broadcast the event message received from the neighbor RSU to the vehicles in the RSU. However, the RSU (for example, the RSU 635) located in an area ahead of the vehicle does not need to receive the event message and also does not need to transmit the event message to the other vehicle in the coverage 830. As one implementation example, the RSU controller 240 or the serving RSU (for example, the RSU 633) may not forward the event message to the RSU located ahead of the vehicle along the driving route of the source vehicle. Further, as one implementation example, when the RSU receives an event message from the serving RSU, another RSU, or the RSU controller 240, the RSU may not reforward the event message based on the location with respect to the serving RSU and the driving route (for example, the RSU list) of the vehicle.

According to the exemplary embodiment, the service provider may reset the driving route information based on the event of the vehicle. However, it is not necessary to update the driving route information of the vehicles (for example, the vehicles 611 and 624) of the RSU (for example, the RSU 635) located ahead of the vehicle. The service provider may not transmit the update message to the RSU. Accordingly, the update message as in the operation S723 of FIG. 7 may not be transmitted to at least some RSU. Since the RSU did not receive the update message, the vehicle (for example, the vehicle 611) in the coverage (for example, the coverage 820) of the RSU may perform the autonomous driving based on the previously provided autonomous driving information.

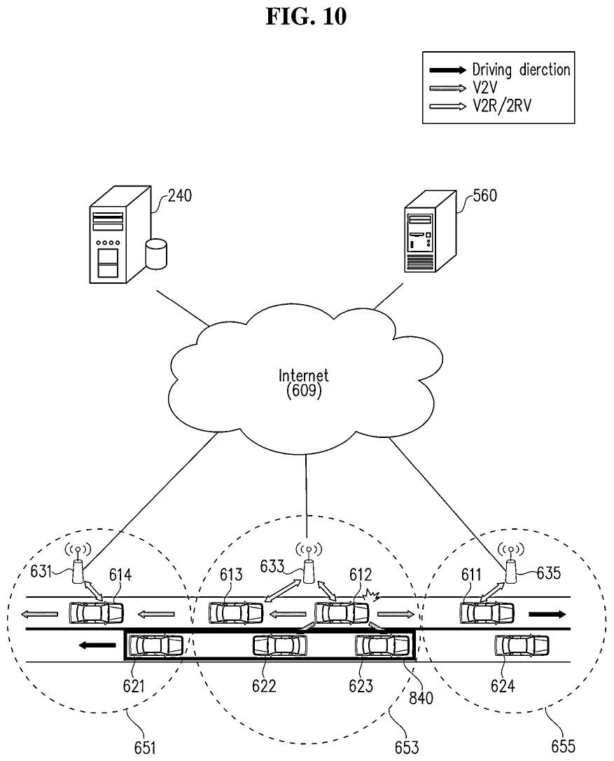

Referring to FIG. 10, the driving direction of the vehicle may be divided into the same direction as the driving direction of the event vehicle and a different direction from the driving direction of the event vehicle. A vehicle which generates the event message may comprise information about the driving direction in the event message. Since the event message is transmitted to the other vehicle or the RSU in a multi-hop manner, the vehicle which receives the message may know the driving direction of the vehicle (that is, the source vehicle) in which the event occurred.

The vehicles 611, 612, 613, and 614 may be traveling on a first lane. A driving direction of the first lane may be from the left to the right. The vehicles 621, 622, 623, and 624 may be traveling on a second lane. A driving direction of the second lane may be from the right to the left. A vehicle which receives the event message may determine whether the vehicle's own self is an independent vehicle or a dependent vehicle based on the driving direction of the source vehicle. When the vehicle which receives the event message has the same driving direction as the driving direction of the source vehicle, the vehicle may identify to be an independent vehicle. When the vehicle which receives the event message has the different driving direction from the driving direction of the source vehicle, the vehicle may be identified as a dependent vehicle.

The event message may comprise the driving direction information of the source vehicle (for example, the vehicle 612). For example, the driving direction information of the vehicle 612 may indicate “1”. The vehicle 622 may receive the event message. The vehicle 622 may receive the event message from the RSU 633 or the vehicle 612. Since the driving direction information of the vehicle 622 is “0” and the driving direction information of the vehicle 612 is “1”, the vehicle 622 may ignore the event message. The vehicle 622 may discard the event message. Like this way, the vehicles 621, 622, and 623 can ignore the received event message as independent vehicles 840. In the meantime, since the RSU 635 is located ahead of the driving route of the vehicle 612, the vehicle 624 in the RSU 635 may not receive the event message for determining the driving direction.

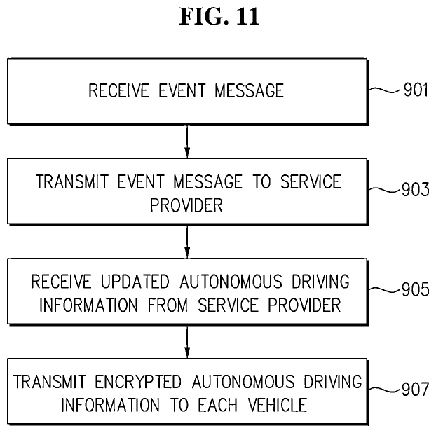

FIG. 11 illustrates an operation flow of an RSU for processing an event message according to an exemplary embodiment.

Referring to FIG. 11, in an operation 901, the RSU may receive an event message. The RSU may receive an event message from the vehicle. The event message may comprise information about an event occurring in the vehicle or the other vehicle. Further, as an another example, the RSU may receive the event message from the neighbor RSU other than a vehicle. The event message may be the event message which has been described with reference to FIG. 6. According to one exemplary embodiment, the event message may comprise at least one of vehicle information, RSU information, location information, event related information, priority information, event type information, driving direction information, lane information, generation time information, transmission method information, vehicle maneuver information, and driver behavior information.

According to an exemplary embodiment, the RSU may decrypt event message. The RSU may identify whether the event message was encrypted based on the encryption information for the RSU. The encryption information for the RSU may refer to key information used to be decrypted within the coverage of the RSU. The encryption information for the RSU may be valid only within the coverage of the RSU. For example, the RSU may comprise key information (for example, “Encryption key/decryption key” of Table 1) in the broadcast message (for example, broadcast message of Table 1). Further, for example, the RSU may comprise the encryption information for the RSU (for example, pre-encryption key of Table 3) in a service response message (for example, a service response message of FIG. 5) when an autonomous driving service is requested. The encryption information may be RSU specific information.

According to one exemplary embodiment, the RSU may perform the integrity check of the event message. The RSU may discard the event message by the integrity check or acquire information in the event message by decoding the event message. For example, when the integrity check is passed, the RSU may identify the priority about the event based on the priority information of the event message. When the RSU has a higher priority than a designated value, the RSU may transmit an event message to an emergency center. Here, the event message may be encrypted based on the encryption information of the RSU.

Even though it is not illustrated in FIG. 11, the RSU may transmit the received event message to the other RSU or the other vehicle. According to one exemplary embodiment, the RSU may transmit the event message to the other RSU based on the driving direction information. For example, the RSU 633 of FIG. 9 may transmit the event message to the RSU 631. However, the RSU 633 may not transmit the event message to the RSU 635. This is because the RSU 635 is deployed in an antecedent region (preceding region) based on a driving direction of the source vehicle in which the event occurs, that is, the vehicle 612. Further, according to one exemplary embodiment, the RSU may generate an event message based on the encryption information for the RSU. The RSU may generate another event message including information transmitted from the vehicle. The RSU encrypts the other event message with encryption information for the RSU so that only the other vehicle in the coverage of the RSU may receive the other event message.

In an operation 903, the RSU may transmit the event information to the service provider. In response to the event of the vehicle, driving plan information of the autonomous driving service which is being provided needs to be changed. The RSU may transmit the event information to the service provider to update the driving plan information of the vehicle.

In an operation 905, the RSU may receive the updated autonomous driving information from the service provider. The service provider may identify vehicles located behind the source vehicle, based on the reception of the event information. Based on the source vehicle (for example, the vehicle 612 of FIGS. 8 to 10), receiving vehicles (for example, vehicles 613 and 614) located behind the source vehicle may be affected by the accident of the source vehicle. That is, the receiving vehicles (for example, the vehicles 613 and 614) located behind the source vehicle may be dependent vehicles of the event of the source vehicle.

The service provider may change autonomous driving information (for example, driving plan information) about the dependent vehicle. The service provider may acquire autonomous driving information to which the event for the source vehicle is reflected. The RSU may receive the autonomous driving information which is generated by the occurrence of the event by means of the update message, from the service provider. The service provider may transmit the autonomous driving information about the dependent vehicle in the coverage of the RSU to the RSU.

In an operation 907, the RSU may transmit the encrypted autonomous driving information to each vehicle. The RSU may transmit the update message including autonomous driving information to each vehicle. At this time, the RSU may not transmit the autonomous driving information to all the vehicles, but transmit updated autonomous driving information to the corresponding vehicle in an unicast manner. This is because each vehicle has a different driving plan. According to one exemplary embodiment, the RSU may transmit the autonomous driving information to each vehicle based on the encryption information about the RSU.

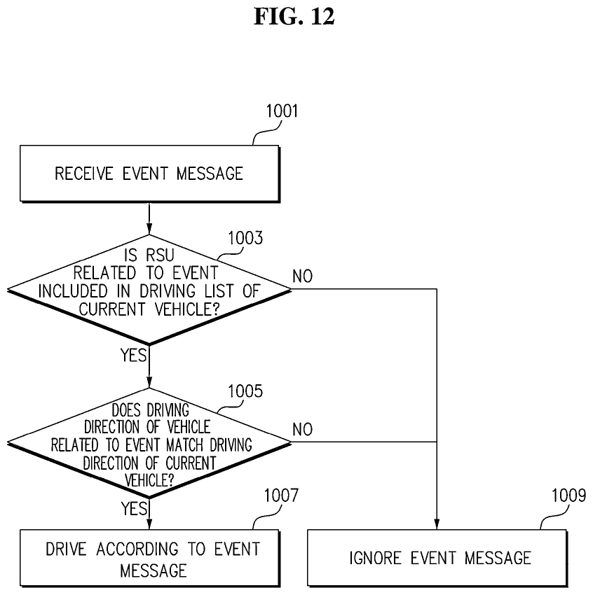

FIG. 12 illustrates an operation flow of a vehicle for processing an event message according to an exemplary embodiment. The vehicle may be referred to as a receiving vehicle. For example, the receiving vehicle illustrates a vehicle which is different from the vehicle 612 in the driving environment of FIGS. 6 to 10.

Referring to FIG. 12, in an operation 1001, the receiving vehicle may receive an event message. The receiving vehicle may receive an event message from a vehicle (hereinafter, a source vehicle) in which the event occurs or the RSU. The event message may comprise information about the event which occurs in the source vehicle. The event message may be the event message which has been described with reference to FIG. 6. According to one exemplary embodiment, the event message may comprise at least one of vehicle information, RSU information, location information, event related information, priority information, event type information, driving direction information, lane information, generation time information, transmission method information, vehicle maneuver information, and driver behavior information.

According to an exemplary embodiment, the receiving vehicle may decrypt event message. The receiving vehicle may identify whether the event message is encrypted based on the encryption information for the RSU. The encryption information for the RSU may refer to key information utilized to enable decryption within the coverage of the RSU. The encryption information may be RSU specific information.

According to one exemplary embodiment, the receiving vehicle may know encryption information for the RSU for a coverage in which the receiving vehicle is located, by means of key information (for example, “encryption key/decryption key” of Table 1) included in the broadcast message (for example, the broadcast message of FIG. 5). Further, the receiving vehicle may know RSUs of a neighboring RSU list and the encryption information of each RSU by means of encryption information (a pre-encryption key of Table 3) included in the service response message (for example, a service response message of FIG. 5). When an event occurs, the vehicle may transmit the event message based on the encryption information for the RSU of the vehicle. In other words, even though the receiving vehicle receives an event message from the other vehicle, if an RSU of the other vehicle is included in the driving route of the receiving vehicle, the receiving vehicle may know the encryption information for the RSU in advance. The receiving vehicle may decrypt the event message by means of a public key algorithm or a symmetric key algorithm. The receiving vehicle may acquire information about a serving RSU which services the source vehicle from the event message. The receiving vehicle may acquire information about a driving direction of the source vehicle from the event message.

In an operation 1003, the receiving vehicle may identify whether an RSU related to an event is included in a driving list of the current vehicle (that is, the receiving vehicle). The receiving vehicle may identify an RSU related to the event from information (for example, a serving RSU ID of Table 4) of the event message. The receiving vehicle may identify one or more RSUs in the driving list of the receiving vehicle. The driving list (for example, a neighbor RSU list of Table 3) may refer to a set of RSU IDs for RSUs located along an expected route for the autonomous driving service. The receiving vehicle may determine whether the RSU associated with the event is relevant to the receiving vehicle, because the event at the RSU is not essentially required for the receiving vehicle, unless the RSU is one that the receiving vehicle plans to visit. When the RSU related to the event is included in the driving list of the receiving vehicle, the receiving vehicle may perform the operation 1005. When the RSU related to the event is not included in the driving list of the receiving vehicle, the receiving vehicle may perform the operation 1009.

In an operation 1005, the receiving vehicle may identify whether a driving direction of the vehicle related to the event matches a driving direction of the current vehicle. The receiving vehicle may identify the driving direction information of the source vehicle from information (for example, a driving direction of Table 4) of the event message. The receiving vehicle may identify the driving direction of the current vehicle. According to one exemplary embodiment, the driving direction may be determined as a relative value. For example, a road may be configured by two lanes. Two lanes may include a first lane which provides a driving direction of a first direction and a second lane which provides a driving direction of a second direction. The driving direction may be relatively determined by the reference of an RSU (for example, RSU 230), an RSU controller (for example, an RSU controller 240) or a service provider (for example, a service provider server 550). For example, one bit for representing a direction may be used. The bit value may be set to “1” for the first direction and set to “0” for the second direction. According to another exemplary embodiment, the driving direction may be determined as an absolute direction by means of a motion of a vehicle sensor.

If a driving direction of a vehicle related to the event, that is, the driving direction of the source vehicle, matches the driving direction of the receiving vehicle, the receiving vehicle may perform operation 1007. If a driving direction of a vehicle related to the event, that is, the driving direction of the source vehicle, does not matches the driving direction of the receiving vehicle, the receiving vehicle may perform operation 1009.

In an operation 1007, the receiving vehicle may perform the driving according to the event message. The receiving vehicle may perform the driving based on the other information (for example, an event occurring location and an event type) in the event message. For example, the receiving vehicle may perform the manipulation for preventing an accident of the receiving vehicle based on the event message. Additionally, the receiving vehicle may determine that it is necessary to transmit the event message. The receiving vehicle may transmit the encrypted event message to the receiving vehicle's the RSU or the other vehicle.

In an operation 1009, the receiving vehicle may ignore the event message. The receiving vehicle may determine that the event indicated by the event message does not directly affect the receiving vehicle. The receiving vehicle may identify that an event of the source vehicle having a driving direction different from the driving direction of the receiving vehicle does not affect the driving of the receiving vehicle. If there is no source vehicle in the driving route of the receiving vehicle, the receiving vehicle does not need to change the driving setting by decoding or processing an event message for the source vehicle.

In FIG. 12, an example of identifying whether the receiving vehicle is an independent vehicle or a dependent vehicle with respect to the event of the source vehicle based on the driving route in the operation 1003 and the driving direction in the operation 1005 has been described. However, the determining order or determining operations in FIG. 12 are just one example for identifying whether the receiving vehicle is an independent vehicle or a dependent vehicle, but the other exemplary embodiments of the present disclosure are not limited to the operations of FIG. 12. According to another exemplary embodiment, the receiving vehicle may not perform the operation 1003, but performs only the operation 1005. According to another exemplary embodiment, the receiving vehicle may perform the operation 1005, before the operation 1003.

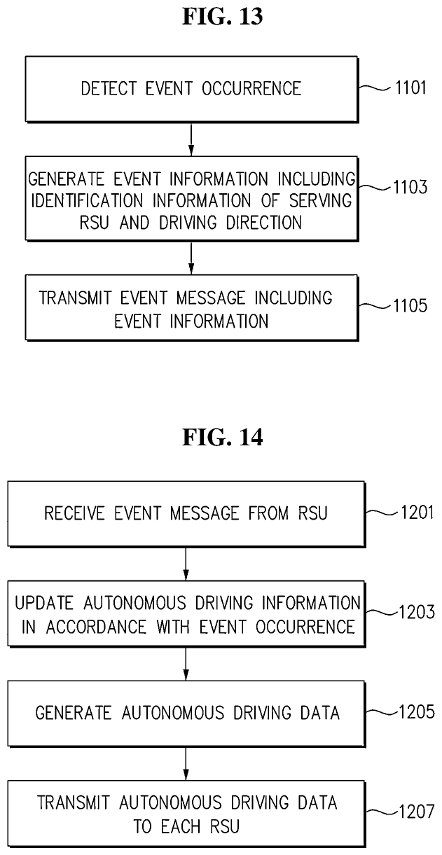

FIG. 13 illustrates an operation flow of an event related vehicle according to an exemplary embodiment. The vehicle may be referred to as a source vehicle. For example, the source vehicle illustrates the vehicle 612 in the driving environment of FIGS. 6 to 10.

In an operation 1101, the source vehicle may detect occurrence of the event. The source vehicle may detect that an event, such as collision with the other vehicle, fire in the source vehicle, and a malfunction of the source vehicle occurs. The source vehicle may autonomously perform the vehicle control based on the detected event. The source vehicle may determine that it is necessary to generate the event message based on the type of the event. The source vehicle may determine to generate an event message if the event does not resolve within a designated time, or if it is required to notify another entity of the occurrence of the event.

In an operation 1103, the source vehicle may generate event information including serving RSU identification information and a driving direction. The source vehicle may generate event information including an ID of an RSU which currently provides a service to the source vehicle, that is, the serving RSU. The source vehicle may include information indicating a driving direction of the source vehicle in the event information.

In an operation 1105, the source vehicle may transmit an event message including event information. The source vehicle may perform the encryption to transmit the event message. The source vehicle may encrypt an event message based on encryption information for the serving RSU (for example, an RSU 633). According to one exemplary embodiment, the source vehicle may know encryption information for the RSU for a coverage in which the source vehicle is located, by means of key information (for example, “encryption key/decryption key” of Table 1) included in the broadcast message (for example, the broadcast message of FIG. 5). Further, the source vehicle may transmit the encrypted event message to vehicles (for example, RSUs 613, 622, and 623) other than the source vehicle in the RSU.

FIG. 14 illustrates an operation flow of a service provider for resetting a driving route in response to an event according to an exemplary embodiment. The operation of the service provider may be performed by a service provider server (for example, the service provider server 550).

Referring to FIG. 14, in an operation 1201, the service provider server may receive an event message from the RSU. The service provider server may identify the source vehicle based on the event message. The service provider server may identify an RSU ID of an RSU of the source vehicle, that is, a serving RSU, based on the event message.

In an operation 1203, the service provider server may update autonomous driving information according to occurrence of the event. The service provider server may identify a vehicle (hereinafter, a dependent vehicle) whose driving route includes the serving RSU of the source vehicle where the event occurred. The service provider server may update autonomous driving information of the dependent vehicle. For example, the service provider server may update autonomous driving information for each dependent vehicle. The service provider server may not update autonomous driving information for the independent vehicle. In other words, the service provider server may update autonomous driving information for each dependent vehicle.

In an operation 1205, the service provider may generate autonomous driving data. The autonomous driving data may include autonomous driving information for each dependent vehicle. The service provider may update autonomous driving data based on autonomous driving information for each dependent vehicle.

In an operation 1207, the service provider may transmit autonomous driving data to each RSU. According to one exemplary embodiment, the service provider may transmit autonomous driving data to an RSU which services a vehicle required to be updated. For example, the service provider does not need to transmit the updated autonomous driving data to an RSU located ahead of the source vehicle in which an accident occurs. In the meantime, the service provider needs to transmit updated autonomous driving data to an RSU that is located in front of the source vehicle and serves a vehicle that will pass through the serving RSU.

Even though it is not illustrated in FIG. 14, the service provider may perform a service subscribing procedure of the vehicle before processing the event message. When the service request message is received from the vehicle, the service provider may check whether the vehicle is a service subscriber. When the vehicle is a service subscriber, the service provider may acquire identifier information (for example, a vehicle ID and a user ID), location information of the vehicle, and destination information, from the service request message. The service provider may calculate driving plan information for the vehicle. The driving plan information may indicate a driving route from a start position of the vehicle to a destination. The service provider may transmit a service response message including driving plan information and a list of RSU IDs present on the route to the serving RSU. The service provider may consistently provide the autonomous driving service through the update message until a service ending notification is received from the vehicle or the vehicle arrives at the destination. Next, when the service provider receives the service ending notification from the vehicle or the vehicle arrives at the destination, the service provider may discard information about the vehicle which requests the service and information about a user of the vehicle.

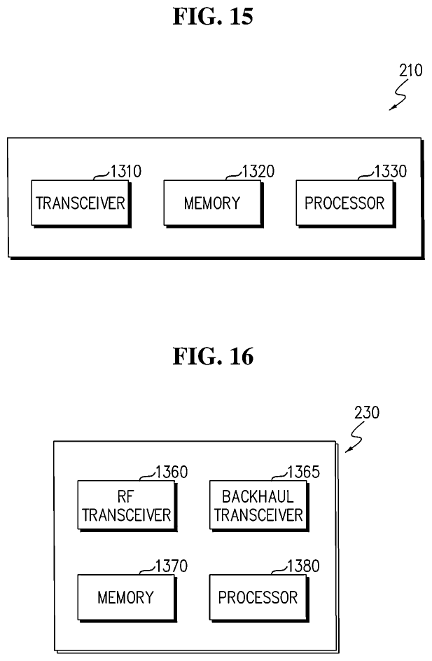

FIG. 15 illustrates an example of a component of a vehicle 210 according to an exemplary embodiment. Here, the terms “-unit” or “-or (er)” described in the specification means a unit for processing at least one function and operation and can be implemented by hardware components or software components or combinations thereof.

Referring to FIG. 15, the vehicle 210 may include at least one transceiver 1310, at least one memory 1320, and at least one processor 1330. Here, even though the component is described as a singular form, but implementation of a plurality of components or sub components are not excluded.

The transceiver 1310 performs functions for transmitting and receiving a signal through a wireless channel. For example, the transceiver 1310 performs a conversion function between base band signals and bit strings according to a physical layer standard of a system. For example, when data is transmitted, the transceiver 1310 generates complex symbols by encoding and modulating transmission bit strings. Further, when the data is received, the transceiver 1310 restores reception bit strings by demodulating and decoding the baseband signal. The transceiver 1310 up-converts the baseband signal into a radio frequency (RF) band signal and then transmits the up-converted signal through the antenna and down-converts the RF band signal received through the antenna into a baseband signal.

To this end, the transceiver 1310 may include a transmission filter, a reception filter, an amplifier, a mixer, an oscillator, a digital to analog converter (DAC), and an analog to digital converter (ADC). Further, the transceiver 1310 may include a plurality of transmission/reception paths. Moreover, the transceiver 1310 may include at least one antenna array configured by a plurality of antenna elements. In terms of hardware, the transceiver 1310 may be configured by a digital unit and an analog unit and the analog unit is configured by a plurality of sub units according to an operating power and an operating frequency.

The transceiver 1310 transmits and receives the signal as described above. Accordingly, the transceiver 1310 may be referred to as a “transmitting unit”, a “receiving unit”, or a “transceiving unit”. Further, in the following description, the transmission and reception performed through a wireless channel, a back haul network, an optical fiber, Ethernet, and other wired path are used as a meaning including that the process as described above is performed by the transceiver 1310. According to an exemplary embodiment, the transceiver 1310 may provide an interface for performing communication with the other node. That is, the transceiver 1310 may convert a bit string transmitted from the vehicle 210 to the other node, for example, another vehicle, another RSU, an external server (for example, a service provider server 550 and an authentication agency server 560) into a physical signal and may convert a physical signal received from the other node into a bit string.

The memory 1320 may store data such as a basic program, an application program, and setting information for an operation of the vehicle 210. The memory 1320 may store various data used by at least one component (for example, the transceiver 1310 and a processor 1320). For example, the data may include software and input data or output data about an instruction related thereto. The memory 1320 may be configured by a volatile memory, a nonvolatile memory, or a combination of a volatile memory and a nonvolatile memory.

The processor 1330 controls overall operations of the vehicle 210. For example, the processor 1330 records and reads data in the memory 1320. For example, the processor 1330 transmits and receives a signal through the transceiver 1310. The memory 1320 provides the stored data according to the request of the processor 1330. Even though in FIG. 15, one processor is illustrated, the exemplary embodiments of the present disclosure are not limited thereto. In order to perform the exemplary embodiments of the present disclosure, the vehicle 210 may include a plurality of processors. The processor 1330 may be referred to as a control unit or a control means. According to the exemplary embodiments, the processor 1330 may control the vehicle 210 to perform at least one of operations or methods according to the exemplary embodiments of the present disclosure.

FIG. 16 illustrates an example of a component of a RSU 230 according to an exemplary embodiment. Here, the terms “-unit” or “-or (er)” described in the specification means a unit for processing at least one function and operation and can be implemented by hardware components or software components or combinations thereof.

Referring to FIG. 16, the RSU 230 includes an RF transceiver 1360, a back haul transceiver 1365, a memory 1370, and a processor 1380.

The RF transceiver 1360 performs functions for transmitting and receiving a signal through a wireless channel. For example, the RF transceiver 1360 up-converts the baseband signal into a radio frequency (RF) band signal and then transmits the up-converted signal through the antenna and down-converts the RF band signal received through the antenna into a baseband signal. For example, the RF transceiver 1360 includes a transmission filter, a reception filter, an amplifier, a mixer, an oscillator, a DAC, and an ADC.

The RF transceiver 1360 may include a plurality of transmission/reception paths. Moreover, the RF transceiver 1360 may include an antenna unit. The RF transceiver 1360 may include at least one antenna array configured by a plurality of antenna elements. In terms of hardware, the RF transceiver 1360 is configured by a digital circuit and an analog circuit (for example, a radio frequency integrated circuit (RFIC)). Here, the digital circuit and the analog circuit may be implemented as one package. Further, the RF transceiver 1360 may include a plurality of RF chains. The RF transceiver 1360 may perform the beam forming. The RF transceiver 1360 may apply a beam forming weight to the signal to assign a directivity according to the setting of the processor 1380 to a signal to be transmitted/received. According to one exemplary embodiment, the RF transceiver 1360 comprises a radio frequency (RF) block (or an RF unit).

According to one exemplary embodiment, the RF transceiver 1360 may transmit and receives a signal on a radio access network. For example, the RF transceiver 1360 may transmit a downlink signal. The downlink signal may comprise a synchronization signal (SS), a reference signal (RS), (for example, a cell-specific reference signal (CRS), a demodulation (DM)-RS), system information (for example, MIB, SIB, remaining system information (RMSI), other system information (OSI), a configuration message, control information, or downlink data. For example, the RF transceiver 1360 may receive an uplink signal. The uplink signal may comprise a random access related signal (for example, a random access preamble (RAP)) (or Msg1 (message 1), Msg3 (message 3), a reference signal (for example, a sounding reference signal (SRS), DM-RS), or a power headroom report (PHR). Even though in FIG. 16, only the RF transceiver 1360 is illustrated, according to another implementation example, the RSU 230 may comprise two or more RF transceivers.

The backhaul transceiver 1365 may transmit/receive a signal. According to one exemplary embodiment, the backhaul transceiver 1365 may transmit/receive a signal on the core network. For example, the backhaul transceiver 1365 may access the Internet through the core network to perform communication with an external server (a service provider server 550 and an authentication agency server 560) or the external device (for example, the RSU controller 240). For example, the backhaul transceiver 1365 may perform communication with the other RSU. Even though in FIG. 16, only the backhaul transceiver 1365 is illustrated, according to another implementation example, the RSU 230 may comprise two or more backhaul transceivers.

The RF transceiver 1360 and the backhaul transceiver 1365 transmit and receive signals as described above. Accordingly, all or a part of the RF transceiver 1360 and the backhaul transceiver 1365 may be referred to as a “communication unit”, a “transmitter”, a “receiver”, or a “transceiver”. Further, in the following description, the transmission and reception performed by the wireless channel are used to include that the processing as described above is performed by the RF transceiver 1360. In the following description, the transmission and reception performed by the wireless channel are used to include that the processing as described above is performed by the RF transceiver 1360.

The memory 1370 stores data such as a basic program, an application program, and setting information for an operation of the RSU 230. The memory 1370 may be referred to as a storage unit. The memory 1370 may be configured by a volatile memory, a nonvolatile memory, or a combination of a volatile memory and a nonvolatile memory. Further, the memory 1370 provides the stored data according to the request of the processor 1380.

The processor 1380 controls overall operations of the RSU 230. The processor 1380 may be referred to as a control unit. For example, the processor 1380 transmits and receives a signal through the RF transceiver 1360 or the backhaul transceiver 1365. Further, the processor 1380 records and reads data in the memory 1370. The processor 1380 may perform functions of a protocol stack required by a communication standard. Even though in FIG. 16, only the processor 1380 is illustrated, according to another implementation example, the RSU 230 may comprise two or more processors. The processor 1380 may be an instruction/code at least temporally resided in the processor or a storage space in which an instruction/code is stored, as an instruction set or code stored in the memory 1370, or may be a part of a circuitry which configures the processor 1380. Further, the processor 1380 may comprise various modules for performing the communication. The processor 1380 may control the RSU 230 to perform the operations according to the exemplary embodiments to be described below.

The configuration of the RSU 230 illustrated in FIG. 16 is just an example, but an example of the RSU which performs the exemplary embodiments of the present disclosure is not limited from the configuration illustrated in FIG. 16. In some exemplary embodiments, some configuration may be added, deleted, or changed.

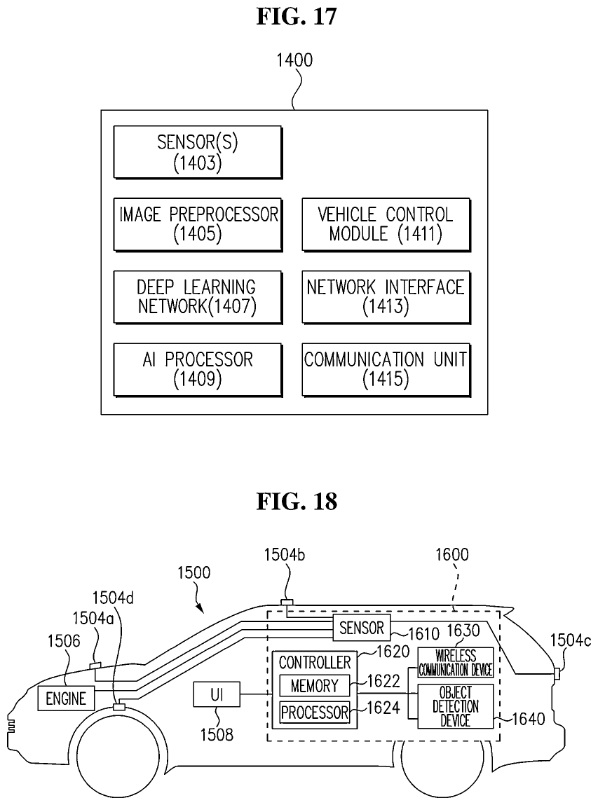

FIG. 17 illustrates a block diagram illustrating an autonomous driving system of a vehicle. The vehicle of FIG. 17 is referenced to the vehicle 210 of FIG. 5. Electronic devices 120 and 130 of FIG. 1 may comprise an autonomous vehicle 1400.

The autonomous driving system 1400 of a vehicle according to FIG. 17 may be a deep learning network including sensors 1403, an image preprocessor 1405, a deep learning network 1407, an artificial intelligence (AI) processor 1409, a vehicle control module 1411, a network interface 1413, and a communication unit 1415. In various exemplary embodiments, each element may be connected through various interfaces. For example, sensor data which is sensed by the sensors 1403 to be output may be fed to the image preprocessor 1405. The sensor data processed by the image preprocessor 1405 may be fed to the deep learning network 1407 which is ran by the AI processor 1409. An output of the deep learning network 1407 ran by the AI processor 1409 may be fed to the vehicle control module 1411. Intermediate results of the deep learning network 1407 ran by the AI processor 1407 are fed to the AI processor 1409. In various exemplary embodiments, the network interface 1413 performs communication with the electronic device in the vehicle to transmit autonomous driving route information and/or autonomous driving control instructions for autonomous driving of the vehicle to the internal block configurations. In one exemplary embodiment, the network interface 1431 may be used to transmit sensor data acquired by the sensor(s) 1403 to the external server. In some exemplary embodiment, the autonomous driving control system 1400 includes additional or less configurations appropriately. For example, in some exemplary embodiment, the image preprocessor 1405 may be an optional component. As another example, the post-processing component (not illustrated) may be included in the autonomous driving control system 1400 to perform the post processing at the output of the deep learning network 1407 before providing the output to the vehicle control module 1411.

In some exemplary embodiment, the sensors 1403 may include one or more sensors. In various exemplary embodiments, the sensors 1403 may be attached to different positions of the vehicle. The sensors 1403 may be directed to one or more different directions. For example, the sensors 1403 may be attached to the front, sides, rear, and/or roof of the vehicle to be directed to the forward facing, rear facing, and side facing directions. In some exemplary embodiment, the sensors 1403 may be image sensors such as high dynamic range cameras. In some exemplary embodiment, sensors 1403 include non-visual sensors. In some exemplary embodiment, sensors 1403 include a RADAR, a light detection and ranging (LiDAR) and/or ultrasonic sensors in addition to the image sensor. In some exemplary embodiment, the sensors 1403 are not mounted in a vehicle including a vehicle control module 1411. For example, the sensors 1403 are included as a part of a deep learning system for capturing sensor data and may be attached to an environment or a road and/or mounted in neighbor vehicles.

In some exemplary embodiment, an image pre-processor 1405 may be used to pre-process sensor data of the sensors 1403. For example, the image pre-processor 1405 may be used to split sensor data by one or more configurations and/or post-process one or more configurations to pre-process the sensor data. In some exemplary embodiment, the image preprocessor 1405 may be a graphics processing unit (GPU), a central processing unit (CPU), an image signal processor, or a specialized image processor. In various exemplary embodiments, the image pre-processor 1405 may be a tone-mapper processor for processing high dynamic range data. In some exemplary embodiment, the image preprocessor 1405 may be a configuration of the AI processor 1409.

In some exemplary embodiment, the deep learning network 1007 may be a deep learning network for implementing control instructions to control the autonomous vehicle. For example, the deep learning network 1407 may be an artificial neural network, such as a convolution neural network CNN trained using sensor data and an output of the deep learning network 1407 is provided to the vehicle control module 1411.

In some exemplary embodiment, the artificial intelligence (AI) processor 1409 may be a hardware processor to run the deep learning network 1407. In some exemplary embodiment, the AI processor 1409 is a specialized AI processor to perform the inference on the sensor data through the convolution neural network (CNN). In some exemplary embodiment, the AI processor 1409 may be optimized for a bit depth of the sensor data. In some exemplary embodiment, the AI processor 1409 may be optimized for the deep learning operations such as operations of the neural network including convolution, inner product, vector and/or matrix operations. In some exemplary embodiment, the AI processor 1409 may be implemented by a plurality of graphics processing units GPU to effectively perform the parallel processing.

In various exemplary embodiments, the AI processor 1409 performs deep learning analysis on sensor data received from the sensor(s) 1403 while the AI processor 1409 is executed and may be coupled to a memory configured to provide the AI processor having instructions which cause a machine learning result used to autonomously at least partially operate the vehicle through the input/output interface. In some exemplary embodiment, the vehicle control module 1411 is used to process instructions to control a vehicle output from the artificial intelligence (AI) processor 1409 and translate an output of the AI processor 1409 into instructions for controlling a module of each vehicle to control various modules of the vehicle. In some exemplary embodiment, the vehicle control module 1411 is used to control a vehicle for autonomous driving. In some exemplary embodiment, the vehicle control module 1411 may adjust steering and/or a speed of the vehicle. For example, the vehicle control module 1411 may be used to control the driving of the vehicle such as braking, acceleration, steering, lane change, and lane keeping. In some exemplary embodiment, the vehicle control module 1411 may generate control signals to control vehicle lighting, such as brake lights, turn signals, and headlights. In some exemplary embodiment, the vehicle control module 1411 may be used to control vehicle audio related systems, such as a vehicle's sound system, vehicle's audio warnings, a vehicle's microphone system, a vehicle's horn system.

In some exemplary embodiment, the vehicle control module 1411 may be used to control notification systems including warning systems to notify passengers and/or drivers of driving events, such as access to an intended destination or potential collision. In some exemplary embodiment, the vehicle control module 1411 may be used to adjust sensors such as sensors 1403 of the vehicle. For example, the vehicle control module 1411 may modify an orientation of sensors 1403, change an output resolution and/or a format type of the sensors 1403, increase or reduce a capture rate, adjust a dynamic range, and adjust a focus of the camera. Further, the vehicle control module 1411 may individually or collectively turn on/off operations of the sensors.

In some exemplary embodiment, the vehicle control module 1411 may be used to change parameters of the image pre-processor 1405 by modifying a frequency range of filters, adjusting edge detection parameters for detecting features and/or objects, or adjusting a bit depth and channels. In various exemplary embodiments, the vehicle control module 1411 may be used to control an autonomous driving function of the vehicle and/or a driver assistance function of the vehicle.

In some exemplary embodiment, the network interface 1413 may be in charge of an internal interface between block configurations of the autonomous driving control system 1400 and the communication unit 1415. Specifically, the network interface 1413 may be a communication interface to receive and/or send data including voice data. In various exemplary embodiments, the network interface 1413 may be connected to external servers to connect voice calls through the communication unit 1415, receive and/or send text messages, transmit sensor data, update software of the vehicle to an autonomous driving system, or update software of the autonomous driving system of the vehicle.

In various exemplary embodiments, the communication unit 1415 may comprise various wireless interfaces such as cellular or WiFi. For example, the network interface 1413 may be used to receive update for operating parameters and/or instructions for the sensors 1403, the image pre-processor 1405, the deep learning network 1407, the AI processor 1409, and the vehicle control module 1411 from the external server connected through the communication unit 1415. For example, the machine learning model of the deep learning network 1407 may be updated using the communication unit 1415. According to another example, the communication unit 1415 may be used to update the operating parameters of the image preprocessor 1405, such as image processing parameters, and/or the firmware of the sensors 1403.

In another exemplary embodiment, the communication unit 1415 may be used to activate emergency services and the communication for emergency contact in an accident or a near-accident event. For example, in a collision event, the communication unit 1415 may be used to call emergency services for help and used to notify emergency services regarding to collision details and emergency services of the location of the vehicle to the outside. In various exemplary embodiments, the communication unit 1415 may update or acquire an expected arrival time and/or a destination location.

According to an exemplary embodiment, the autonomous driving system 1400 illustrated in FIG. 17 may be configured by an electronic device of the vehicle. According to an exemplary embodiment, when an autonomous driving release event occurs from the user during the autonomous driving of the vehicle, the AI processor 1409 of the autonomous driving system 1400 may control to input autonomous driving release event related information as training set data of the deep learning network to train autonomous driving software of the vehicle.

The vehicle control module 1411 according to the exemplary embodiment may generate various vehicle manipulation information to prevent secondary accident, such as collision avoidance, collision mitigation, lane changing, accelerating, braking, steering wheel control, according to a message element comprised in the received event message.

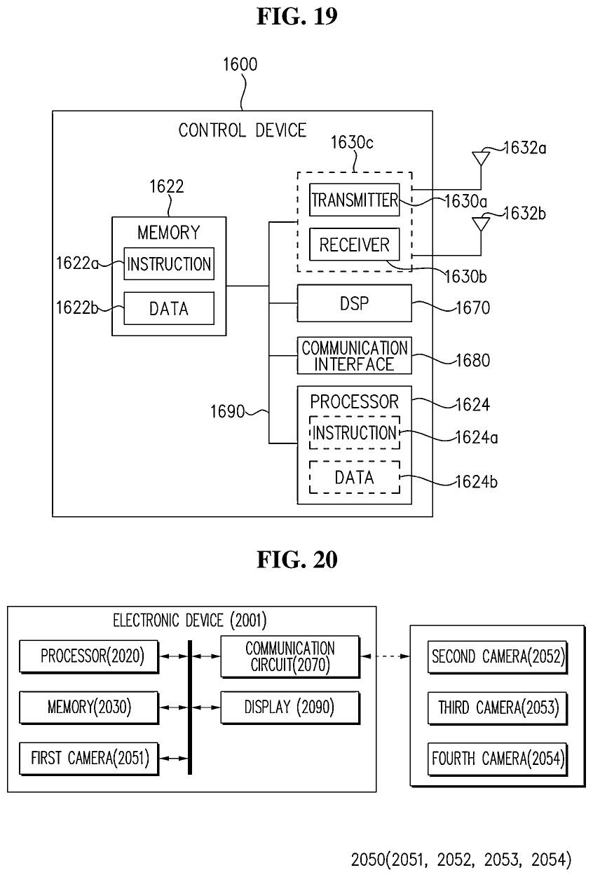

FIGS. 18 and 19 are block diagrams illustrating an autonomous mobility according to an exemplary embodiment. Referring to FIG. 18, an autonomous mobility 1500 according to the present exemplary embodiment may comprise a control device 1600, sensing modules 1504a, 1504b, 1504c, 1504d, an engine 1506, and a user interface 1508. For example, the autonomous mobility 1500 may be an example of vehicles 211, 212, 213, 215, and 217 of FIG. 2. For example, the autonomous mobility 1500 may be controlled by the electronic devices 120 and 130.

The autonomous mobility 1500 may comprise an autonomous driving mode or a manual mode. For example, the manual mode is switched to the autonomous driving mode or the autonomous driving mode is switched to the manual mode in accordance with the user input received through the user interface 1508.

When the autonomous mobility 1500 operates in the autonomous driving mode, the autonomous mobility 1500 may operate under the control of the control device 1600.

In the present exemplary embodiment, the control device 1600 may comprise a controller 1620 including a memory 1622 and a processor 1624, a sensor 1610, a communication device 1630, and an object detection device 1640.

Here, the object detection device 1640 may perform all or some of a distance measurement device (for example, electronic devices 120 and 130).

That is, in the present exemplary embodiment, the object detection device 1640 is a device for detecting an object located outside the moving object 1500 and the object detection device 1640 may detect an object located outside the moving object 1500 and may generate object information according to the detection result.

The object information may comprise information about the presence of the object, object location information, distance information between the mobility and the object, and relative speed information with the mobility and the object.

The object may be a concept comprising various objects located at the outside of the moving object 1500, such as lanes, the other vehicle, pedestrians, traffic signals, lights, roads, structures, speed bumps, terrain objects, and animals. Here, the traffic signal may be a concept including a traffic light, a traffic sign, and a pattern or text drawn on the road surface. The light may be light generated from a lamp equipped in other vehicle, light generated from a streetlamp, or sunlight.

The structure may be an object which is located in the vicinity of the road and is fixed to the ground. For example, the structure may comprise street lights, street trees, buildings, power poles, traffic lights, and bridges. The terrain object may comprise mountains and hills.

Such an object detection device 1640 may comprise a camera module. The controller 1620 may extract object information from an external image captured by the camera module and allow the controller 1620 to process the information thereabout.

Further, the object detection device 1640 may further comprise imaging devices to recognize the external environment. In addition to the LIDAR, a RADAR, a GPS device, an odometry, and other computer vision device, an ultrasonic sensor, and an IR sensor may be used and if necessary, the devices selectively or simultaneously operate for more accurate sensing.

In the meantime, the distance measurement device according to the exemplary embodiment of the present disclosure may calculate a distance between the autonomous moving object 1500 and the object and interwork with the control device 1600 of the autonomous mobility 1500 to control the operation of the moving object based on the calculated distance.

For example, when there is a possibility of collision depending on the distance between the autonomous mobility 1500 and the object, the autonomous mobility 1500 may decelerate or control the brake to stop. As another example, when the object is a moving object, the autonomous mobility 1500 may control a driving speed of the autonomous mobility 1500 to maintain a predetermined distance or more from the object.

The distance measuring device according to the exemplary embodiment of the present disclosure may be configured by one module in the control device 1600 of the autonomous moving object 1500. That is, the memory 1622 and the processor 1624 of the control device may implement the collision preventing method according to the present disclosure in a software manner.

Further, the sensor 1610 may be connected to the sensing modules 1504a, 1504b, 1504c, and 1504d of the moving object's internal/external environment to acquire various sensing information regarding to the moving object's internal/external environment. Here, the sensor 1610 may comprise a posture sensor (for example, a yaw sensor, a roll sensor, and a pitch sensor), a collision sensor, a wheel sensor, a speed sensor, an inclination sensor, a weight sensor, a heading sensor, a gyro sensor, a position module, a moving object forward/backward sensor, a battery sensor, a fuel sensor, a tire sensor, a steering sensor by steering wheel rotation, an internal temperature sensor of a moving object, an internal humidity sensor of the moving object, an ultrasonic sensor, an illumination sensor, an accelerator pedal position sensor, and a brake pedal position sensor, and the like.

Accordingly, the sensor 1610 may acquire sensing signals about mobility posture information, mobility collision information, mobility direction information, mobility location information (GPS information), mobility angle information, mobility speed information, mobility acceleration information, mobility inclination information, mobility forward/backward information, mobility battery information, fuel information, tire information, mobility lamp information, internal temperature information of mobility, internal humidity information of mobility, a steering wheel rotation angle, an external illumination of mobility, a pressure applied to an acceleration pedal, or a pressure applied to a brake pedal.

Further, the sensor 1610 may further comprise an acceleration pedal sensor, a pressure sensor, an engine speed sensor, an air flow sensor, an air temperature sensor (ATS), a water temperature sensor (WTS), a throttle position sensor (TPS), a TDC sensor, and a crank angle sensor (CAS).

As described above, the sensor 1610 may generate moving object state information based on the sensing data.

The wireless communication device 1630 is configured to implement wireless communication with the autonomous moving object 1500. For example, the wireless communication device 1630 may be allowed to communicate with a mobile phone of the user or other wireless communication device 1630, other moving object, a central device (a traffic control device), or a server. The wireless communication device 1630 may transmit/receive a wireless signal according to an access wireless protocol. The wireless communication protocol may be Wi-Fi, Bluetooth, long-term evolution (LTE), code division multiple access (CDMA), wideband code division multiple access (WCDMA), global Systems for mobile communications (GSM) and not be limited thereto.

Further, in the present exemplary embodiment, the autonomous moving object 1500 may implement a communication between moving objects by means of the wireless communication device 1630. That is, the wireless communication device 1630 may communicate with the other object on the road and the other objects by the vehicle to vehicle (V2V) communication. The autonomous moving object 1500 transmits and receives information such as a driving warning or traffic information by means of the vehicle to vehicle communication and may request information from the other moving object or receive a request. For example, the wireless communication device 1630 may perform the V2V communication via a dedicated short-range communication (DSRC) device or a cellular-V2V (C-V2V) device. Further, in addition to the vehicle to vehicle communication, a vehicle to everything (V2X) communication (for example, with an electronic device carried by a pedestrian) is also implemented by the wireless communication device 1630.

In the present exemplary embodiment, the controller 1620 is a unit which controls overall operations of each unit in the moving object 1500 and may be configured by a manufacturer of the moving object during the manufacturing process or additionally configured for performing the function of the autonomous driving after the manufacturing. Alternatively, a configuration for continuously performing an additional function through an upgrade of the controller 1620 configured at the time of manufacture may be comprised. The controller 1620 may be referred to as an electronic control unit (ECU).

The controller 1620 may collect various data from the connected sensor 1610, object detection device 1640, and communication device 1630 and transmit a control signal to the sensor 1610, the engine 1506, the user interface 1508, the communication device 1630, and the object detection device 1640 which are included as other configurations in the moving object, based on the collected data. Further, even though it is not illustrated in the drawing, the control signal is also transmitted to the acceleration device, the braking system, the steering device, or the navigation device which is related to the driving of the moving object.

In the present exemplary embodiment, the controller 1620 may control the engine 1506 and for example, senses a speed limit of a road on which the autonomous moving object 1500 is driving to control the engine 1506 such that the driving speed does not exceed the speed limit or to accelerate the driving speed of the autonomous moving object 1500 within a range which does not exceed the speed limit.

Further, when the autonomous moving object 1500 approaches the lane or moves out of the lane during the driving of the autonomous moving object 1500, the controller 1620 may determine whether the approaching and moving out of the lane is caused according to the normal driving situation or the other driving situation, and control the engine 1506 to control the driving of the moving object according to the determination result. Specifically, the autonomous moving object 1500 may detect a lane formed on both sides of a lane on which the moving object is driving. In this case, the controller 1620 determines whether the autonomous moving object 1500 does not approach the lane or moves out of the lane, and if it is determined that the autonomous moving object 1500 approaches the lane or moves out of the lane, it may be determined that whether this driving is performed according to the accurate driving situation or other driving situation or not. Here, as an example of the normal driving situation may be a situation that requires the moving object to change lanes. Further, as an example of a other driving situation may be a situation that the moving object does not need to change lanes. If it is determined that the autonomous moving object 1500 approaches the lane or moves out of the lane in a situation where it is not necessary for the moving object to change the lane, the controller 1620 may control the driving of the autonomous moving object 1500 to normally drive without moving out of the lane.

When there is another moving object or an obstacle in front of the moving object, controller 1620 may control an engine 1606 or a braking system to reduce the speed of the driving moving object and also control a trajectory, a driving route, and a steering angle in addition to the speed. Alternatively, the controller 1620 may generate a necessary control signal according to recognition information of other external environment, such as a driving lane and a driving signal of the moving object to control the driving of the moving object.

The controller 1620 may communicate with a neighbor moving object or a central server in addition to the autonomous generation of the control signal and also transmit an instruction to control the peripheral devices through the received information to control the driving of the moving object.

Further, when the position of the camera module 2050 or the field of view angle is changed, it is difficult to accurately recognize the moving object or the lane according to the present exemplary embodiment so that in order to prevent this, a control signal for controlling the calibration of the camera module 2050 may be generated. Accordingly, according to the present exemplary embodiment, the controller 1220 may generate a calibration control signal to the camera module 2050 so that even though a mounting position of the camera module 2050 is changed by vibration or impact which is generated according to the movement of the autonomous moving object 1500, a normal mounting position, a direction, or a field of view angle of the camera module 1650 are consistently maintained. When initial mounting position, direction, and viewing angle information of the camera module 2050 which are stored in advance and initial mounting position, direction, and viewing angle information of the camera module 2050 which are measured during the driving of the autonomous moving object 1500 are changed by a threshold value or more, the controller 1620 generates a control signal to perform calibration of the camera module 2050.

In the present exemplary embodiment, the controller 1620 may comprise a memory 1622 and a processor 1624. The processor 1624 may execute software stored in the memory 1622 according to a control signal of the controller 1620. Specifically, the controller 1620 may store data and instructions for performing a lane detection method according to the present disclosure in the memory 1622 and the instructions may be executed by the processor 1624 to implement one or more methods disclosed herein.

At this time, the memory 1622 may be stored in a nonvolatile recording medium which is executable in the processor 1624. The memory 1622 may store software and data through appropriate internal and external devices. The memory 1622 may be configured by a random access memory (RAM), a read only memory (ROM), a hard disk, and a memory 1622 device connected to a dongle.

The memory 1622 at least may store an operating system (OS), a user application, and executable instructions. The memory 1222 may also store application data and array data structures.

The processor 1624 may be a microprocessor or an appropriate electronic processor and may be a controller, a micro controller, or a state machine.

The processor 1624 may be implemented by a combination of computing devices and the computing device may be a digital signal processor or a microprocessor or may be configured by an appropriate combination thereof.

In the meantime, the autonomous moving object 1500 may further comprise a user interface 1508 for an input of the user to the above-described control device 1600. The user interface 1508 may allow the user to input the information by appropriate interaction. For example, the user interface may be implemented as a touch screen, a keypad, or a manipulation button. The user interface 1508 transmits an input or an instruction to a controller 1620 and the controller 1620 may perform a control operation of a moving object as a response of the input or the instruction.

Further, the user interface 1508 is a device outside the autonomous moving object 1500 and may communicate with the autonomous moving object 1500 by means of a wireless communication device 1630. For example, the user interface 1508 may interwork with a mobile phone, a tablet, or other computer device.

Moreover, in the present exemplary embodiment, even though it has been described that the autonomous moving object 1500 comprises an engine 1506, another type of propulsion system is also comprised. For example, the moving object may be operated with an electric energy and also operated by a hydrogen energy or a hybrid system combining them. Thus, the controller 1620 may comprise a propulsion mechanism according to the propulsion system of the autonomous moving object 1500 and may provide a control signal to configurations of each propulsion mechanism accordingly.

Hereinafter, a detailed configuration of the control device 1600 according to the exemplary embodiment of the present disclosure will be described in more detail with reference to FIG. 19.

The control device 1600 comprises a processor 1624. The processor 1624 may be a general-purpose single or multi-chip microprocessor, a dedicated microprocessor, a microcontroller, or a programmable gate array. The processor is also referred to as a central processing unit (CPU). Further, in the present exemplary embodiment, the processor 1624 may also be used by a combination of a plurality of processors.

The control device 1600 comprises a memory 1622. The memory 1622 may be an arbitrary electronic component which stores electronic information. The memory 1622 also comprises a combination of the memories 1622 in addition to the single memory.

Data and instructions 1622a for performing a distance measurement method of a distance measuring device according to the present disclosure may be stored in the memory 1622. When the processor 1624 executes the instruction 1622a, all or some of the instructions 1622a and data 1622b required to perform the instruction may be loaded (1624a and 1624b) on the processor 1624.

The control device 1600 may comprise a transmitter 1630a, a receiver 1630b, or a transceiver 1630c to permit the transmission and reception of signals. One or more antennas 1632a and 1632b may be electrically connected to the transmitter 1630a, the receiver 1630b, or the transceiver 1630c and further include antennas.

The control device 1600 may include a digital signal processor (DSP) 1670. The moving body may quickly process the digital signal by means of the DSP 1670.

The control device 1600 may include a communication interface 1680. The communication interface 1680 may include one or more ports and/or communication modules to connect the other devices to the control device 1600. The communication interface 1680 may make the user and the control device 1600 interact with each other.

Various configurations of the control device 1600 may be connected by one or more buses 1690 and the buses 1690 may include a power bus, a control signal bus, a state signal bus, and a data bus. Configurations may perform a desired function of transmitting information with each other through the bus 1690 in response to the control of the processor 1624.

According to the exemplary embodiments, the processor 1624 of the control device 1600 may control to communicate with the other vehicles and/or RSUs through the communication interface 1680. When a vehicle in which the control device 1600 is mounted is a source vehicle, the processor 1624 reads event related information stored in the memory 1622, is included in an element of an event message and then may encrypt the event message according to a determined encryption method. The processor 1624 may transmit an encrypted message to the other vehicles and/or RSUs through the communication interface 1680.

Further, according to the exemplary embodiments, when the processor 1624 of the control device 1600 receives an event message through the communication interface 1680, the processor 1624 may decrypt the event message using decryption related information stored in the memory 1622. After decryption, the processor 1624 of the control device 1600 may determine whether the vehicle is a dependent vehicle dependent to the event message. When the vehicle corresponds to a dependent vehicle, the processor 1624 of the control device 1600 may control the vehicle to perform the autonomous driving according to an element included in the event message.

According to the exemplary embodiments, a device of the vehicle may comprise at least one transceiver, a memory configured to store instructions, and at least one processor operatively coupled to at least one transceiver and the memory. The at least one processor may be configured to, when the instructions are executed, receive an event message related to an event of the source vehicle. The event message may comprise identification information about serving road side unit (RSU) of the source vehicle and direction information indicating a driving direction of the source vehicle. The at least one processor may be configured to, when the instructions are executed, identify whether the serving RSU of the source vehicle is comprised in a driving list of the vehicle. The at least one processor may be configured to, when the instructions are executed, identify whether the driving direction of the source vehicle matches a driving direction of the vehicle. When the instructions are executed, if it is identified that the driving direction of the source vehicle matches the driving direction of the vehicle and a serving RSU of the source vehicle is comprised in the driving list of the vehicle (upon identifying), the at least one processor may be configured to perform the driving according to the event message. When the instructions are executed, if it is identified that the driving direction of the source vehicle does not match the driving direction of the vehicle and a serving RSU of the source vehicle is not comprised in the driving list of the vehicle (upon identifying), the at least one processor may be configured to perform the driving without the event message.

According to an exemplary embodiment, the driving list of the vehicle may comprise identification information about one or more RSUs. The driving direction may indicate one of a first lane direction and a second lane direction which is opposite to the first lane direction.

According to one exemplary embodiment, the at least one processor may be configured to, when the instructions are executed, identify encryption information about the serving RSU based on the reception of the event message. The at least one processor may be configured to, when the instructions are executed, acquire the identification information about the serving RSU of the source vehicle and the direction information indicating the driving direction of the source vehicle by decrypting the event message based on the encryption information about the serving RSU.

According to the exemplary embodiment, when the instructions are executed, before receiving the event message, the at least one processor may be configured to transmit a service request message to a service provider server through the RSU. When the instructions are executed, the at least one processor may be configured to receive a service response message corresponding to the service request message from the service provider server through the RSU. The service response message may comprise driving plan information indicating an expected driving route of the vehicle, information for each of one or more RSUs related to the expected driving route, and encryption information about one or more RSUs. The encryption information may comprise encryption information about the serving RSU.

According to one exemplary embodiment, when the instructions are executed, before receiving the event message, the at least one processor may be configured to receive broadcast information from the serving RSU. The broadcast message may comprise identification information about the RSU, information indicating at least one RSU adjacent to the RSU, and encryption information about the RSU.

According to the exemplary embodiment, when the instructions are executed, the at least one processor may be configured to change a driving related setting of the vehicle based on the event message to perform the driving according to the event message. The driving related setting may comprise at least one of a driving route of the vehicle, a driving lane of the vehicle, a driving speed of the vehicle, a lane of the vehicle, or the braking of the vehicle.

According to the exemplary embodiment, when the instructions are executed, the at least one processor may be configured to generate a transmission event message based on the event message to perform the driving according to the event message. When the instructions are executed, the at least one processor may be configured to encrypt the transmission event message based on encryption information about the RSU which services the vehicle to perform the driving according to the event message. When the instructions are executed, the at least one processor may be configured to transmit the encrypted transmission event message to the RSU or the other vehicle to perform the driving according to the event message.

According to the exemplary embodiment, when the instructions are executed, the at least one processor may be configured to transmit a update request message to a service provider server through the RSU which services the vehicle to perform the driving according to the event message. When the instructions are executed, the at least one processor may be configured to receive an update message from the service provider server through the RSU to perform the driving according to the event message. The update request message may comprise information related to the event of the source vehicle. The update message may comprise information for representing the updated driving route of the vehicle.

According to the exemplary embodiments, a device performed by the road side unit (RSU) may comprise at least one transceiver, a memory configured to store instructions, and at least one processor operatively coupled to at least one transceiver and the memory. When the instructions are executed, the at least one processor may be configured to receive an event message related to an event in the source vehicle, from a vehicle which is serviced by the RSU. The event message may comprise identification information of the vehicle and direction information indicating a driving direction of the vehicle. The at least one processor may be configured to identify the driving route of the vehicle based on the identification information of the vehicle when the instructions are executed. When the instructions are executed, the at least one processor may be configured to identify at least one RSU located in a direction opposite to the driving direction of the vehicle, from the RSU, among one or more RSUs comprised in the driving route of the vehicle. When the instructions are executed, the at least one processor may be configured to transmit the event message to each of the at least one identified RSU.

According to the exemplary embodiment, when the instructions are executed, the at least one processor may be configured to generate a transmission event message based on the event message. When the instructions are executed, the at least one processor encrypts the transmission event message based on the encryption information about the RSU and when the instructions are executed, the at least one processor may be configured to transmit the encrypted transmission event message to the other vehicle in the RSU. The encryption information about the RSU may be broadcasted from the RSU.

According to the exemplary embodiments, a method performed by the vehicle may comprise an operation of receiving an event message related to an event of the source vehicle. The event message may comprise identification information about a serving road side unit (RSU) of the source vehicle and direction information indicating a driving direction of the source vehicle. The method may comprise an operation of identifying whether the serving RSU of the source vehicle is included in a driving list of the vehicle. The method may comprise an operation of identifying whether the driving direction of the source vehicle matches a driving direction of the vehicle. When it is identified that the driving direction of the source vehicle matches the driving direction of the vehicle and a serving RSU of the source vehicle is included in the driving list of the vehicle (upon identifying), the method may comprise an operation of performing the driving according to the event message. When it is identified that the driving direction of the source vehicle does not match the driving direction of the vehicle or a serving RSU of the source vehicle is not included in the driving list of the vehicle (upon identifying), the method may comprise an operation of performing the driving without the event message.

According to an exemplary embodiment, the driving list of the vehicle may comprise identification information about one or more RSUs. The driving direction may indicate one of a first lane direction and a second lane direction which is opposite to the first lane direction.

According to one exemplary embodiment, the method may comprise an operation of identifying the encryption information about the serving RSU, based on the reception of the event message. The method may comprise an operation of acquiring the identification information about the serving RSU of the source vehicle and the direction information indicating the driving direction of the source vehicle by decrypting the event mes sage based on the encryption information about the serving RSU.

According to one exemplary embodiment, the method may comprise an operation of transmitting a service request message to a service provider server through the RSU before receiving the event message. The method may comprise an operation of receiving a service response message corresponding to the service request message from the service provider server through the RSU. The service response message may comprise driving plan information indicating an expected driving route of the vehicle, information about each of one or more RSUs related to the expected driving route, and encryption information about one or more RSUs. The encryption information may comprise encryption information about the serving RSU.

According to one exemplary embodiment, the method may comprise an operation of receiving a broadcast message from the serving RSU before receiving the event message. The broadcast message may comprise identification information about the RSU, information indicating at least one RSU adjacent to the RSU, and encryption information about the RSU.

According to one exemplary embodiment, the operation of performing the driving according to the event message may comprise an operation of changing a driving related setting of the vehicle based on the event message. The driving related setting may comprise at least one of a driving route of the vehicle, a driving lane of the vehicle, a driving speed of the vehicle, a lane of the vehicle, or the braking of the vehicle.

According to one exemplary embodiment, the operation of performing the driving according to the event message may comprise an operation of generating a transmission event message based on the event message. The operation of performing the driving according to the event message may comprise an operation of encrypting the transmission event message based on the encryption information about an RSU which services the vehicle. The operation of performing the driving according to the event message may comprise an operation of transmitting the encrypted transmission event message to the RSU or the other vehicle.

According to the exemplary embodiment, the operation of performing the driving according to the event message may comprise an operation of transmitting an update request message to a service provider, via an RSU serving the vehicle. The operation of performing the driving according to the event message may comprise an operation of receiving an update message from the service provider server through the RSU. The update request message may comprise information related to the event of the source vehicle. The update message may comprise information for representing the updated driving route of the vehicle.

In the exemplary embodiments, the method performed by a road side unit (RSU) may comprise an operation of receiving an event related event message in the vehicle from the vehicle which is serviced by the RSU. The event message may comprise identification information of the vehicle and direction information indicating a driving direction of the vehicle. The method may comprise an operation of identifying a driving route of the vehicle based on the identification information of the vehicle. The method may comprise an operation of identifying at least one RSU located in a direction opposite to the driving direction of the vehicle from the RSU, among one or more RSUs included in the driving route of the vehicle. The method may comprise an operation of transmitting the event message to each of at least one identified RSU.

According to the exemplary embodiment, the method may comprise an operation of generating a transmission event message based on the event message. The method may comprise an operation of encrypting the transmission event message based on the encryption information about the RSU. The method may comprise an operation of transmitting the encrypted transmission event message to the other vehicle within the RSU. The encryption information about the RSU may be broadcasted from the RSU.

FIG. 20 illustrates an example of a block diagram of an electronic device according to an embodiment. Referring to FIG. 20, an electronic device 2001 according to an embodiment may comprise at least one of a processor 2020, a memory 200, a plurality of cameras 2050, a communication circuit 2070, or a display 2090. The processor 2020, the memory 2030, the plurality of cameras 2050, the communication circuit 2070, and/or the display 2090 may be electronically and/or operably coupled with each other by an electronical component such as a communication bus. The type and/or number of a hardware component included in the electronic device 2001 are not limited to those illustrated in FIG. 20. For example, the electronic device 2001 may comprise only a part of the hardware component illustrated in FIG. 20.

The processor 2020 of the electronic device 2001 according to an embodiment may comprise the hardware component for processing data based on one or more instructions. The hardware component for processing data may comprise, for example, an arithmetic and logic unit (ALU), a field programmable gate array (FPGA), and/or a central processing unit (CPU). The number of the processor 2020 may be one or more. For example, the processor 2020 may have a structure of a multi-core processor such as a dual core, a quad core, or a hexa core. The memory 2030 of the electronic device 2001 according to an embodiment may comprise the hardware component for storing data and/or instructions input and/or output to the processor 2020. The memory 2030 may comprise, for example, volatile memory such as random-access memory (RAM) and/or non-volatile memory such as read-only memory (ROM). The volatile memory may comprise, for example, at least one of dynamic RAM (DRAM), static RAM (SRAM), cache RAM, or pseudo SRAM (PSRAM). The non-volatile memory may comprise, for example, at least one of programmable ROM (PROM), erasable PROM (EPROM), electrically erasable PROM (EEPROM), flash memory, hard disk, compact disk, or embedded multimedia card (eMMC).

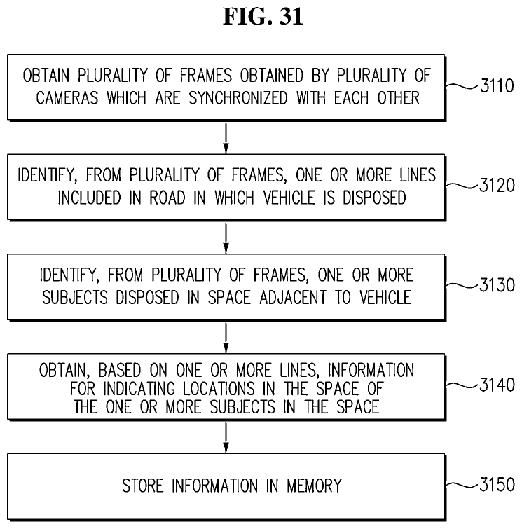

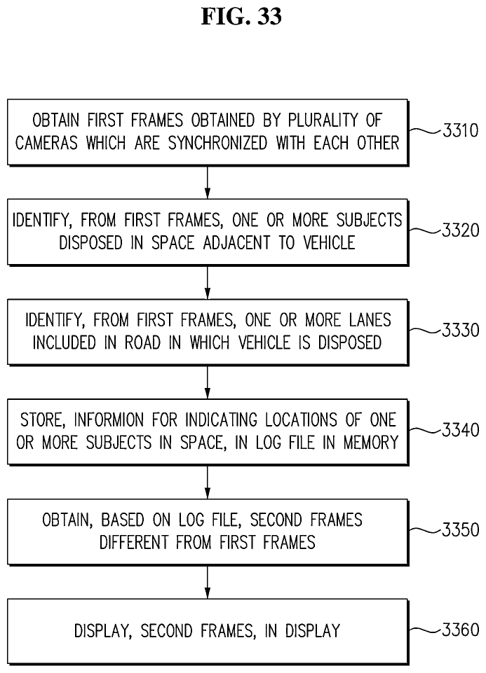

In the memory 2030 of the electronic device 2001 according to an embodiment, the one or more instructions indicating an operation to be performed on data by the processor 2020 may be stored. A set of instructions may be referred to as firmware, operating system, process, routine, sub-routine, and/or application. For example, the electronic device 2001 and/or the processor 2020 of the electronic device 2001 may perform the operation in FIG. 31 or FIG. 33 by executing a set of a plurality of instructions distributed in the form of the application.

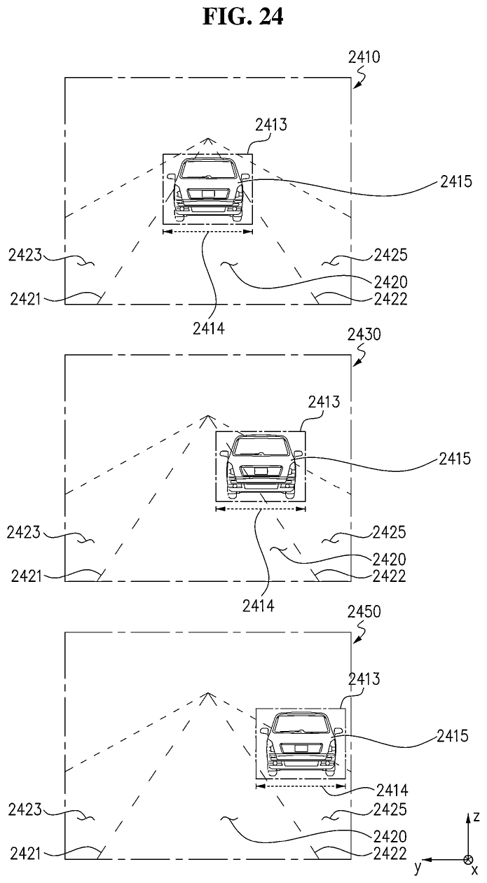

A set of parameters related to a neural network may be stored in the memory 2030 of the electronic device 2001 according to an embodiment. A neural network may be a recognition model implemented as software or hardware that mimic the computational ability of a biological system by using a large number of artificial neurons (or nodes). The neural network may perform human cognitive action or learning process through the artificial neurons. The parameters related to the neural network may indicate, for example, weights assigned to a plurality of nodes included in the neural network and/or connections between the plurality of nodes. For example, the structure of the neural network may be related to the neural network (e.g., convolution neural network (CNN)) for processing image data based on a convolution operation. The electronic device 2001 may obtain information on one or more subjects included in the image based on processing image (or frame) data obtained from at least one camera by using the neural network. The one or more subjects may comprise a vehicle, a bike, a line, a road, and/or a pedestrian. For example, the information on the one or more subjects may comprise the type of the one or more subjects (e.g., vehicle), the size of the one or more subjects, the distance between the one or more subjects, and/or electronic devices 2001. The neural network may be an example of a neural network learned to identify information on the one or more subjects included in a plurality of frames obtained by the plurality of cameras 2050. An operation in which the electronic device 2001 obtains information on the one or more subjects included in the image will be described later in FIGS. 24 to 30.

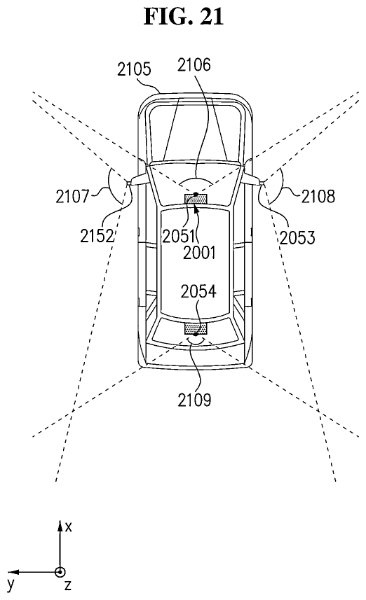

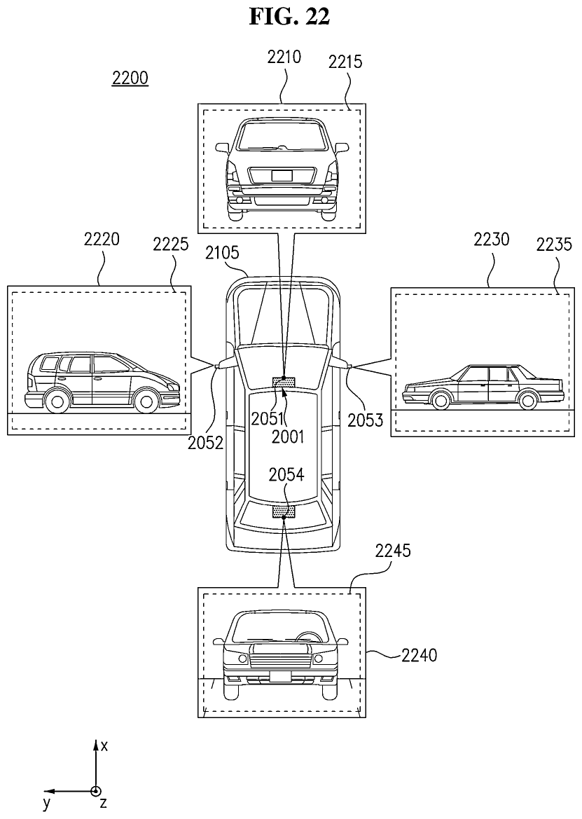

The plurality of cameras 2050 of the electronic device 2001 according to an embodiment may comprise one or more optical sensors (e.g., Charged Coupled Device (CCD) sensors, Complementary Metal Oxide Semiconductor (CMOS) sensors) that generate an electrical signal indicating the color and/or brightness of light. The plurality of optical sensors included in the plurality of cameras 2050 may be disposed in the form of a 2-dimensional array. The plurality of cameras 2050, by obtaining the electrical signals of each of the plurality of optical sensors substantially simultaneously, may respond to light reaching the optical sensors of the 2-dimensional array and may generate images or frames including a plurality of pixels arranged in 2-dimensions. For example, photo data captured by using the plurality of cameras 2050 may mean a plurality of images obtained from the plurality of cameras 2050. For example, video data captured by using the plurality of cameras 2050 may mean a sequence of the plurality of images obtained from the plurality of cameras 2050 according to a designated frame rate. The electronic device 2001 according to an embodiment may be disposed toward a direction in which the plurality of cameras 2050 receive light, and may further include a flashlight for outputting light in the direction. Locations where each of the plurality of cameras 2050 is disposed in the vehicle will be described later in FIGS. 21 to 22.

For example, each of the plurality of cameras 2050 may have an independent direction and/or Field-of-View (FOV) within the electronic device 2001. The electronic device 2001 according to an embodiment may identify the one or more subjects included in the frames by using frames obtained by each of the plurality of cameras 2050.

The electronic device 2001 according to an embodiment may establish a connection with at least a part of the plurality of cameras 2050. Referring to FIG. 20, the electronic device 2001 may comprise a first camera 2051, and may establish a connection with a second camera 2052, a third camera 2053, and/or a fourth camera 2054 different from the first camera. For example, the electronic device 2001 may establish a connection with the second camera 2052, the third camera 2053, and/or the fourth camera 2054 directly or indirectly by using the communication circuit 2070. For example, the electronic device 2001 may establish a connection with the second camera 2052, the third camera 2053, and/or the fourth camera 2054 by wire by using a plurality of cables. For example, the second camera 2052, the third camera 2053, and/or the fourth camera 2054 may be referred to as an example of an external camera in that they are disposed outside the electronic device 2001.

The communication circuit 2070 of the electronic device 2001 according to an embodiment may comprise the hardware component for supporting transmission and/or reception of signals between the electronic device 2001 and the plurality of cameras 2050. The communication circuit 2070 may comprise, for example, at least one of a modem (MODEM), an antenna, or an optical/electronic (O/E) converter. For example, the communication circuit 2070 may support transmission and/or reception of signals based on various types of protocols such as Ethernet, local area network (LAN), wide area network (WAN), wireless fidelity (WiFi), Bluetooth, Bluetooth low energy (BLE), ZigBee, long term evolution (LTE), and 5G NR (new radio). The electronic device 2001 may be interconnected with the plurality of cameras 2050 based on a wired network and/or a wireless network. For example, the wired network may comprise a network such as the Internet, a local area network (LAN), a wide area network (WAN), Ethernet, or a combination thereof. The wireless network may comprise a network such as long term evolution (LTE), 5G new radio (NR), wireless fidelity (WiFi), Zigbee, near field communication (NFC), Bluetooth, Bluetooth low-energy (BLE), or a combination thereof. In FIG. 20, the electronic device 2001 is illustrated as being directly connected to the plurality of cameras 2052, 2053, and 2054, but is not limited thereto. For example, the electronic device 2001 and the plurality of cameras 2052, 2053, and 2054 may be indirectly connected through one or more routers and/or one or more access points (APs).

The electronic device 2001 according to an embodiment may establish a connection by wireless by using the plurality of cameras 2050 and the communication circuit 2070, or may establish a connection by wire by using a plurality of cables disposed in the vehicle. The electronic device 2001 may synchronize the plurality of cameras 2050 by wireless and/or by wire based on the established connection. For example, the electronic device 2001 may control the plurality of synchronized cameras 2050 based on a plurality of channels. For example, the electronic device 2001 may obtain a plurality of frames based on the same timing by using the plurality of synchronized cameras 2050.

The display 2090 of the electronic device 2001 according to an embodiment may be controlled by a controller such as the processor 2020 to output visualized information to a user. The display 2090 may comprise a flat panel display (FPD) and/or electronic paper. The FPD may comprise a liquid crystal display (LCD), a plasma display panel (PDP), and/or one or more light emitting diodes (LEDs). The LED may comprise an organic LED (OLED). For example, the display 2090 may be used to display an image obtained by the processor 2020 or a screen (e.g., top-view screen) obtained by a display driving circuit. For example, the electronic device 2001 may display the image on a part of the display 2090 according to the control of the display driving circuit. However, it is not limited thereto.

As described above, the electronic device 2001, by using the plurality of cameras 2050, may identify one or more lines included in the road on which the vehicle on which the electronic device 2001 is mounted is disposed and/or a plurality of vehicles different from the vehicle. The electronic device 2001 may obtain information on the lines and/or the plurality of different vehicles based on frames obtained by using the plurality of cameras 2050. The electronic device 2001 may store the obtained information in the memory 2030 of the electronic device 2001. The electronic device 2001 may display a screen corresponding to the information stored in the memory in the display 2090. The electronic device 2001 may provide a user with a surrounding state of the vehicle while the vehicle on which the electronic device 2001 is mounted is moving based on displaying the screen in the display 2090. Hereinafter, in FIGS. 21 to 22, an operation in which the electronic device 2001 obtains frames with respect to the outside of a vehicle on which the electronic device 2001 is mounted by using the plurality of cameras 2050 will be described later.

FIGS. 21 to 23 illustrate exemplary states indicating obtaining of a plurality of frames using an electronic device disposed in a vehicle according to an embodiment. Referring to FIGS. 21 to 22, an exterior of a vehicle 2105 on which an electronic device 2001 is mounted is illustrated. The electronic device 2001 may be referred to the electronic device 2001 in FIG. 20. The plurality of cameras 2050 may be referred to the plurality of cameras 2050 in FIG. 20. For example, the electronic device 2001 may establish a connection by wireless by using the plurality of cameras 2050 and the communication circuit (e.g., the communication circuit 2070 in FIG. 20). For example, the electronic device 2001 may establish a connection with the plurality of cameras 2050 by wire by using a plurality of cables. The electronic device 2001 may synchronize the plurality of cameras 2050 based on the established connection. For example, angles of view 2106, 2107, 2108, and 2109 of each of the plurality of cameras 2050 may be different from each other. For example, each of the angles of view 2106, 2107, 2108, and 2109 may be 100 degrees or more. For example, the sum of the angles of view 2106, 2107, 2108, and 2109 of each of the plurality of cameras 2050 may be 360 degrees or more.

Referring to FIGS. 21 to 22, the electronic device 2001 may be an electronic device included in the vehicle 2105. For example, the electronic device 2001 may be embedded in the vehicle 2105 before the vehicle 2105 is released. For example, the electronic device 2001 may be embedded in the vehicle 2105 based on a separate process after the vehicle 2105 is released. For example, the electronic device 2001 may be mounted on the vehicle 2105 so as to be detachable after the vehicle 2105 is released. However, it is not limited thereto.

Referring to FIG. 21, the electronic device 2001 according to an embodiment may be located on at least a part of the vehicle 2105. For example, the electronic device 2001 may comprise a first camera 2051. For example, the first camera 2051 may be disposed such that the direction of the first camera 2051 faces the moving direction of the vehicle 2105 (e.g., +x direction). For example, the first camera 2051 may be disposed such that an optical axis of the first camera 2051 faces the front of the vehicle 2105. For example, the first camera 2051 may be located on a dashboard, an upper part of a windshield, or in a room mirror of the vehicle 2105.

The second camera 2052 according to an embodiment may be disposed on the left side surface of the vehicle 2105. For example, the second camera 2052 may be disposed to face the left direction (e.g., +y direction) of the moving direction of the vehicle 2105. For example, the second camera 2052 may be disposed on a left side mirror or a wing mirror of the vehicle 2105.

The third camera 2053 according to an embodiment may be disposed on the right side surface of the vehicle 2105. For example, the third camera 2053 may be disposed to face the right direction (e.g., −y direction) of the moving direction of the vehicle 2105. For example, the third camera 2053 may be disposed on a side mirror or a wing mirror of the right side of the vehicle 2105.

The fourth camera 2054 according to an embodiment may be disposed toward the rear (e.g., −x direction) of the vehicle 2105. For example, the fourth camera 2054 may be disposed at an appropriate location of the rear of the vehicle 2105.

Referring to FIG. 22, a state 2200 in which the electronic device 2001 mounted on the vehicle 2105 obtains a plurality of frames 2210, 2220, 2230, and 2240 by using the plurality of cameras 2050.) is illustrated. The electronic device 2001 according to an embodiment may obtain a plurality of frames including one or more subjects disposed in the front, side, and/or rear of the vehicle 2105 by using the plurality of cameras 2050.

According to an embodiment, the electronic device 2001 may obtain first frames 2210 including the one or more subjects disposed in front of the vehicle by the first camera 2051. For example, the electronic device 2001 may obtain the first frames 2210 based on the angle of view 2106 of the first camera 2051. For example, the electronic device 2001 may identify the one or more subjects included in the first frames 2210 by using the neural network. The neural network may be an example of a neural network trained to identify the one or more subjects included in the frames 2210. For example, the neural network may be a neural network pre-trained based on a single shot detector (SSD) and/or you only look once (YOLO). However, it is not limited to the above-described embodiment.

For example, the electronic device 2001 may use the bounding box 2215 to detect the one or more subjects within the first frames 2210 obtained by using the first camera 2051. The electronic device 2001 may identify the size of the one or more subjects by using the bounding box 2215. For example, the electronic device 2001 may identify the size of the one or more subjects based on the size of the first frames 2210 and the size of the bounding box 2215. For example, the length of an edge (e.g., width) of the bounding box 2215 may correspond to the horizontal length of the one or more subjects. For example, the length of the edge may correspond to the width of the vehicle. For example, the length of another edge (e.g., height) different from the edge of the bounding box 2215 may correspond to the vertical length of the one or more subjects. For example, the length of another edge may correspond to the height of the vehicle. For example, the electronic device 2001 may identify the size of the one or more subjects disposed in the bounding box 2215 based on a coordinate value corresponding to a corner of the bounding box 2215 in the first frames 2210.

According to an embodiment, the electronic device 2001, by using the second camera 2052, may obtain second frames 2220 including the one or more subjects disposed on the left side of the moving direction of the vehicle 2105 (e.g., +x direction). For example, the electronic device 2001 may obtain the second frames 2220 based on the angle of view 2107 of the second camera 2052.

For example, the electronic device 2001 may identify the one or more subjects in the second frames 2220 obtained by using the second camera 2052 by using the bounding box 2225. The electronic device 2001 may obtain the sizes of the one or more subjects by using the bounding box 2225. For example, the length of an edge of the bounding box 2225 may correspond to the length of the vehicle. For example, the length of another edge, which is different from the one edge of the bounding box 2215, may correspond to the height of the vehicle. For example, the electronic device 2001 may identify the size of the one or more subjects disposed in the bounding box 2215 based on a coordinate value corresponding to a corner of the bounding box 2215 in the first frames 2210.

According to an embodiment, the electronic device 2001, by using the third camera 2053, may obtain the third frames 2230 including the one or more subjects disposed on the right side of the moving direction (e.g., +x direction) of the vehicle 2105. For example, the electronic device 2001 may obtain the third frames 2230 based on the angle of view 2108 of the third camera 2053. For example, the electronic device 2001 may use the bounding box 2235 to identify the one or more subjects within the third frames 2230. The size of the bounding box 2235 may correspond to at least a part of the sizes of the one or more subjects. For example, the size of the one or more subjects may comprise the width, height, and/or length of the vehicle.

According to an embodiment, the electronic device 2001, by using the fourth camera 2054, may obtain the fourth frames 2240 including the one or more subjects disposed at the rear of the vehicle 2105 (e.g., −x direction). For example, the electronic device 2001 may obtain the fourth frames 2240 based on the angle of view 2109 of the fourth camera 2054. For example, the electronic device 2001 may use the bounding box 2245 to detect the one or more subjects included in the fourth frames 2240. For example, the size of the bounding box 2245 may correspond to at least a part of the sizes of the one or more subjects.

The electronic device 2001 according to an embodiment may identify subjects included in each of the frames 2210, 2220, 2230, and 2240 and the distance between the electronic devices 2001 by using bounding boxes 2215, 2225, 2235, and 2245. For example, the electronic device 2001 may obtain the width of the subject (e.g., the width of the vehicle) by using the bounding box 2215 and/or the bounding box 2245. The electronic device 2001 may identify the distance between the electronic device 2001 and the subject based on the type (e.g., sedan, truck) of the subject stored in the memory and/or the width of the obtained subject.

For example, the electronic device 2001 may obtain the length of the subject (e.g., the length of the vehicle) by using the bounding box 2225 and/or the bounding box 2235. The electronic device 2001 may identify the distance between the electronic device 2001 and the subject based on the type of the subject stored in memory and/or the obtained length of the subject.

The electronic device 2001 according to an embodiment may correct the plurality of frames 2210, 2220, 2230, and 2240 obtained by the plurality of cameras 2050 by using at least one neural network stored in a memory (e.g., the memory 2030 in FIG. 20). For example, the electronic device 2001 may calibrate the image by using the at least one neural network. For example, the electronic device 2001 may obtain a parameter corresponding to the one or more subjects included in the plurality of frames 2210, 2220, 2230, and 2240 based on calibration of the plurality of frames 2210, 2220, 2230, and 2240.

For example, the electronic device 2001 may remove noise included in the plurality of frames 2210, 2220, 2230, and 2240 by calibrating the plurality of frames 2210, 2220, 2230, and 2240. The noise may be a parameter corresponding to an object different from the one or more subjects included in the plurality of frames 2210, 2220, 2230, and 2240. For example, the electronic device 2001 may obtain information on the one or more subjects (or objects) based on calibration of the plurality of frames 2210, 2220, 2230, and 2240. For example, the information may comprise the location of the one or more subjects, the type of the one or more subjects (e.g., vehicle, bus, and/or truck), the size of the one or more subjects (e.g., the width of the vehicle, or the length of the vehicle), the number of the one or more subjects, and/or the time information in which the one or more subjects are captured in the plurality of frames 2210, 2220, 2230, and 2240. However, it is not limited thereto. For example, information on the one or more subjects may be indicated as shown in Table 6.

TABLE 6

| line number | data format | Content |
|---|---|---|
| 1 | time information | time information (or frame order) |
| | (or frame) | corresponding to each of the frames |
| 2 | camera | First camera 151 [front], second camera |
| | | 152 [left side], third camera 153 [right |
| | | side], fourth camera 154 [rear] |
| 3 | number of objects | number of objects included in frames |
| 4 | object number | object number |
| 5 | object type | sedan, bus, truck, compact car, bike, |
| | | human |
| 6 | object location | location coordinates (x, y) of an object |
| | information | based on a 2-dimensional coordinate |
| | | system |

For example, referring to line number 1 in Table 6 described above, the time information may mean time information on each of the frames obtained from a camera, and/or an order for frames. Referring to line number 2, the camera may mean a camera obtained each of the frames. For example, the camera may comprise the first camera 2051, the second camera 2052, the third camera 2053, and/or the fourth camera 2054. Referring to line number 3, the number of objects may mean the number of objects (or subjects) included in each of the frames. Referring to line number 4, the object number may mean an identifier number (or index number) corresponding to objects included in each of the frames. The index number may mean an identifier set by the electronic device 2001 corresponding to each of the objects in order to distinguish the objects. Referring to line number 5, the object type may mean a type for each of the objects. For example, types may be classified into a sedan, a bus, a truck, a light vehicle, a bike, and/or a human. Referring to line number 6, the object location information may mean a relative distance between the electronic device 2001 and the object obtained by the electronic device 2001 based on the 2-dimensional coordinate system. For example, the electronic device 2001 may obtain a log file by using each information in a data format. For example, the log file may be indicated as “[time information] [camera] [object number] [type] [location information corresponding to object number]”. For example, the log file may be indicated as “[2022-09-22-08-29-48][F][3][1:sedan,30,140][2:truck,120,45][3:bike,400,213]”. For example, information indicating the size of the object according to the object type may be stored in the memory.

The log file according to an embodiment may be indicated as shown in Table 7 below.

TABLE 7

| line number | field | description |
|---|---|---|
| 1 | [2022-09-22-08-29- | Image captured time information |
| | 48] | |
| 2 | [F] | camera location information |
| | | [F]: Forward |
| | | [R]: Rear |
| | | [LW]: Left wing, Left side |
| | | [RW]: Right wing, Right side |
| 3 | [3] | number of detected objects in the obtained image |
| 4 | [1: sedan, 30, 140] | 1: identifier assigned to identify detected objects in the |
| | | obtained image (indicating the first object among the |
| | | total of three detected objects) |
| | | sedan: indicates that the object type of the detected |
| | | object is Sedan |
| | | 30: location information on the x-axis from the Ego |
| | | vehicle (e.g., the vehicle 205 in FIG. 2A), |
| | | 140: location information on the y-axis from the Ego |
| | | vehicle |
| 5 | [2: truck, 120, 45] | 2: identifier assigned to identify detected objects in the |
| | | obtained image (indicating the second object among the |
| | | total of three detected objects) |
| | | truck: indicates that the object type of the detected |
| | | object is a truck |
| | | 120: location information on the x-axis from the Ego |
| | | vehicle (e.g., the vehicle 205 in FIG. 2A), |
| | | 45: location information on the y-axis from the Ego |
| | | vehicle |
| 6 | [3: bike, 400, 213] | 3: identifier assigned to identify detected objects in the |
| | | obtained image (indicating the third object among the |
| | | total of three detected objects) |
| | | bike: indicates that the object type of the detected object |
| | | is a bike |
| | | 400: location information on the x-axis from the ego |
| | | vehicle (e.g., the vehicle 205 in FIG. 2A), |
| | | 213: location information on the y-axis from the Ego |
| | | vehicle |

Referring to line number 1 in Table 7 described above, the electronic device 2001 may store information on the time at which the image is obtained in a log file by using a camera. Referring to line number 2, the electronic device 2001 may store information indicating a camera used to obtain the image (e.g., at least one of the plurality of cameras 2050 in FIG. 21) in a log file. Referring to line number 3, the electronic device 2001 may store the number of objects included in the image in a log file. Referring to line number 4, line number 5, and/or line number 6, the electronic device 2001 may store type and/or location information on one of the objects included in the image in a log file. However, it is not limited thereto. In Table 7 described above, only a total of three object types are displayed, but this is only an example, and it will be natural that they may be specifically subdivided into other objects (e.g., bus, sports utility vehicle (SUV), pick-up truck, dump truck, mixer truck, excavator, and the like) according to pre-trained models. For example, the electronic device 2001 may store the obtained information in a log file of a memory (e.g., the memory 2030 in FIG. 20) of the electronic device 2001. For example, the electronic device 2001 may store in the log file by obtaining information on the one or more subjects from each of the plurality of frames 2210, 2220, 2230, and 2240.

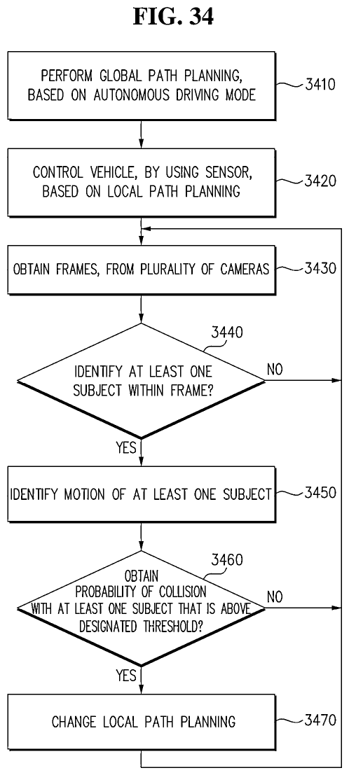

According to an embodiment, the electronic device 2001 may infer motion of the one or more subjects by using the log file. Based on the inferred motion of the one or more subjects, the electronic device 2001 may control a moving direction of a vehicle in which the electronic device 2001 is mounted. An operation in which the electronic device 2001 controls the moving direction of the vehicle in which the electronic device 2001 is mounted will be described later in FIG. 34.

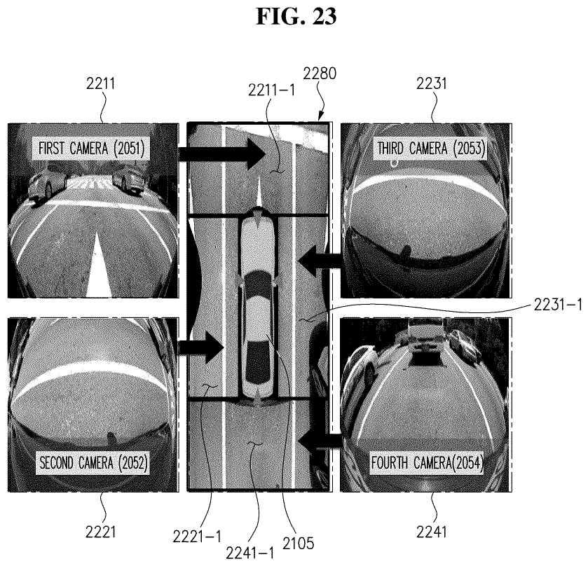

Referring to FIG. 23, the electronic device 2001 according to an embodiment may generate the image 2280 by using frames obtained from the cameras 2050. The image 2280 may be referred to a top view image. The image 2280 may be generated by using one or more images. For example, the image 2280 may comprise a visual object indicating the vehicle 2105. For example, the image 2211 may be at least one of the first frames 2210. The image 2221 may be at least one of the second frames 2220. The image 2231 may be at least one of the third frames 2230. The image 2241 may be at least one of the fourth frames 2240.

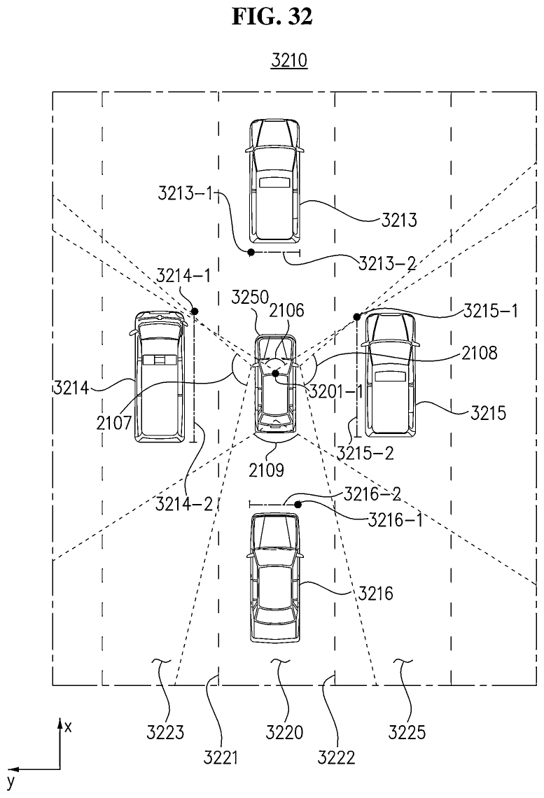

For example, the electronic device 2001 may change the images 2211, 2221, 2231, and 2241 respectively by using at least one function (e.g., homography matrix). Each of the changed images 2211, 2221, 2231, and 2241 may correspond to the images 2211-1, 2221-1, 2231-1, and 2241-1. An operation in which the electronic device 2001 uses the obtained image 2280 by using the images 2211-1, 2221-1, 2231-1, and 2241-1 will be described later in FIG. 32. The electronic device 2001 according to an embodiment may obtain the image 2280 by using the four cameras 2050 disposed in the vehicle 2105. However, it is not limited thereto.

As described above, the electronic device 2001, mountable in the vehicle 2105, may comprise the plurality of cameras 2050 or may establish a connection with the plurality of cameras 2050. The electronic device 2001 and/or the plurality of cameras 2050 may be mounted within different parts of the vehicle 2105, respectively. The sum of the angles of view 2106, 2107, 2108, and 2109 of the plurality of cameras 2050 mounted on the vehicle 2105 may have a value of 360 degrees or more. For example, by using the plurality of cameras 2050 disposed facing each direction of the vehicle 2105, the electronic device 2001 may obtain the plurality of frames 2210, 2220, 2230, and 2240 including the one or more subjects located around the vehicle 2105. The electronic device 2001 may obtain a parameter (or feature value) corresponding to the one or more subjects by using a pre-trained neural network. The electronic device 2001 may obtain information on the one or more subjects (e.g., vehicle size, vehicle type, time and/or location relationship) based on the obtained parameter. Hereinafter, in FIGS. 24 to 30, an operation in which the electronic device 2001 identifies at least one subject by using a camera disposed facing one direction will be described later.

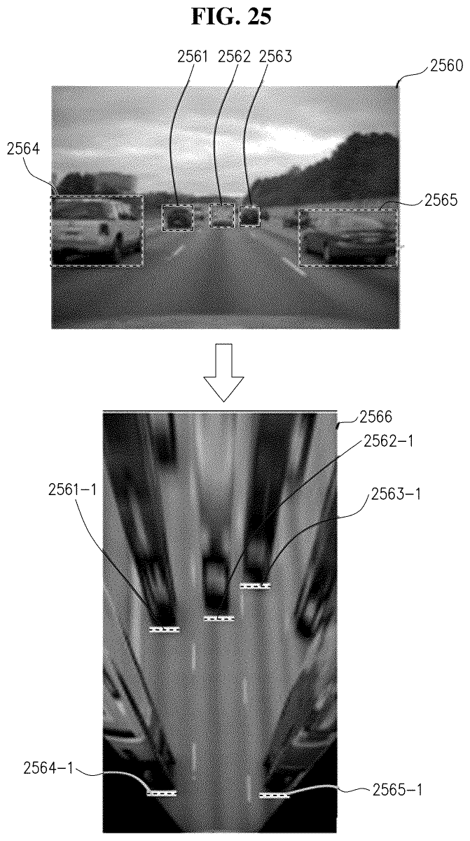

FIGS. 24 to 25 illustrate an example of frames including information on a subject that an electronic device 2001 obtained by using a first camera 2051 disposed in front of a vehicle 2105, according to an embodiment. Referring to FIG. 24, the images 2410, 2430, and 2450 corresponding to one frame of the first frames (e.g., first frames 2210 in FIG. 22) obtained by the first camera (e.g., first camera 2051 in FIG. 20) disposed toward the moving direction (e.g., +x direction) of the vehicle (e.g., vehicle 2105 in FIG. 21) by the electronic device 2001 in FIG. 20 are illustrated. The electronic device 2001 may obtain different information in the images 2410, 2430, and 2450. The electronic device may correspond to the electronic device 2001 in FIG. 20.

According to an embodiment, the electronic device 2001 may obtain an image 2410 about the front of the vehicle by using a first camera (e.g., the first camera 2051 in FIG. 21) while the vehicle on which the electronic device 2001 is mounted (e.g., the vehicle 2105 in FIG. 21) moves toward one direction (e.g., +x direction). At this time, the electronic device 2001 may classify, via a pre-trained neural network engine, the one or more subjects present in the image of the front of the vehicle, and identify the classified subjects. For example, the electronic device 2001 may identify one or more subjects in the image 2410. For example, the image 2410 may comprise the vehicle 2215 disposed in front of the vehicle on which the electronic device is mounted (e.g., the vehicle 2105 in FIG. 21), the lines 2421 and 2422, and/or lanes 2420, 2423, and 2425 divided by lines within the road. The electronic device 2001 may identify the vehicle 2415, lines 2421 and 2422, and/or lanes 2420, 2423, and 2425 in the image 2410. For example, although not illustrated, the electronic device 2001 may identify natural objects, traffic lights, road signs, humans, bikes, and/or animals in the image 2410. However, it is not limited thereto.

For example, in the image 2410, the vehicle 2415 may be an example of a vehicle 2415 that is disposed on the same lane 2420 as the vehicle (e.g., vehicle 2105 in FIG. 21) in which the electronic device 2001 is mounted and is disposed in front of the vehicle (e.g., the vehicle 2105 in FIG. 21) in which the electronic device 2001 is mounted. For example, referring to FIG. 24, one vehicle 2415 disposed in front of the vehicle (e.g., the vehicle 2105 in FIG. 21) is illustrated, but is not limited thereto. For example, the images 2410, 2430, and 2450 may comprise one or more vehicles. For example, the electronic device 2001 may set an identifier for the vehicle 2415. For example, the identifier may mean an index code set by the electronic device 2001 to track the vehicle 2415.

For example, the electronic device 2001 may obtain a plurality of parameters corresponding to the vehicle 2415, the lines 2421, 2422, and/or the lanes 2420, 2423, 2425 by using a neural network stored in the memory (e.g., the memory 2030 in FIG. 20). For example, the electronic device 2001 may identify a type of the vehicle 2415 based on a parameter corresponding to the vehicle 2415. The vehicle 2415 may be classified into a sedan, a sport utility vehicle (SUV), a recreational vehicle (RV), a hatchback, a truck, a bike, or a bus. For example, the electronic device 2001 may identify the type of the vehicle 2415 by using information on the exterior of the vehicle 2415 including the tail lamp, license plate, and/or tire of the vehicle 2415. However, it is not limited thereto.

According to an embodiment, the electronic device 2001 may identify a distance from the vehicle 2415 and/or a location of the vehicle 2415 based on the locations of the lines 2421, 2422, the lanes 2420, 2423, 2425, and the first camera (e.g., the first camera 2051 in FIG. 21), the magnification of the first camera, the angle of view of the first camera (e.g., the angle of view 2106 in FIG. 21) and/or the width of the vehicle 2415.

According to an embodiment, the electronic device 2001 may obtain information on the location of the vehicle 2415 (e.g., the location information in Table 6) based on the distance from the vehicle 2415 and/or the type of the vehicle 2415. For example, the electronic device 2001 may obtain the width 2414 by using a size representing the type (e.g., sedan) of the vehicle 2415.

According to an embodiment, the width 2414 may be obtained by the bounding box 2413 used by the electronic device 2001 to identify the vehicle 2415 in the image 2410. The width 2414 may correspond to, for example, a horizontal length among line segments of the bounding box 2413 of the vehicle 2415. For example, the electronic device 2001 may obtain a numerical value of the width 2414 by using pixels corresponding to the width 2414 in the image 2410. The electronic device 2001 may obtain a relative distance between the electronic device 2001 and the vehicle 2415 by using the width 2414.

The electronic device 2001 may obtain a log file for the vehicle 2415 by using the lines 2421 and 2422, the lanes 2420, 2423 and 2425, and/or the width 2414. Based on the obtained log file, the electronic device 2001 may obtain location information (e.g., coordinate value based on 2-dimensions) of a visual object corresponding to the vehicle 2415 to be disposed in the top view image. An operation in which the electronic device 2001 obtains the top view image will be described later in FIG. 25.

The electronic device 2001 according to an embodiment may identify vehicle 2415 in image 2430, which is being cut in and/or cut out. For example, the electronic device 2001 may identify the movement of the vehicle 2415 overlapped on the line 2422 in the image 2430. The electronic device 2001 may track the vehicle 2415 based on the identified movement. The electronic device 2001 may identify the vehicle 2415 included in the image 2430 and the vehicle 2415 included in the image 2410 as the same object (or subject) by using an identifier for the vehicle 2415. For example, the electronic device 2001 may use the images 2410, 2430, and 2450 configured as a series of sequences within the first frames (e.g., the first frames 2210 in FIG. 22) obtained by using the first camera (e.g., the first camera 2051 in FIG. 21) for the tracking. For example, the electronic device 2001 may identify a change between the location of the vehicle 2415 within the image 2410 and the location of the vehicle 2415 within the image 2430 after the image 2410. For example, the electronic device 2001 may predict that the vehicle 2415 will be moved from the lane 2420 to the lane 2425, based on the identified change. For example, the electronic device 2001 may store information on the location of the vehicle 2415 in a memory.

The electronic device 2001 according to an embodiment may identify the vehicle 2415 moved from the lane 2420 to the lane 2425 within the image 2450. For example, the electronic device 2001 may generate the top view image by using the first frames (e.g., the first frames 2210 in FIG. 22) including images 2410, 2430, and 2450 based on information on the location of the vehicle 2415 and/or information on the lines 2421 and 2422. An operation in which the electronic device 2001 generates the top view image will be described later in FIG. 25.

Referring to FIG. 25, the electronic device 2001 according to an embodiment may identify the one or more subjects included in the image 2560. The electronic device 2001 may identify the one or more subjects by using each of the bounding boxes 2561, 2562, 2563, 2564, and 2565 corresponding to each of the one or more subjects. For example, the electronic device 2001 may obtain location information on each of the one or more subjects by using the bounding boxes 2561, 2562, 2563, 2564, and 2565.

For example, the electronic device 2001 may transform the image 2560 by using at least one function (e.g., homography matrix). The electronic device 2001 may obtain the image 2566 by projecting the image 2560 to one plane by using the at least one function. For example, the line segments 2561-1, 2562-1, 2563-1, 2564-1, and 2565-1 may mean a location where the bounding boxes 2561, 2562, 2563, 2564, and 2565 are displayed in the image 2566. The line segments 2561-1, 2562-1, 2563-1, 2564-1, and 2565-1 included in the image 2566 according to an embodiment may correspond to the one line segment of each of the bounding boxes 2561, 2562, 2563, 2564, and 2565. The line segments 2561-1, 2562-1, 2563-1, 2564-1, and 2565-1 may be referred to the width of each of the one or more subjects. For example, the line segment 2561-1 may be referred to the width of the bounding box 2561. The line segment 2562-1 may be referred to the width of the bounding box 2562. The line segment 2563-1 may be referred to the width of the bounding box 2563. The line segment 2564-1 may be referred to the width of the bounding box 2564. The line segment 2565-1 may be referred to the width of the bounding box 2565. However, it is not limited thereto. For example, the electronic device 2001 may generate the image 2566 based on identifying the one or more subjects (e.g., vehicles), lanes, and/or lines included in the image 2560.

The image 2566 according to an embodiment may correspond to an image for obtaining the top view image. The image 2566 according to an embodiment may be an example of an image obtained by using the image 2560 obtained by a front camera (e.g., the first camera 2051) of the electronic device 2001. The electronic device 2001 may obtain a first image different from the image 2566 by using frames obtained by using the second camera 2052. The electronic device 2001 may obtain a second image by using frames obtained by using the third camera 2053. The electronic device 2001 may obtain a third image by using frames obtained by using the fourth camera 2054. Each of the first image, the second image, and/or the third image may comprise one or more bounding boxes for identifying at least one subject. The electronic device 2001 may obtain an image (e.g., top view image) based on information of at least one subject included in the image 2566, the first image, the second image, and/or the third image.

As described above, the electronic device 2001 mounted on the vehicle (e.g., the vehicle 2105 in FIG. 21) may identify the vehicle 2415, the lines 2421, 2422, and/or the lanes 2420, 2423, 2425 which are different from the vehicle located in front of the vehicle by using a first camera (e.g., the first camera 2051 in FIG. 21). For example, the electronic device 2001 may identify the type of the vehicle 2415 and/or the size of the vehicle 2415, based on the exterior of the vehicle 2415. For example, the electronic device 2001 may identify relative location information (e.g., the location information of Table 6) between the electronic device 2001 and the vehicle 2415 based on the lines 2421 and 2422, the type of the vehicle 2415, and/or the size of the vehicle 2415.

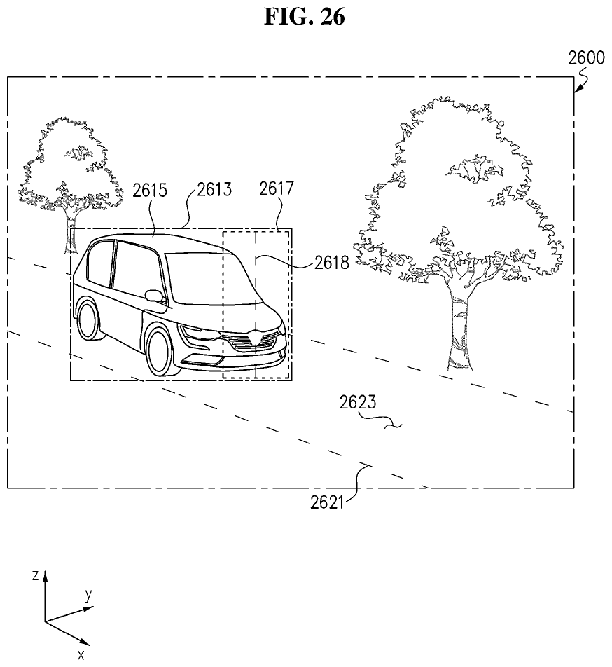

For example, the electronic device 2001 may store information on the vehicle 2415 (e.g., the type of vehicle 2415 and the location of the vehicle) in a log file of a memory. The electronic device 2001 may display a plurality of frames corresponding to the timing at which the vehicle 2415 is captured through the log file on the display (e.g., the display 2090 in FIG. 20). For example, the electronic device 2001 may generate the plurality of frames by using a log file. The generated plurality of frames may be referred to a top view image (or a bird eye view image). An operation in which the electronic device 2001 uses the generated plurality of frames will be described later in FIGS. 32 and 33. Hereinafter, in FIGS. 26 to 29, an operation in which the electronic device 2001 identifies the one or more subjects located on the side of a vehicle in which the electronic device 2001 is mounted by using a plurality of cameras will be described below.

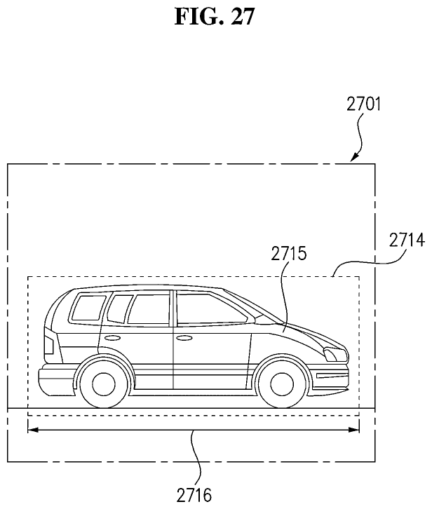

FIGS. 26 to 27 illustrate an example of frames including information on a subject that an electronic device obtained by using a second camera disposed on the left side surface of a vehicle, according to an embodiment.

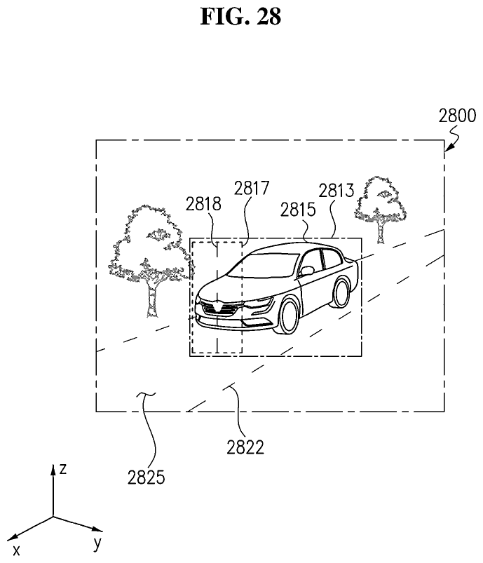

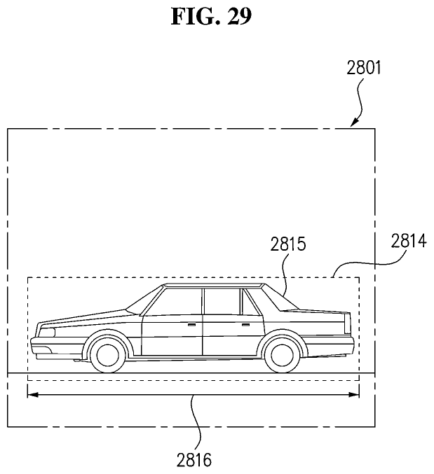

FIGS. 28 to 29 illustrate an example of frames including information on a subject that an electronic device obtained by using a third camera 2053 disposed on the right side surface of a vehicle 2105, according to an embodiment. In FIGS. 26 to 29, images 2600 and 2800 including one or more subjects located on the side of a vehicle (e.g., the vehicle 2105 in FIG. 21) in which the electronic device 2001 in FIG. 20 is mounted are illustrated. For example, the images 2600 and 2800 may be included in a plurality of frames obtained by the electronic device 2001 in FIG. 20 by using a part of the plurality of cameras. For example, the line 2621 may be referred to the line 2421 in FIG. 24. The lane 2623 may be referred to the lane 2423 in FIG. 24. The line 2822 may be referred to the line 2422 in FIG. 24. The lane 2825 may be referred to the lane 2425 in FIG. 24.

Referring to FIG. 26, an image 2600 according to an embodiment may be included in a plurality of frames (e.g., the second frames 2020 in FIG. 22) obtained by the electronic device 2001 by using the second camera (e.g., the second camera 2052 in FIG. 21). For example, the electronic device 2001 may obtain the captured image 2600 toward the left direction (e.g., +y direction) of the vehicle (e.g., the vehicle 2105 in FIG. 21) by using the second camera (e.g., the second camera 2052 in FIG. 21). For example, the electronic device 2001 may identify the vehicle 2615, the line 2621, and/or the lane 2623 located on the left side of the vehicle (e.g., the vehicle 2105 in FIG. 21) in the image 2600.

The electronic device 2001 according to an embodiment may identify that the line 2621 and/or the lane 2623 are located on the left side surface of the vehicle (e.g., the vehicle 2105 in FIG. 21) by using the synchronized first camera (e.g., the first camera 2051 in FIG. 21) and second camera (e.g., the second camera 2052 in FIG. 21). The electronic device 2001 may identify the extended line 2621 from the line 2421 in FIG. 24 toward one direction (e.g., −x direction) by using the first camera and/or the second camera.

Referring to FIG. 26, the electronic device 2001 according to an embodiment may identify the vehicle 2615 located on the left side of the vehicle (e.g., the vehicle 2105 in FIG. 21) in which the electronic device 2001 is mounted in the image 2600. For example, the vehicle 2615 included in the image 2600 may be the vehicle 2615 located at the rear left of the vehicle 2105. The electronic device 2001 may set an identifier for the vehicle 2615 based on identifying the vehicle 2615.

For example, the vehicle 2615 may be an example of a vehicle moving toward the same direction (e.g., +x direction) as the vehicle (e.g., the vehicle 2105 in FIG. 21). For example, the electronic device 2001 may identify the type of the vehicle 2615 based on the exterior of the vehicle 2615. For example, the electronic device 2001 may obtain a parameter corresponding to the one or more subjects included in the image 2600 through calibration of the image 2600. Based on the obtained parameter, the electronic device 2001 may identify the type of the vehicle 2615. For example, the vehicle 2615 may be an example of an SUV. For example, the electronic device 2001 may obtain the width of the vehicle 2615 based on the type of the bounding box 2613 and/or the vehicle 2615.

The electronic device 2001 according to an embodiment may obtain the width of the vehicle 2615 by using the bounding box 2613. For example, the electronic device 2001 may obtain the sliding window 2617 having the same height as the height of the bounding box 2613 and the width of at least a part of the width of the bounding box 2613. The electronic device 2001 may calculate, or sum the difference values of each of the pixels included in the bounding box 2613 by shifting the sliding window in the bounding box 2613. The electronic device 2001 may identify the symmetry of the vehicle 2615 included in the bounding box 2613 by using the sliding window 2617. For example, the electronic device 101 may obtain the central axis 2618 within the bounding box 2613 based on identifying whether each of the divided areas is symmetrical by using the sliding window 2617. For example, the difference value of pixels included in each area, which is divided by the sliding window, based on the central axis 2618, may correspond to 0. The electronic device 2001 may identify the center of the front surface of the vehicle 2615 by using the central axis 2618. By using the center of the identified front surface, the electronic device 2001 may obtain the width of the vehicle 2615. Based on the obtained width, the electronic device 2001 may identify a relative distance between the electronic device 2001 and/or the vehicle 2615. For example, the electronic device 2001 may obtain a relative distance based on a ratio between the width of the vehicle 2615 included in the data on the vehicle 2615 (here, the data may be predetermined the width information and the length information depending on the type of vehicle) and the width of the vehicle 2615 included in the image 2600. However, it is not limited thereto.

For example, the electronic device 2001 may identify a ratio between the width obtained by using the bounding box 2613 and/or the sliding window 2617. The electronic device 2001 may obtain another image (e.g., the image 2566 in FIG. 25) by using the image 2600 as at least one function. The electronic device 2001 may obtain a line segment (e.g., the line segments 2561-1, 2562-1, 2563-1, 2564-1, and 2565-1 in FIG. 25) for indicating location information corresponding to the vehicle 2615 based on the identified ratio. The electronic device 2001 may obtain location information of the visual object of the vehicle 2615 to be disposed in the images to be described later in FIGS. 32 to 33 by using the line segment.

Referring to FIG. 27, the electronic device 2001 according to an embodiment may identify the vehicle 2715 located on the left side of the vehicle 2105 included in the image 2701 obtained by using the second camera 2052 by using the bounding box 2714. For example, the image 2701 may be obtained after the image 2600. The electronic device 2001 may identify the vehicle 2715 included in the image 2701 by using an identifier set in the vehicle 2715 included in the image 2600.

For example, the electronic device 2001 may obtain the length 2716 of the vehicle 2715 by using the bounding box 2714. For example, the electronic device 2001 may obtain a numerical value corresponding to the length 4716 by using pixels corresponding to length 4716 in the image 2701. By using the obtained length 2716, the electronic device 2001 may identify a relative distance between the electronic device 2001 and the vehicle 2715. The electronic device 2001 may store information indicating a relative distance in a memory. The information indicating the stored relative distance may be indicated as the object location information of Table 6. For example, the electronic device 2001 may store the location information of the vehicle 2715 and/or the type of the vehicle 2715, and the like in a memory based on the location of the electronic device 2001.

For example, the electronic device 2001 may obtain another image (e.g., the image 2566 in FIG. 25) by inputting data corresponding to the image 2701 into at least one function. For example, a part of the bounding box corresponding to the length 2716 may be referred to the line segment 2561-1, 2562-1, 2563-1, 2564-1, and 2565-1 in FIG. 25. By using the other image, the electronic device 2001 may obtain an image to be described later in FIG. 32.

Referring to FIG. 28, an image 2800 according to an embodiment may be included in a plurality of frames (e.g., the third frames 2230 in FIG. 22) obtained by the electronic device 2001 by using the third camera (e.g., the third camera 2053 in FIG. 21). For example, the electronic device 2001 may obtain the image 2800 captured toward the right direction (e.g., −y direction) of the vehicle (e.g., the vehicle 2105 in FIG. 21) by using the third camera (e.g., the third camera 2053 in FIG. 21). For example, the electronic device 2001 may identify the vehicle 2815, the line 2822, and/or the lane 2825, which are disposed on the right side of the vehicle (e.g., the vehicle 2105 in FIG. 21), in the image 2800.

The electronic device 2001 according to an embodiment may identify that the line 2822 and/or the lane 2825 are disposed on the right side of the vehicle (e.g., the vehicle 2105 in FIG. 21) by using the synchronized first camera (e.g., the first camera 2051 in FIG. 21) and the third camera (e.g., the third camera 2053 in FIG. 21). The electronic device 2001 may identify a line 2822 extending toward one direction (e.g., −x direction) from the line 2422 in FIG. 24 by using the first camera and/or the third camera.

The electronic device 2001 according to an embodiment may identify a vehicle 2815 disposed on the right side of the vehicle in which the electronic device 2001 is mounted (e.g., the vehicle 2105 in FIG. 21) in the image 2800. For example, the vehicle 2815 may be an example of a vehicle moving toward the same direction (e.g., +x direction) as the vehicle (e.g., the vehicle 2105 in FIG. 21). For example, the electronic device 2001 may identify the vehicle 2815 located at the right rear of the vehicle 2105 in FIG. 21. For example, the electronic device 2001 may set an identifier for the vehicle 2815.

For example, the electronic device 2001 may identify the type of the vehicle 2815 based on the exterior of the vehicle 2815. For example, the electronic device 2001 may obtain a parameter corresponding to the one or more subjects included in the image 2800 through calibration of the image 2800. Based on the obtained parameter, the electronic device 2001 may identify the type of the vehicle 2815. For example, the vehicle 2815 may be an example of a sedan.

For example, the electronic device 2001 may obtain the width of the vehicle 2815 based on the type of the bounding box 2813 and/or the vehicle 2815. For example, the electronic device 2001 may identify a relative location relationship between the electronic device 2001 and the vehicle 2815 by using the length 2816. For example, the electronic device 2001 may identify the central axis 2818 of the front surface of the vehicle 2815 by using the sliding window 2817. As described above with reference to FIG. 26, the electronic device 2001 may identify the central axis 2818.

For example, the electronic device 2001 may obtain the width of the vehicle 2815 by using the identified central axis 2818. Based on the obtained total width, the electronic device 2001 may obtain a relative distance between the electronic device 2001 and the vehicle 2815. The electronic device 2001 may identify location information of the vehicle 2815 based on the obtained relative distance. For example, the location information of the vehicle 2815 may comprise a coordinate value. The coordinate value may mean location information based on a 2-dimensional plane (e.g., xy plane). For example, the electronic device 2001 may store location information of the vehicle 2815 and/or the type of the vehicle 2815, in a memory. Based on the ratio between the widths obtained by using the bounding box 2813 and the sliding window 2817, the operation of by the electronic device 2001 obtaining line segments of an image different from the image 2800 may be substantially similar to that described above with reference to FIG. 26.

Referring to FIG. 29, the electronic device 2001 according to an embodiment may obtain an image 2801. The image 2801 may be one of the third frames 2230 obtained by using a camera (e.g., the third camera 2253 in FIG. 22). For example, the image 2801 may be obtained after the image 2800.

The electronic device 2001 according to an embodiment may identify the vehicle 2815 located on the right side of the vehicle 2105. The electronic device 2001 may identify the vehicle 2815 included in the image 2800 and the vehicle 2815 included in the image 2801 as the same vehicle by using an identifier for the vehicle 2815 included in the image 2800.

For example, the electronic device 2001 may identify the length 2816 of the vehicle 2815 by using the bounding box 2814 in FIG. 29. The electronic device 2001 may obtain a numerical value of the length 2816 by using pixels corresponding to the length 2816 included in the image 2801. By using the obtained length 2816, the electronic device 2001 may obtain a relative distance between the electronic device 2001 and the vehicle 2815. By using the obtained relative distance, the electronic device 2001 may identify location information of the vehicle 2815. The electronic device 2001 may store the identified location information of the vehicle 2815 in a memory. An operation in which the electronic device 2001 obtains a line segment indicating the location of the vehicle 2815 in a different image from the image 2801 obtained by using at least one function by using the bounding box 2814 may be substantially similar to the operation described above in FIG. 27.

As described above, the electronic device 2001 may identify the one or more subjects (e.g., the vehicles 2715, 2815 and the lines 2721, 2822) located in the side direction of the vehicle (e.g., the vehicle 2105 in FIG. 21) on which the electronic device 2001 is disposed (e.g., the left direction, or the right direction) by using the second camera (e.g., the second camera 2052 in FIG. 21) synchronized with the first camera (e.g., the first camera 2051 in FIG. 21) and/or the third camera (e.g., the third camera 2053 in FIG. 21). For example, the electronic device 2001 may obtain information on the type or size of the vehicles 2715 and 2815 by using at least one data stored in the memory. For example, based on the location of the electronic device 2001, the electronic device 2001 may obtain relative location information of the vehicles 2715 and 2815 disposed in a space adjacent to the vehicle (e.g., the vehicle 2105 in FIG. 21) on which the electronic device 2001 is disposed. The electronic device 2001 may obtain a relative distance between the electronic device 2001 and the vehicles 2715, 2815 by using the width and/or the length of the vehicles 2715, 2815 obtained by using the images 2700, 2701, 2800, and 2801. The electronic device 2001 may obtain location information of the vehicles 2715 and 2815 by using the relative distance. The location information may comprise a coordinate value based on one plane (e.g., x-y plane). The electronic device 2001 may store information on the type or size of the vehicles 2715 and 2815 and/or the location information in a memory (e.g., the memory 2030 in FIG. 20) in a log file. The electronic device 2001 may receive a user input indicating that among a plurality of frames stored in the log file, vehicles 2715 and 2815 select one frame corresponding to the captured timing. The electronic device 2001 may display a plurality of frames including the one frame in the display of the electronic device 2001 (e.g., the display 2090 in FIG. 20) based on the received input. Based on displaying the plurality of frames in the display, the electronic device 101 may provide the user with the type of vehicles 2715 and 2815 and/or the location information of the vehicles 2715 and 2815 disposed in the adjacent space of the vehicle (e.g., the vehicle 2105 in FIG. 21) on which the electronic device 2001 is mounted.

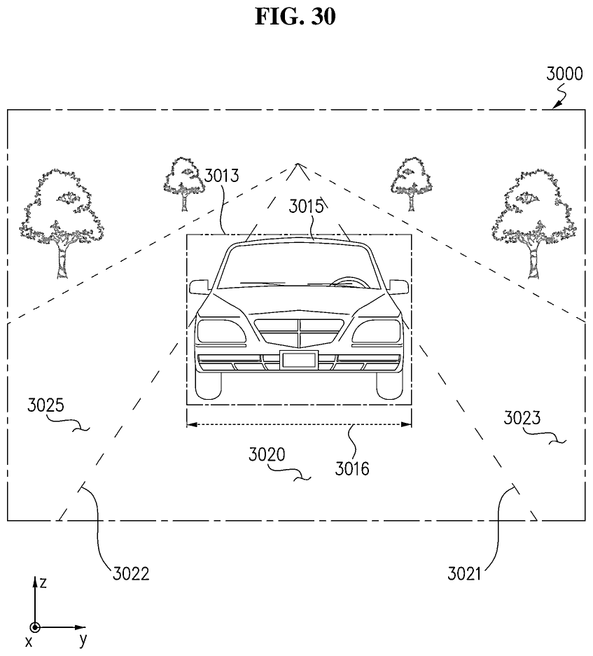

FIG. 30 illustrates an example of frames including information on a subject that an electronic device obtained by using a fourth camera disposed at the rear of a vehicle, according to an embodiment. Referring to FIG. 30, the image 3000 corresponding to one frame among the fourth frames (e.g., the fourth frames 2240 in FIG. 22) obtained by the fourth camera (e.g., the fourth camera 2154 in FIG. 21) in which the electronic device 2001 in FIG. 20 is disposed toward a direction (e.g., −x direction) different from the moving direction of the vehicle (e.g., the vehicle 2105 in FIG. 21) is illustrated. For example, the line 3021 may be referred to the line 2421 in FIG. 24. The line 3022 may be referred to the line 2422 in FIG. 24. The lane 3020 may be referred to the lane 2420 in FIG. 24. The lane 3025 may be referred to the lane 2425 in FIG. 24. The lane 3023 may be referred to the lane 2423 in FIG. 24.

The image 3000 according to an embodiment may comprise the one or more subjects disposed at the rear of a vehicle (e.g., the vehicle 2105 in FIG. 21) on which the electronic device 2001 is mounted. For example, the electronic device 2001 may identify the vehicle 3015, the lanes 3020, 3023, and 3025 and/or the lines 3021, 3022 in the image 3000.

The electronic device 2001 according to an embodiment may identify the lines 3021, 3022 using a first camera (e.g., the first camera 2051 in FIG. 20) and a fourth camera (e.g., the fourth camera 2054 in FIG. 20) synchronized with the first camera. The electronic device may identify the lines 3021, 3022 extending toward a direction (e.g., −x direction) opposite to the moving direction of the vehicle (e.g., the vehicle 2105 in FIG. 21), from the lines 2421 and 2422 in FIG. 24 disposed within the frames obtained by the first camera (e.g., the first camera 2051 in FIG. 20). For example, the electronic device 2001 may identify the lane 3020 divided by the lines 3021 and 3022.

The electronic device 2001 may identify the vehicle 3015 disposed on the lane 3020 by using the bounding box 3013. For example, the electronic device 2001 may identify the type of the vehicle 3015 based on the exterior of the vehicle 3015. For example, the electronic device 2001 may identify the type and/or size of the vehicle 3015 within the image 3000, based on radiator grille, shape of bonnet, shape of headlight, emblem and/or wind shield included in the front of the vehicle 3015. For example, the electronic device 2001 may identify the width 3016 of the vehicle 3015 by using the bounding box 3013. The width 3016 of the vehicle 3015 may correspond to one line segment of the bounding box 3013. For example, the electronic device 2001 may obtain the width 3016 of the vehicle 3015 based on identifying the type (e.g., sedan) of the vehicle 3015. For example, the electronic device 2001 may obtain the width 3016 by using a size representing the type (e.g., sedan) of the vehicle 3015.

The electronic device 2001 according to an embodiment may obtain location information of the vehicle 3015 with respect to the electronic device 2001 based on identifying the type and/or size (e.g., the width 3016) of the vehicle 3015. An operation by which the electronic device 2001 obtains the location information by using the width and/or the length of the vehicle 3015 may be similar to the operation performed by the electronic device 2001 in FIGS. 26 to 29. Hereinafter, a detailed description will be omitted.

The electronic device 2001 according to an embodiment identifies an overlapping area in obtained frames (e.g., the frames 2210, 2220, 2230, and 2240 in FIG. 22) based on the angles of view 2106, 2107, 2108, and 2109 in FIG. 21. The electronic device 2001 may identify an object (or subject) based on the same identifier in an overlapping area. For example, the electronic device 2001 may identify an object (not illustrated) based on a first identifier in the fourth frames 2240 obtained by using the fourth camera 2054 in FIG. 21. The electronic device 2001 may identify first location information on the object included in the fourth frames. While identifying the object in the fourth frames 2240 in FIG. 21, the electronic device 2001 may identify the object based on the first identifier in frames (e.g., the second frames 2220 in FIG. 22 or the third frame 2230 in FIG. 22) obtained by using the second camera 2052 in FIG. 21 and/or the third camera 2053 in FIG. 21. The electronic device 2001 may identify second location information on the object. For example, the electronic device 2001 may merge the first location information and the second location information on the object based on the first identifier and store them in a memory. For example, the electronic device 2001 may store one of the first location information and the second location information in a memory. However, it is not limited thereto.

As described above, the electronic device 2001 according to an embodiment may obtain information (e.g., type of vehicle and/or location information of vehicle) about the one or more subjects from a plurality of obtained frames (e.g., the first frames 2210, the second frames 2220, the third frames 2230, and the fourth frames 2240 in FIG. 22) by using a plurality of cameras (e.g., the plurality of cameras 2050 in FIG. 20) synchronized with each other. For example, the electronic device 2001 may store the obtained information in a log file. The electronic device 2001 may generate an image corresponding to the plurality of frames by using the log file. The image may comprise information on subjects included in each of the plurality of frames. The electronic device 2001 may display the image through a display (e.g., the display 2090 in FIG. 20). For example, the electronic device 2001 may store data about the generated image in a memory. The description of the image generated by the electronic device 2001 will be described later in FIG. 32.

FIG. 31 is an exemplary flowchart illustrating an operation in which an electronic device obtains information on one or more subjects included in a plurality of frames obtained by using a plurality of cameras, according to an embodiment. At least one operation of the operations in FIG. 31 may be performed by the electronic device 2001 in FIG. 20 and/or the processor 2020 of the electronic device 2001 in FIG. 20.

Referring to FIG. 31, in operation 3110, the processor 2020 according to an embodiment may obtain a plurality of frames obtained by the plurality of cameras synchronized with each other. For example, the plurality of cameras synchronized with each other may comprise the first camera 2051 in FIG. 20, the second camera 2052 in FIG. 20, the third camera 2053 in FIG. 20, and/or the fourth camera 2054 in FIG. 20. For example, each of the plurality of cameras may be disposed in different parts of a vehicle (e.g., the vehicle 2105 in FIG. 21) on which the electronic device 2001 is mounted. For example, the plurality of cameras may establish a connection by wire by using a cable included in the vehicle. For example, the plurality of cameras may establish a connection by wireless through a communication circuit (e.g., the communication circuit 2070 in FIG. 20) of an electronic device. The processor 2020 of the electronic device 2001 may synchronize the plurality of cameras based on the established connection. For example, the plurality of frames obtained by the plurality of cameras may comprise the first frames 2210 in FIG. 22, the second frames 2220 in FIG. 22, the third frames 2230 in FIG. 22, and/or the fourth frames 2240 in FIG. 22. The plurality of frames may mean a sequence of images captured according to a designated frame rate by the plurality of cameras while the vehicle on which the electronic device 2001 is mounted is in operation. For example, the plurality of frames may comprise the same time information.

Referring to FIG. 31, in operation 3120, the processor 2020 according to an embodiment may identify one or more lines included in the road where the vehicle is located from a plurality of frames. For example, the vehicle may be referred to the vehicle 2105 in FIG. 21. The road may comprise lanes 2420, 2423, and 2425 in FIG. 24. The lines may be referred to the lines 2421 and 2422 in FIG. 24. For example, the processor may identify lanes by using a pre-trained neural network stored in a memory (e.g., the memory 2030 in FIG. 20).

Referring to FIG. 31, in operation 3130, the processor according to an embodiment may identify the one or more subjects disposed within a space adjacent to the vehicle from a plurality of frames. For example, the space adjacent to the vehicle may comprise the road. For example, the one or more subjects may comprise the vehicle 2415 in FIG. 24, the vehicle 2715 in FIG. 27, the vehicle 2815 in FIG. 29, and/or the vehicle 3015 in FIG. 30. The processor may obtain information on the type and/or size of the one or more identified subjects using a neural network different from the neural network.

Referring to FIG. 31, in operation 3140, the processor 2020 according to an embodiment may obtain information for indicating locations of the one or more subjects in a space based on one or more lines. For example, the processor 2020 may identify a distance for each of the one or more subjects based on a location where each of the plurality of cameras is disposed in the vehicle (e.g., the vehicle 2105 in FIG. 21), the magnification of each of the plurality of cameras, the angle of view of each of the plurality of cameras, the type of each of the one or more subjects, and/or, the Size of each of the one or more subjects. The processor 2020 may obtain location information for each of the one or more subjects by using coordinate values based on the identified distance.

Referring to FIG. 31, in operation 3150, the processor 2020 according to an embodiment may store information in a memory. For example, the information may comprise the type of the one or more subjects included in a plurality of frames obtained by the processor 2020 using the plurality of cameras (e.g., the plurality of cameras 2050 in FIG. 20) and/or location information of the one or more subjects. The processor may store the information in a memory (e.g., the memory 2030 in FIG. 20) in a log file. For example, the processor 2020 may store the timing at which the one or more subjects are captured. For example, in response to an input indicating that the timing is selected, the processor 2020 may display a plurality of frames corresponding to the timing within the display (e.g., the display 2090 in FIG. 20). The processor 2020 may provide information on the one or more subjects included in the plurality of frames to the user, based on displaying the plurality of frames within the display.

As described above, the electronic device 2001 and/or the processor 2020 of the electronic device may identify the one or more subjects (e.g., the vehicle 2415 in FIG. 24, the vehicle 2715 in FIG. 27, the vehicle 2815 in FIG. 29, and/or vehicle 3015 in FIG. 30) included in each of a plurality of obtained frames by using the plurality of cameras 2050. The electronic device 2001 and/or the processor 2020 may obtain information on the type and/or size of each of the one or more subjects based on the exterior of the identified the one or more subjects. The electronic device 2001 and/or the processor 2020 may obtain a distance from the electronic device 2001 for each of the one or more subjects based on identifying a line and/or a lane included in each of the plurality of frames. The electronic device 2001 and/or the processor 2020 may obtain location information for each of the one or more subjects based on information on the obtained distance, the type and/or size of each of the one or more subjects. The electronic device 2001 and/or the processor 2020 may store the obtained plurality of information in a log file of a memory. The electronic device 2001 and/or the processor 2020 may generate an image including the plurality of information by using the log file. The electronic device 2001 and/or the processor 2020 may provide the generated image to the user. The electronic device 2001 and/or the processor 2020 may provide the user with information on the one or more subjects by providing the image. Hereinafter, an operation in which the electronic device provides the image will be described later in FIG. 32.

FIG. 32 illustrate an exemplary screen including one or more subjects, which is generated by an electronic device based on a plurality of frames obtained by using a plurality of cameras, according to an embodiment. The electronic device 2001 in FIG. 32 may be referred to the electronic device 2001 in FIG. 20.

Referring to FIG. 32, the image 3210 may comprise the visual object 3250 corresponding to a vehicle (e.g., the vehicle 2105 in FIG. 21) on which the electronic device 2001 in FIG. 20 is mounted based on two axes (e.g., x-axis, and y-axis). The image 3210 may comprise a plurality of visual objects 3213, 3214, 3215, and 3216 corresponding to each of the one or more subjects disposed within an adjacent space of the vehicle. The image 3210 may comprise the visual objects 3221 and 3222 corresponding to lines (e.g., the lines 2421 and 2422 in FIG. 24) and/or the visual objects 3220, 3223, and 3525 corresponding to lanes (e.g., the lanes 2420, 2423, and 2425 in FIG. 24) disposed within an adjacent space of the vehicle. For example, the image 3210 may comprise the plurality of visual objects moving toward one direction (e.g., x direction). For example, the electronic device 2001 in FIG. 20 may generate an image 3210 based on a log file stored in a memory (e.g., the memory 2030 in FIG. 20).

According to an embodiment, the log file may comprise information on an event that occurs while the operating system or other software of the electronic device 2001 is executed. For example, the log file may comprise information (e.g., type, number, and/or location) about the one or more subjects included in the frames obtained through the plurality of cameras (e.g., the plurality of cameras 2050 in FIG. 20). The log file may comprise time information in which the one or more subjects are included in each of the frames. For example, the electronic device 2001 may store the log file in memory by logging the information on the one or more subjects and/or the time information. The log file may be indicated as shown in Table 6 described above.

The electronic device 2001 according to an embodiment may obtain an image 3210 by using a plurality of frames obtained by a plurality of included cameras (e.g., the plurality 2 of cameras 2050 in FIG. 20). For example, the image 3210 may comprise the plurality of visual objects 3250, 3213, 3214, 3215, and 3216 on a plane configured based on two axes (x-axis and y-axis). For example, the image 3210 may be an example of an image (e.g., top view, or bird's eye view) viewed toward a plane (e.g., xy plane). For example, based on around view monitoring (AVM) stored in the electronic device 2001, the image 3210 may be obtained by using a plurality of frames.

The electronic device 2001 according to an embodiment may generate an image 3210 by using a plurality of frames obtained by the plurality of cameras facing in different directions. For example, the electronic device 2001 may obtain an image 3210 by using at least one neural network based on lines included in a plurality of frames (e.g., the first frame 2210, the second frame 2220, the third frame 2230, and/or the fourth frame 2240 in FIG. 22). For example, the line 3221 may correspond to the line 2421 in FIG. 24. The line 3222 may correspond to the line 2422 in FIG. 24. The lanes 3220, 3223, and 3225 divided by the lines 3221 and 3222 may correspond to the lanes 2420, 2423, and 2425 in FIG. 24, respectively.

The electronic device 2001 according to an embodiment may dispose the visual objects 3213, 3214, 3215, and 3216 in the image 3210 by using location information and/or type for the one or more subjects (e.g., the vehicle 2415 in FIG. 24, the vehicle 2715 in FIG. 27, the vehicle 2815 in FIG. 29, and the vehicle 3015 in FIG. 30) included in each of the plurality of frames.

For example, the electronic device 2001 may identify information on vehicles (e.g., the vehicle 2415 in FIG. 24, the vehicle 2715 in FIGS. 26 and 27, vehicle 2815 in FIGS. 28 and 29, vehicle 3015 in FIG. 30) corresponding to each of the visual objects 3213, 3214, 3215, and 3216 by using a log file stored in the memory. The information may comprise type, size, and/or location information of the vehicles. For example, the electronic device 2001 may adjust the location where the visual objects 3213, 3214, 3215, and 3216 are disposed in the visual object 3250 corresponding to the vehicle (e.g., the vehicle 2105 in FIG. 21) on which the electronic device 2001 is mounted, based on the point 3201-1. For example, the point 3201-1 may correspond to the location of the electronic device 2001 mounted on the vehicle 2205 in FIG. 22. The point 3201-1 may mean a reference location (e.g., (0,0) in xy plane) for disposing the visual objects 3213, 3214, 3215, and 3216.

For example, the visual object 3213 may correspond to a vehicle (e.g., the vehicle 2415 in FIG. 24) located within the angle of view 2106 of the first camera (e.g., the first camera 2051 in FIG. 21). For example, the line segment 3213-2 may be obtained by using one edge (e.g., the width of the bounding box) of the bounding box 2413 in FIG. 24. For example, the line segment 3213-2 may be referred to one of the line segments in FIG. 25. For example, the electronic device 2001 may dispose the visual object 3213 by using the location information of the vehicle (e.g., the vehicle 2415 in FIG. 24) corresponding to the visual object 3213 based on the point 3213-1 of the line segment 3213-2. For example, the electronic device 2001 may obtain a distance from the point 3210-1 to the point 3213-1 by using the location information of the vehicle. The electronic device 2001 may obtain the distance based on a designated ratio to the location information of the vehicle. However, it is not limited thereto.

For example, the visual object 3214 may correspond to a vehicle (e.g., the vehicle 2715 in FIG. 27) located within the angle of view 2107 of the second camera (e.g., the second camera 2052 in FIG. 21). The line segment 3214-2 may correspond to one edge of the bounding box 2714 in FIG. 27. The line segment 3214-2 may be referred to the length 2716 in FIG. 27. The electronic device 2001 may dispose the visual object 3214 by using the location information on the vehicle (e.g., the vehicle 2715 in FIG. 27) based on the one point 3214-1 of the line segment 3214-2. However, it is not limited thereto.

For example, the visual object 3215 may correspond to a vehicle (e.g., the vehicle 2815 in FIG. 29) located within the angle of view 2108 of the third camera (e.g., the third camera 2053 in FIG. 21). The line segment 3215-2 may be obtained by using one edge of the bounding box 2814 in FIG. 29. The line segment 3215-2 may be referred to the length 2816 in FIG. 29. The electronic device 2001 may dispose the visual object 3215 by using the location information on the vehicle (e.g., the vehicle 2815 in FIG. 29) based on the one point 3215-1 of the line segment 3215-2. However, it is not limited thereto.

For example, the visual object 3216 may correspond to a vehicle (e.g., the vehicle 3015 in FIG. 30) located within the angle of view 2109 of the fourth camera (e.g., the fourth camera 2054 in FIG. 21). The line segment 3216-2 may be obtained by using the bounding box 3013 in FIG. 30. The line segment 3216-2 may be referred to the width 3016 in FIG. 30. The electronic device 2001 may dispose the visual object 3216 by using the location information on the vehicle (e.g., the vehicle 3015 in FIG. 30), based on the point 3216-1 of the line segment 3216-2.

For example, the electronic device 2001 may identify information on the points 3213-1, 3214-1, 3215-1, and 3216-1 based on the point 3201-1 based on the designated ratio from the location information of the one or more subjects obtained by using a plurality of frames (e.g., the frames 2210, 2220, 2230, and 2240 in FIG. 22). The electronic device 2001 may indicate the points as coordinate values based on two axes (e.g., x-axis and y-axis).

The electronic device 2001 according to an embodiment may identify information on a subject (e.g., the vehicle 2415) included in an image (e.g., the image 2410 in FIG. 24) corresponding to one frame among the first frames (e.g., the first frames 2210 in FIG. 22) obtained by using a first camera (e.g., the first camera 2051 in FIG. 20). The information may comprise type, size, and/or location information of the subject (e.g., the vehicle 2415). For example, based on the identified information, the electronic device 2001 may identify the visual object 3213. For example, the electronic device 2001 may dispose the visual object 3213 in front of the visual object 3250 corresponding to a vehicle (e.g., the vehicle 2105 in FIG. 21) based on the identified information. For example, the visual object 3213 may be disposed from the visual object 3250 toward a moving direction (e.g., x direction).

The electronic device 2001 according to an embodiment may identify information on a subject (e.g., the vehicle 2715) included in an image (e.g., the image 2600 in FIG. 26) corresponding to one frame among the second frames (e.g., the second frames 2220 in FIG. 22) obtained by using a second camera (e.g., the second camera 2052 in FIG. 20). The information may comprise type, size, and/or location information of the subject (e.g., the vehicle 2715). For example, based on the identified information, the electronic device 2001 may identify the visual object 3214. For example, the electronic device 2001 may dispose the visual object 3214 on the left side of the visual object 3250 corresponding to the vehicle (e.g., the vehicle 2105 in FIG. 21) based on the identified information. For example, the electronic device 2001 may dispose the visual object 3214 on the lane 3223.

The electronic device 2001 according to an embodiment may identify information on a subject (e.g., the vehicle 2815) included in an image (e.g., the image 2800 in FIG. 28) corresponding to one frame among the third frames (e.g., the third frames 2130 in FIG. 21) obtained by using the third camera (e.g., the third camera 2053 in FIG. 20). The information may comprise type, size, and/or location information of the subject (e.g., the vehicle 2815). For example, based on the identified information, the electronic device 2001 may identify the visual object 3215. For example, the electronic device 2001 may dispose the visual object 3215 on the right side of the visual object 3250 corresponding to the vehicle (e.g., the vehicle 2105 in FIG. 21) based on the identified information. For example, the electronic device 2001 may dispose the visual object 3215 on the lane 3225.

The electronic device 2001 according to an embodiment may identify information on a subject (e.g., the vehicle 3015) included in an image (e.g., the image 3000 in FIG. 30) corresponding to one frame among the fourth frames (e.g., the fourth frames 2140 in FIG. 21) obtained by using the fourth camera (e.g., the fourth camera 2054 in FIG. 20). The information may comprise type, size, and/or location information of the subject (e.g., vehicle 3015). For example, based on the identified information, the electronic device 2001 may identify the visual object 3216. For example, the electronic device 2001 may dispose the visual object 3216 at the rear of the visual object 3250 corresponding to the vehicle (e.g., the vehicle 2105 in FIG. 21), based on the identified information. For example, the electronic device 2001 may dispose the visual object 3216 on the lane 3220.

The electronic device 2001 according to an embodiment may provide a location relationship for vehicles (e.g., the vehicle 2105 in FIG. 21, the vehicle 2415 in FIG. 24, the vehicle 2715 in FIG. 27, the vehicle 2815 in FIG. 28, and the vehicle 3015 in FIG. 30) corresponding to the visual objects 3250, 3213, 3214, 3215, and 3216 based on the image 3210. For example, based on the time information included in the log file, the electronic device 2001 may indicate the movement of visual objects 3250, 3213, 3214, 3215, and 3216 corresponding to each of the vehicles during the time indicated in the time information, by using the image 3210. The electronic device 2001 may identify contact between a part of the vehicles based on the image 3210.

Referring to FIG. 32, the image in which the electronic device 2001 according to an embodiment reconstructs frames corresponding to the time information by using the time information included in the log file is illustrated. The image may be referred to a top view image or a bird eye view image. The electronic device 2001 may obtain the image based on 3-dimensions by using a plurality of frames. For example, the image may be referred to the image 3210. The electronic device 2001 according to an embodiment may playback the image based on a designated time by controlling the display. The image may comprise visual objects 3213, 3214, 3215, 3216, and 3250. For example, the electronic device 2001 may generate the image by using a plurality of frames obtained by using the plurality of cameras 2050 in FIG. 20 for a designated time. For example, the designated time may comprise a time point when a collision between a vehicle (e.g., the vehicle 2105 in FIG. 21) on which the electronic device 2001 is mounted and another vehicle (e.g., the vehicle 3015 in FIG. 30) occurs. The electronic device 2001 may provide the surrounding environment of the vehicle (e.g., the vehicle 2105 in FIG. 21) on which the electronic device 2001 is mounted to the user by using the image 3210 and/or the image.

As described above, the electronic device 2001 may obtain information on the one or more subjects (or vehicles) included in a plurality of frames (e.g., the frames 2210, 2220, 2230, and 2240 in FIG. 22) obtained by the plurality of cameras (e.g., the plurality of cameras 2050 in FIG. 20). For example, the information may comprise the type, size, location of the one or more subjects (e.g., vehicles) and/or timing (time) at which the one or more subjects were captured. For example, the electronic device 2001 may obtain the image 3210 by using the plurality of frames based on the information. For example, the timing may comprise a time point at which contact between a part of the one or more subjects occurs. In response to an input indicating the selection of a frame corresponding to the time point, the electronic device 2001 may provide the image 3210 corresponding to the frame to the user. The electronic device 2001 may reconstruct contact (or interaction) between a part of the one or more subjects by using the image 3210.

FIG. 33 is an exemplary flowchart illustrating an operation in which an electronic device identifies information on one or more subjects included in the plurality of frames based on a plurality of frames obtained by a plurality of cameras, according to an embodiment. At least one operation of the operations in FIG. 33 may be performed by the electronic device 2001 in FIG. 20 and/or the processor 2020 in FIG. 20. For example, the order of operations in FIG. 33 performed by the electronic device and/or the processor is not limited to those illustrated in FIG. 33. For example, the electronic device and/or the processor may perform a part of the operations in FIG. 33 in parallel, or by changing the order.

Referring to FIG. 33, in operation 3310, the processor 2020 according to an embodiment may obtain first frames obtained by the plurality of cameras synchronized with each other. For example, the plurality of cameras synchronized with each other may be referred to the plurality of cameras 2050 in FIG. 20. For example, the first frames may comprise the frames 2210, 2220, 2230, and 2240 in FIG. 22.

Referring to FIG. 33, in operation 3320, the processor 2020 according to an embodiment may identify the one or more subjects disposed in a space adjacent to the vehicle from the first frames. For example, the vehicle may be referred to the vehicle 2105 in FIG. 21. For example, the one or more subjects may comprise the vehicle 2415 in FIG. 24, the vehicle 2715 in FIG. 27, the vehicle 2815 in FIG. 28, and/or the vehicle 3015 in FIG. 30. For example, the processor 2020 may identify the one or more subjects from the first frames by using a pre-trained neural network for identifying the subjects stored in memory. For example, the processor 2020 may obtain information on the one or more subjects by using the neural network. The information may comprise types and/or sizes of the one or more subjects.

Referring to FIG. 33, in operation 3330, the processor 2020 according to an embodiment may identify one or more lanes included in the road on which the vehicle is disposed from the first frames. The lanes may comprise lanes 2420, 2423, and 2425 in FIG. 24. The road may comprise the lane and, within the road, lines (e.g., the lines 2421 and 2422 in FIG. 24) for dividing the lane. For example, processor 2020 may identify a lane included in the first frames by using a pre-trained neural network for identifying a lane stored in memory.

Referring to FIG. 33, in operation 3340, the processor 2020 according to an embodiment may store information for indicating locations of the one or more subjects in a space in a log file of a memory. For example, the processor 2020 may obtain information for indicating the location by identifying the length and/or the width of the vehicle by using a bounding box. However, it is not limited thereto.

Referring to FIG. 33, in operation 3350, the processor 2020 according to an embodiment may obtain second frames different from the first frames based on the log file. For example, the second frames may be referred to the image 3210 in FIG. 32. For example, the second frames may comprise a plurality of visual objects corresponding to a road, a lane, and/or one or more subjects.

Referring to FIG. 33, in operation 3360, the processor according to an embodiment may display the second frames in the display. For example, data on the second frames may be stored in a log file, independently of displaying the second frames in the display. For example, the processor may display the second frames in the display in response to an input indicating the load of the data.

As described above, the electronic device and/or the processor may obtain a plurality of frames by using the plurality of cameras respectively disposed in the vehicle toward the front, side (e.g., left, or right), and rear. The electronic device and/or processor may identify information on the one or more subjects included in the plurality of frames and/or lanes (or lines). The electronic device and/or processor may obtain an image (e.g., top-view image) based on the information on the one or more subjects and the lanes. For example, the electronic device and/or processor may capture contact between the vehicle and a part of the one or more subjects, by using the plurality of cameras. For example, the electronic device and/or processor may indicate contact between the vehicle and a part of the one or more subjects by using visual objects included in the image. The electronic device and/or processor may provide accurate data on the contact by providing the image to the user.

FIG. 34 is an exemplary flowchart illustrating an operation of controlling a vehicle by an electronic device according to an embodiment. The vehicle in FIG. 34 may be an example of the vehicle 2105 in FIG. 21 and/or the autonomous vehicle 1500 in FIG. 18. At least one of the operations in FIG. 34 may be performed by the electronic device 2001 in FIG. 20 and/or the processor 2020 in FIG. 20.

Referring to FIG. 34, in operation 3410, an electronic device according to an embodiment may perform global path planning based on an autonomous driving mode. For example, the electronic device 2001 may control the operation of a vehicle on which the electronic device mounted based on performing global path planning. For example, the electronic device 2001 may identify a driving path of the vehicle by using data received from at least one server.

Referring to FIG. 34, in operation 3420, the electronic device according to an embodiment may control the vehicle based on local path planning by using a sensor. For example, the electronic device may obtain data on the surrounding environment of the vehicle by using a sensor within a state in which the vehicle is driven based on performing global path planning. The electronic device may change at least a part of the driving path of the vehicle based on the obtained data.

Referring to FIG. 34, according to an embodiment, in operation 3420, the electronic device may obtain a frame from a plurality of cameras. The plurality of cameras may be referred to the plurality of cameras 2050 in FIG. 20. The frame may be included in one or more frames obtained from the plurality of cameras (e.g., the frames 2210, 2220, 2230, and 2240 in FIG. 22).

Referring to FIG. 34, according to an embodiment, the electronic device may identify whether at least one subject has been identified in the frame. For example, the electronic device may identify the at least one subject by using a neural network. For example, at least one subject may be referred to the vehicle 2415 in FIG. 24, the vehicle 2715 in FIG. 27, the vehicle 2815 in FIG. 28, and/or the vehicle 3015 in FIG. 30.

Referring to FIG. 34, in a state in which at least one subject is identified in the frame (operation 3430—yes), in operation 3440, the electronic device according to an embodiment may identify at least one subject's motion. For example, the electronic device may use the information of at least one subject obtained from the plurality of cameras to identify the motion of the at least one subject. The information may comprise location information, a type, size, and/or time of the at least one subject. The electronic device 2001 may predict the motion of at least one subject based on the information.

Referring to FIG. 34, in operation 3450, according to an embodiment, the electronic device may identify whether a collision probability with at least one subject is obtained, and wherein the probability is greater than or equal to the specified threshold. The electronic device may obtain the collision probability by using another neural network different from the neural network for identifying at least one subject. The other neural network may be an example of the deep learning network 1407 in FIG. 17. However, it is not limited thereto.

Referring to FIG. 34, in operation 3460, the electronic device according to an embodiment may change local path planning when the collision probability with at least one subject is obtained (operation 3450—yes), which is equal to or greater than a designated threshold. For example, the electronic device may change the driving path of the vehicle based on the changed local path planning. For example, the electronic device may adjust the driving speed of the vehicle based on the changed local path planning. For example, the electronic device may control the vehicle to change the line based on the changed local path planning. However, it is not limited to the above-described embodiment.

As described above, based on the autonomous driving system 1400 in FIG. 17, the electronic device may identify at least one subject included in frames obtained through a camera within a state of controlling the vehicle. The motion of at least one subject may be identified based on the identified information on the at least one subject. Based on the identified motion, the electronic device may control the vehicle. By controlling the vehicle, the electronic device may prevent collision with the at least one subject. The electronic device may provide a user of the electronic device with safer autonomous driving by controlling the vehicle to prevent collisions with the at least one subject.

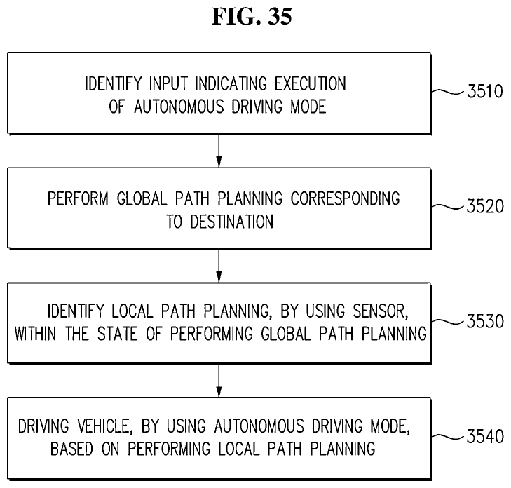

FIG. 35 is an exemplary flowchart illustrating an operation in which an electronic device controls a vehicle based on an autonomous driving mode according to an embodiment. At least one of the operations in FIG. 35 may be performed by the electronic device 2001 in FIG. 20 and/or the processor 2020 in FIG. 20. At least one of the operations in FIG. 35 may be related to operation 3410 in FIG. 34 and/or operation 3420 in FIG. 34.

Referring to FIG. 35, the electronic device according to an embodiment may identify an input indicating execution of the autonomous driving mode in operation 3510. The electronic device may control a vehicle on which the electronic device is mounted by using the autonomous driving system 1400 in FIG. 17, based on the autonomous driving mode. The vehicle may be driven by the electronic device based on the autonomous driving mode.

Referring to FIG. 35, in operation 3520, according to an embodiment, the electronic device may perform global path planning corresponding to a destination. The electronic device may receive an input indicating a destination from a user of the electronic device. For example, the electronic device may obtain location information of the electronic device from at least one server. Based on the location information, the electronic device may identify a driving path from a current location (e.g., departure place) of the electronic device to the destination. The electronic device may control the operation of the vehicle based on the identified driving path. For example, by performing global path planning, the electronic device may provide a user with a distance of a driving path and/or a driving time.

Referring to FIG. 35, in operation 3530, according to an embodiment, the electronic device may identify local path planning by using a sensor within a state in which global path planning is performed. For example, the electronic device may identify the surrounding environment of the electronic device and/or the vehicle on which the electronic device is mounted by using a sensor. For example, the electronic device may identify the surrounding environment by using a camera. The electronic device may change the local path planning based on the identified surroundings. The electronic device may adjust at least a part of the driving path by changing the local path planning. For example, the electronic device may control the vehicle to change the line based on the changed local path planning. For example, the electronic device may adjust the speed of the vehicle based on the changed local path planning.

Referring to FIG. 35, in operation 3540, the electronic device according to an embodiment may drive a vehicle by using an autonomous driving mode based on performing the local path planning. For example, the electronic device may change the local path planning according to a part of the vehicle's driving path by using a sensor and/or a camera. For example, the electronic device may change local path planning to prevent collisions with at least one subject within the state in which the motion of at least one subject is identified by using a sensor and/or camera. Based on controlling the vehicle by using the changed local path planning, the electronic device may prevent a collision with at least one subject.

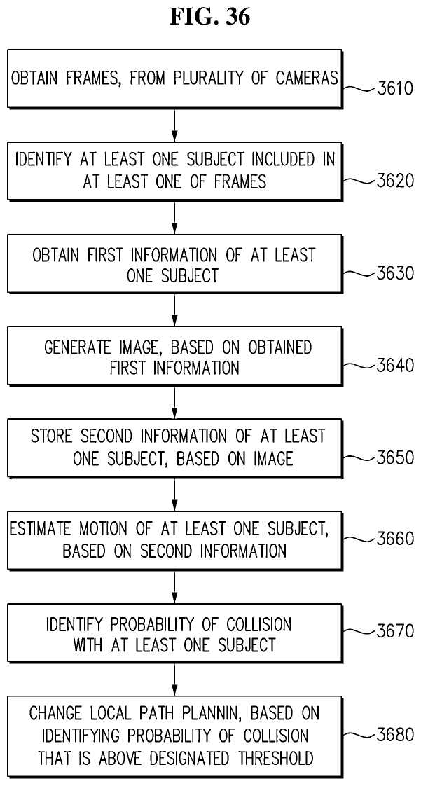

FIG. 36 is an exemplary flowchart illustrating an operation of controlling a vehicle by using information of at least one subject obtained by an electronic device by using a camera according to an embodiment. At least one of the operations in FIG. 36 may be related to operation 3440 in FIG. 34. At least one of the operations in FIG. 36 may be performed by the electronic device in FIG. 20 and/or the processor 2020 in FIG. 20.

The electronic device according to an embodiment may obtain frames from a plurality of cameras in operation 3610. For example, the electronic device may perform operation 3610, based on the autonomous driving mode, within a state in which the electronic device controls the vehicle mounted thereon. The plurality of cameras may be referred to the plurality of cameras 2050 in FIG. 20. The frames may be referred to at least one of the frames 2210, 2220, 2230, and 2240 in FIG. 22. The electronic device may distinguish the obtained frames from each of the plurality of cameras.

According to an embodiment, in operation 3620, the electronic device may identify at least one subject included in at least one of the frames. The at least one subject may comprise the vehicle 2415 in FIG. 24, the vehicle 2715 in FIG. 27, the vehicle 2815 in FIG. 28, and/or the vehicle 3015 in FIG. 30. For example, the at least one subject may comprise a vehicle, a bike, a pedestrian, a natural object, a line, a road, and a lane. For example, the electronic device may identify the at least one subject through at least one neural network.

According to an embodiment the electronic device, in operation 3630, may obtain first information of at least one subject. For example, the electronic device may obtain information of the at least one subject based on data stored in the memory. For example, the at least one subject information may comprise a distance between the at least one subject and the electronic device, a type of the at least one subject, a size of the at least one subject, a location information of the at least one subject, and/or a time information when the at least one subject is captured.

In operation 3640, the electronic device according to an embodiment may obtain an image based on the obtained information. For example, the image may be referred to the image 3210 in FIG. 32. For example, the electronic device may display the image through a display. For example, the electronic device may store the image in a memory.

In operation 3650, the electronic device according to an embodiment may store second information of at least one subject based on the image. For example, the second information may comprise location information of at least one subject. For example, the electronic device may identify location information of at least one subject by using an image. For example, the location information may mean a coordinate value based on a 2-dimensional coordinate system and/or a 3-dimensional coordinate system. For example, the location information may comprise the points 3213-1, 3214-1, 3215-1, and 3216-1 in FIG. 32. However, it is not limited thereto.

According to an embodiment, in operation 3660, the electronic device may estimate the motion of at least one subject based on the second information. For example, the electronic device may obtain location information from each of the obtained frames from the plurality of cameras. The electronic device may estimate the motion of at least one subject based on the obtained location information. For example, the electronic device may use the deep learning network 1407 in FIG. 17 to estimate the motion. For example, the at least one subject may move toward the driving direction of the vehicle in which the electronic device is disposed. For example, the at least one subject may be located on a lane different from the vehicle. For example, the at least one subject may cut in from the different lanes to the lane in which the vehicle is located. However, it is not limited thereto.

According to an embodiment, in operation 3670, the electronic device may identify a collision probability with at least one subject. For example, the electronic device may identify the collision probability based on estimating the motion of at least one subject. For example, the electronic device may identify the collision probability with the at least one subject based on the driving path of the vehicle on which the electronic device is mounted. In order to identify the collision probability, the electronic device may use a pre-trained neural network.

According to an embodiment, in operation 3680, the electronic device may change local path planning based on identifying a collision probability that is equal to or greater than a designated threshold. In operation 3410, the electronic device may change the local path planning within a state in which global path planning is performed based on the autonomous driving mode. For example, the electronic device may change a part of the driving path of the vehicle by changing the local path planning. For example, when estimating the motion of the at least one subject blocking the driving of the vehicle, the electronic device may reduce the speed of the vehicle. For example, the electronic device may identify at least one subject included in the obtained frames by using a rear camera (e.g., the fourth camera 2054 in FIG. 20). For example, the at least one subject may be located on the same lane as the vehicle. The electronic device may estimate the motion of at least one subject approaching the vehicle. The electronic device may control the vehicle to change the line based on estimating the motion of the at least one subject. However, it is not limited to.

As described above, the electronic device may identify at least one subject within frames obtained from the plurality of cameras. The electronic device may identify or estimate the motion of the at least one subject based on the information of the at least one subject. The electronic device may control a vehicle on which the electronic device is mounted based on identifying and/or estimating the motion of the at least one subject. The electronic device may provide a safer autonomous driving mode to the user by controlling the vehicle based on estimating the motion of the at least one subject.

As described above, an electronic device mountable in a vehicle according to an embodiment may comprise a plurality of cameras disposed toward different directions of the vehicle, a memory, and a processor. The processor may obtain a plurality of frames obtained by the plurality of cameras which are synchronized with each other. The processor may identify, from the plurality of frames, one or more lines included in a road in which the vehicle is disposed. The processor may identify, from the plurality of frames, one or more subjects disposed in a space adjacent to the vehicle. The processor may obtain, based on the one or more lines, information for indicating locations in the space of the one or more subjects in the space. The processor may store the obtained information in the memory.

For example, the processor may store, in the memory, the information including a coordinate, corresponding to a corner of the one or more subjects in the space.

For example, the processor may store, in the memory, the information including the coordinate of a left corner of a first subject included in a first frame obtained from a first camera disposed in a front direction of the vehicle.

For example, the processor may store in the memory, the information including the coordinate of a right corner of a second subject included in a second frame obtained from a second camera disposed on a left side surface of the vehicle.

For example, the processor may store, in the memory, the information including the coordinate of a left corner of a third subject included in a third frame obtained from a third camera disposed on a right side surface of the vehicle.

For example, the processor may store, in the memory, the information including the coordinate of a right corner of a fourth subject included in a fourth frame obtained from a fourth camera disposed in a rear direction of the vehicle.

For example, the processor may identify, from the plurality of frames, movement of at least one subject of the one or more subjects. The processor may track the identified at least one subject, by using at least one camera of the plurality of cameras. The processor may identify the coordinate, corresponding to a corner of the tracked at least one subject and changed by the movement. The processor may store, in the memory, the information including the identified coordinate.

For example, the processor may store the information, in a log file matching to the plurality of frames.

For example, the processor may store types of the one or more subjects, in the information.

For example, the processor may store, the information for indicating time in which the one or more subjects is captured, in the information.

A method of an electronic device mountable in a vehicle according to an embodiment, may comprise an operation of obtaining a plurality of frames obtained by a plurality of cameras which are synchronized with each other. The method may identify, from the plurality of frames, one or more lines included in a road in which the vehicle is disposed. The method may comprise an operation of identifying, from the plurality of frames, the one or more subjects disposed in a space adjacent to the vehicle. The method may comprise an operation of obtaining, based on the one or more lines, information for indicating locations in the space of the one or more subjects in the space. The method may comprise an operation of storing the obtained information in the memory.

For example, the method may comprise storing, in the memory, the information including a coordinate, corresponding to a corner of the one or more subjects in the space.

For example, the method may comprise storing, in the memory, the information including the coordinate of a left corner of a first subject included in a first frame obtained from a first camera disposed in a front direction of the vehicle.

For example, the method may comprise storing, in the memory, the information including the coordinate of a right corner of a second subject included in a second frame obtained from a second camera disposed on a left side surface of the vehicle.

For example, the method may comprise storing, in the memory, the information including the coordinate of a left corner of a third subject included in a third frame obtained from a third camera disposed on a right side surface of the vehicle.

For example, the method may comprise storing, in the memory, the information including the coordinate of a right corner of a fourth subject included in a fourth frame obtained from a fourth camera disposed in a rear direction of the vehicle.

For example, the method may comprise identifying, from the plurality of frames, movement of at least one subject of the one or more subjects. The method may comprise tracking the identified at least one subject, by using at least one camera of the plurality of cameras. The method may comprise identifying the coordinate, corresponding to a corner of the tracked at least one subject and changed by the movement. The method may comprise storing, in the memory, the information including the identified coordinate.

For example, the method may comprise storing the information, in a log file matching to the plurality of frames.

For example, the method may comprise storing at least one of types of the one or more subjects or time in which the one or more subjects is captured, in the information.

A non-transitory computer readable storage medium storing one or more programs according to an embodiment, wherein the one or more programs, when being executed by a processor of an electronic device mountable in a vehicle, may obtain a plurality of frames obtained by a plurality of cameras which are synchronized with each other. For example, the one or more programs may identify, from the plurality of frames, one or more lines included in a road in which the vehicle is disposed. The one or more programs may identify, from the plurality of frames, the one or more subjects disposed in a space adjacent to the vehicle. The one or more programs may obtain, based on the one or more lines, information for indicating locations in the space of the one or more subjects in the space. The one or more programs may store the obtained information in the memory.

The device described above may be implemented by a hardware component, a software component, and/or a combination of the hardware component and the software component. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of processing element. For example, the processing device may include a plurality of processors or include one processor and one controller. Further, another processing configuration such as a parallel processor may be allowed.

The software may include a computer program, a code, an instruction, or a combination of one or more of them and configure the processing device to be operated as desired or independently or collectively command the processing device. The software and/or data may be permanently or temporarily embodied in an arbitrary type of machine, component, physical device, virtual equipment, computer storage medium, or device, or signal wave to be transmitted to be interpreted by a processing device or provide command or data to the processing device. The software may be distributed on a computer system connected through a network to be stored or executed in a distributed manner. The software and data may be stored in one or more computer readable recording media.

The method according to the example embodiment may be implemented as a program command which may be executed by various computers to be recorded in a computer readable medium. The computer readable medium may include solely a program command, a data file, and a data structure or a combination thereof. The program instruction recorded in the medium may be specifically designed or constructed for the example embodiment or known to those skilled in the art of a computer software to be used. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the example embodiment and vice versa.

Although the exemplary embodiments have been described above by a limited example and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved.

Therefore, other implements, other embodiments, and equivalents to the claims are within the scope of the following claims.

What is claimed is:

1. A device for a vehicle, comprising:
at least one transceiver;
a memory configured to store instructions; and
at least one processor operably coupled to the at least one transceiver and the memory,
wherein when the instructions are executed, the at least one processor is configured to receive an event message related to an event of a source vehicle in which the event message includes identification information about a serving road side unit (RSU) of the source vehicle and direction information indicating a driving direction of the source vehicle, identify whether a serving RSU of the source vehicle is included in a driving list of the vehicle, identify whether a driving direction of the source vehicle matches a driving direction of the vehicle, when it is identified that the driving direction of the source vehicle matches the driving direction of the vehicle and a serving RSU of the source vehicle is included in the driving list of the vehicle (upon identifying), perform the driving according to the event message, and when it is identified that the driving direction of the source vehicle does not match the driving direction of the vehicle and a serving RSU of the source vehicle is not included in the driving list of the vehicle (upon identifying), perform the driving without the event message.

2. The device according to claim 1, wherein the driving list of the vehicle includes identification information about one or more RSUs and the driving direction indicates one of a first lane direction and a second lane direction which is opposite to the first lane direction.

3. The device according to claim 1, wherein the at least one processor is further configured to, when the instructions are executed, acquire the identification information about the serving RSU of the source vehicle and the direction information indicating the driving direction of the source vehicle by identifying encryption information about the serving RSU based on the reception of the event message and decrypting the event message based on the encryption information about the serving RSU.

4. The device according to claim 3, wherein the at least one processor is further configured to, when the instructions are executed, before receiving the event message, transmit a service request message to a service provider server through the RSU and receive a service response message corresponding to the service request message from the service provider server through the RSU,
the service response message includes driving plan information indicating an expected driving route of the vehicle, information about one or more RSUs related to the expected driving route, and encryption information about one or more RSUs, and
the encryption information includes encryption information about the serving RSU.

5. The device according to claim 3, wherein the at least one processor is further configured to, when the instructions are executed, before receiving the event message, receive broadcast information from the serving RSU and the broadcast message includes identification information about the RSU, information indicating at least one RSU adjacent to the RSU, and encryption information about the RSU.

6. The device according to claim 1, wherein the at least one processor is configured to, when the instructions are executed, change a driving related setting of the vehicle based on the event message to perform the driving according to the event message, and the driving related setting includes at least one of a driving route of the vehicle, a driving lane of the vehicle, a driving speed of the vehicle, a lane of the vehicle, or the braking of the vehicle.

7. The device according to claim 1, wherein the at least one processor is configured to, when the instructions are executed, generate a transmission event message based on the event message, encrypt the transmission event message based on encryption information about an RSU which services the vehicle, and transmit the encrypted transmission event message to the RSU or the other vehicle, to perform the driving according to the event message.

8. The device according to claim 1, wherein the at least one processor is further configured to, when the instructions are executed, transmit an update request message to a service provider server, through the RSU which services the vehicle and receive an update message from the service provider server, to perform the driving according the event message,
the update request message includes information related to the event of the source vehicle, and
the update message includes information for representing the updated driving route of the vehicle.

9. A device performed by a road side unit (RSU), comprising:
at least one transceiver;
a memory configured to store instructions; and
at least one processor operably coupled to the at least one transceiver and the memory,
wherein the at least one processor is configured to, when the instructions are executed, receive an event message related to an event in the vehicle, from a vehicle which is serviced by the RSU, the event message including identification information of the vehicle and direction information indicating a driving direction of the vehicle, identify a driving route of the vehicle based on identification information of the vehicle, identify at least one RSU located in a direction opposite to a driving direction of the vehicle from the RSU, among one or more RSUs included in the driving route of the vehicle, and transmit the event message to at least one identified RSU.

10. The device according to claim 9, wherein the at least one processor is further configured to, when the instructions are executed, generate a transmission event message based on the event message, encrypt the transmission event message based on encryption information about an RSU, and transmit the encrypted transmission event message to the other vehicle in the RSU, and the encryption information about the RSU is broadcasted from the RSU.

11. A method performed by a vehicle, comprising:
an operation of receiving an event message related to an event of a source vehicle in which the event message includes identification information about a serving road side unit (RSU) of the source vehicle and direction information indicating a driving direction of the source vehicle,
an operation of identifying whether a serving RSU of the source vehicle is included in a driving list of the vehicle,
an operation of identifying whether a driving direction of the source vehicle matches a driving direction of the vehicle,
an operation of performing the driving according to the event message when it is identified that the driving direction of the source vehicle matches the driving direction of the vehicle and a serving RSU of the source vehicle is included in the driving list of the vehicle (upon identifying), and
an operation of performing the driving without the event message when it is identified that the driving direction of the source vehicle does not match the driving direction of the vehicle and a serving RSU of the source vehicle is not included in the driving list of the vehicle (upon identifying).

12. The method according to claim 11, wherein the driving list of the vehicle includes identification information about one or more RSUs and the driving direction indicates one of a first lane direction and a second lane direction which is opposite to the first lane direction.

13. The method according to claim 11, further comprising:
an operation of identifying encryption information about the serving RSU based on reception of the event message, and
an operation of acquiring the identification information about the serving RSU of the source vehicle and the direction information indicating the driving direction of the source vehicle by decrypting the event message based on the encryption information about the serving RSU.

14. The method according to claim 13, further comprising:
an operation of transmitting a service request message to a service provider through an RSU before receiving the event message, and
an operation of receiving a service response message corresponding to the service request message from the service provider server through the RSU,
wherein the service response message includes driving plan information indicating an expected driving route of the vehicle, information about one or more RSUs related to the expected driving route, and encryption information about one or more RSUs, and
the encryption information includes encryption information about the serving RSU.

15. The method according to claim 13, further comprising:
an operation of receiving a broadcast message from the serving RSU, before receiving the event message,
wherein the broadcast message includes identification information about the RSU, information indicating at least one RSU adjacent to the RSU, and encryption information about the RSU.

16. The method according to claim 11, wherein the operation of performing the driving according to the event message includes:
an operation of changing a driving related setting of the vehicle, based on the event message, the driving related setting includes at least one of a driving route of the vehicle, a driving lane of the vehicle, a driving speed of the vehicle, a lane of the vehicle, or the braking of the vehicle.

17. The method according to claim 11, wherein the operation of performing the driving according to the event message includes:
an operation of generating a transmission event message based on the event message,
an operation of encrypting the transmission event message based on encryption information about the RSU which services the vehicle, and
an operation of transmitting the encrypted transmission event message to the RSU or the other vehicle.

18. The method according to claim 11, wherein the operation of performing the driving according to the event message further includes:
an operation of transmitting an update request message to a service provider server through an RSU which services the vehicle, and
an operation of receiving an update message from the service provider server, through the RSU,
the update request message includes information related to the event of the source vehicle, and
the update message includes information for representing the updated driving route of the vehicle.

19. A method performed by a road side unit (RSU), comprising:
an operation of receiving an event message related to an event in the vehicle, from a vehicle which is serviced by the RSU, the event message including identification information of the vehicle and direction information indicating a driving direction of the vehicle,
an operation of identifying a driving route of the vehicle based on identification information of the vehicle,
an operation of identifying at least one RSU located in a direction opposite to the driving direction of the vehicle from the RSU, among one or more RSUs included in the driving route of the vehicle, and
an operation of transmitting the event message to at least one identified RSU.

20. The method according to claim 19, further comprising:
an operation of generating a transmission event message based on the event message,
an operation of encrypting the transmission event message based on encryption information about the RSU, and
an operation of transmitting the encrypted transmission event message to the other vehicle in the RSU,
wherein the encryption information about the RSU is broadcasted from the RSU.
